(19) United States
(12) Patent Application Publication
(10) Pub. No.: US 2026/0070843 A1
(43) Pub. Date: Mar. 12, 2026

(54) METHOD FOR ARTIFICIAL CORAL REEF RESTORATION AND SHORELINE STABILIZATION

(71) Applicant: PARTANNA GLOBAL, INC., Rancho Santa Fe, CA (US)

(72) Inventors: Sam Franklin Marshall, Hidden Hills, CA (US); Kevin A. MacDonald, Rancho Santa Fe, CA (US)

(21) Appl. No.: 19/070,076

(22) Filed: Mar. 4, 2025

Related U.S. Application Data
(60) Provisional application No. 63/561,599, filed on Mar. 5, 2024.

(51) Int. Cl. A01K 61/77; A01G 24/15; A01G 24/17; A01G 24/25; A01G 24/44; A01G 33/00; A01K 61/20; B33Y 10/00; B33Y 80/00; C04B 20/02; C04B 22/06; C04B 22/08; C04B 22/12; C04B 22/14; C04B 22/16; C04B 28/08; C04B 38/00; C04B 40/00; C04B 103/10; C04B 111/00

(52) U.S. Cl. CPC C04B 22/066; A01K 61/70; B33Y 80/00; C04B 20/0232; C04B 22/085; C04B 22/124; C04B 22/142; C04B 22/16; C04B 28/08; C04B 38/0054; C04B 40/0071; C04B 40/0082; B33Y 10/00; C04B 2103/10; C04B 2111/00019; C04B 2111/00181

(57) ABSTRACT

The present disclosure relates to shaped cementitious compositions that comprise a substrate for aquatic flora and/or fauna attachment; methods for providing a substrate for aquatic flora and/or fauna attachment comprising depositing a shaped cementitious composition into a body of water; and methods for making a shaped cementitious composition. The shaped cementitious composition is formed from a pourable cementitious mixture comprising: (a) a pozzolan comprising a natural pozzolan and/or a manmade pozzolan; (b) MgO and/or Mg(OH)₂; (c) an aqueous solution comprising one or more accelerants; and (d) at least one aggregate. In some cases, the MgO and/or Mg(OH)₂ of (b) is included in the aqueous solution of (c). And, in various cases, the manmade pozzolan comprises a slag.

### CROSS-REFERENCE

This application claims priority to U.S. Provisional Patent Application Ser. No. 63/561,599 filed Mar. 5, 2024. The contents of which are incorporated herein by reference in its entirety.

### BACKGROUND

Portland cement production is known to be a significant contributor to carbon dioxide (CO₂) emissions, which is a major greenhouse gas responsible for global warming. The production of Portland cement involves heating limestone and other materials at high temperatures, releasing substantial amounts of CO₂ into the atmosphere. The rise in global temperatures due to increased greenhouse gas emissions has led to elevated ocean temperatures, which are, in turn, contributing to coral bleaching events.

Coral bleaching occurs when corals expel the symbiotic algae living within their tissues, causing the corals to lose their vibrant colors and lead to stress, disease, and ultimately, death. Higher ocean temperatures, partly driven by global warming, can trigger coral bleaching by disrupting the delicate symbiotic relationship between corals and the algae which provide them with essential nutrients.

While the primary cause of coral bleaching is rising ocean temperatures, it is crucial to address the underlying factors contributing to global warming, such as CO₂ emissions from various sources, including the production of Portland cement. Reducing CO₂ emissions and transitioning to more sustainable materials and practices is vital to mitigate the impacts of global warming on coral reefs and the overall health of our oceans.

Portland cement, which is commonly used as a substrate in coral restoration and reallocation projects, has negative effects on coral growth when it comes into direct contact with corals and coral reefs. The high pH and alkalinity of Portland cement harms corals and other marine organisms. When cement is mixed with water, it undergoes a chemical reaction called hydration, which increases the pH and alkalinity of the surrounding water. This elevated pH can cause tissue damage, interfere with the photosynthetic processes of zooxanthellae algae, and inhibit the growth of coral polyps. Furthermore, Portland Cement releases, i.e., leaches, various chemical compounds into the water, such as aluminum and various heavy metals, which are toxic to corals. These compounds interfere with the coral's ability to build and maintain its calcium carbonate skeleton, leading to reduced growth and overall reef health.

There remains an unmet need for shaped cementitious composition which does not produce significate CO₂ during manufacturing, and which encourages coral proliferation for restoration of coral reefs.

### BRIEF SUMMARY

The present disclosure relates to a shaped cementitious composition that is far more favorable for coral proliferation when compared to conventional Portland cement, pozzolan-modified Portland cement, or other carbonate-based and/or sodium-based binders. The shaped cementitious composition of the present disclosure has a chemical constitution that is significantly different from calcium-based cement, in that the main constituents at the surface of the material are hydrostatic and are other magnesium-based minerals. This causes the surface pH of the shaped cementitious composition of the present disclosure to be significantly lower than the pH of a calcium-based concrete.

An aspect of the present disclosure is a shaped cementitious composition that comprises comprising a substrate for aquatic flora and/or fauna attachment. The shaped cementitious composition is formed from a pourable cementitious mixture comprising: (a) a pozzolan comprising a natural pozzolan and/or a manmade pozzolan; (b) MgO and/or Mg(OH)₂; (c) an aqueous solution comprising one or more accelerants; and (d) at least one aggregate. In some cases, the MgO and/or Mg(OH)₂ of (b) is included in the aqueous solution of (c). And, in various cases, the manmade pozzolan comprises a slag.

Another aspect of the present disclosure is a method for providing a substrate for aquatic flora and/or fauna attachment. The method comprising depositing any-herein described shaped cementitious composition, into a natural or artificial body of water which comprises aquatic flora and/or fauna in need of an attachment.

An additional aspect of the present disclosure is a method for making any-herein described shaped cementitious composition. The method comprising manufacturing a pourable cementitious mixture comprising steps of: (1) mixing (a) a pozzolan comprising a natural pozzolan and/or a manmade pozzolan; (b) MgO and/or Mg(OH)₂; (c) an aqueous solution comprising one or more accelerants; and (d) at least one aggregate; and (2) pouring the cementitious mixture into a mold. In some cases, the MgO and/or Mg(OH)₂ of (b) is included in the aqueous solution of (c). In various embodiments, the manmade pozzolan comprises a slag.

A further aspect of the present disclosure is a method for making any-herein described shaped cementitious composition. The method comprises manufacturing a pourable cementitious mixture comprising steps of: (1) mixing (a) a pozzolan comprising a natural pozzolan and/or a manmade pozzolan; (b) MgO and/or Mg(OH)₂; (c) an aqueous solution comprising one or more accelerants; and (d) at least one aggregate; and (2) extruding the pourable cementitious mixture via a 3-D printer. In some cases, the MgO and/or Mg(OH)₂ of (b) is included in the aqueous solution of (c). In various cases, the manmade pozzolan comprises a slag.

Any composition or method disclosed herein is applicable to any herein-disclosed composition or method. In other words, any aspect or embodiment described herein can be combined with any other aspect or embodiment as disclosed herein.

### BRIEF DESCRIPTION OF THE DRAWINGS

FIG. 1 is a photograph showing a herein disclosed shaped cementitious compositions having numerous corals attached thereto.

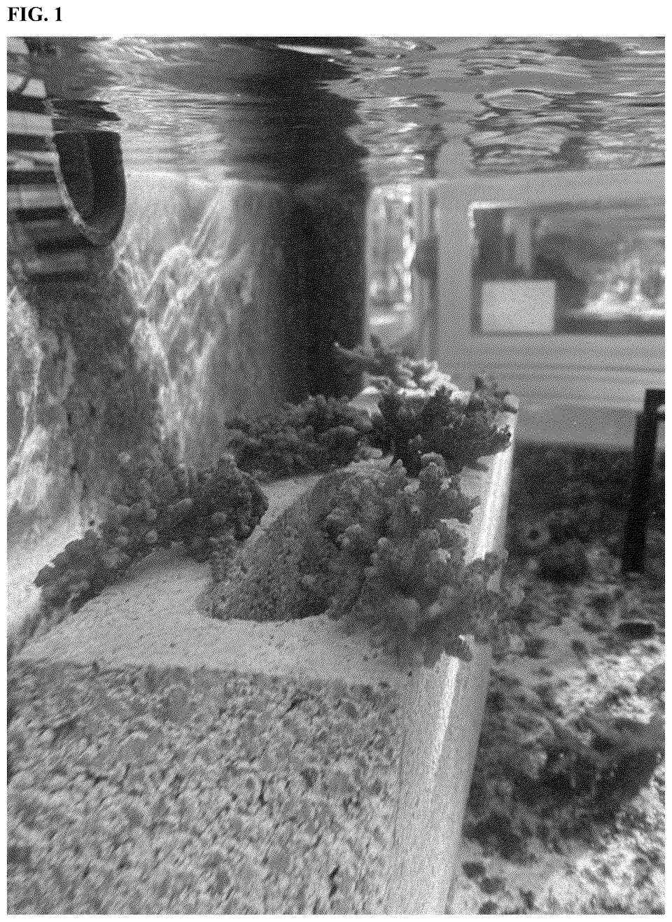

### DETAILED DESCRIPTION

Aspects of the present disclosure include shaped cementitious compositions that comprise a substrate for aquatic flora and/or fauna attachment; methods for providing a substrate for aquatic flora and/or fauna attachment comprising depositing a shaped cementitious composition into a body of water; and methods for making a shaped cementitious composition. The shaped cementitious composition is formed from a pourable cementitious mixture comprising: (a) a pozzolan comprising a natural pozzolan and/or a manmade pozzolan; (b) MgO and/or Mg(OH)₂; (c) an aqueous solution comprising one or more accelerants; and (d) at least one aggregate. In some cases, the MgO and/or Mg(OH)₂ of (b) is included in the aqueous solution of (c). And, in various cases, the manmade pozzolan comprises a slag.

### Introduction

The present disclosure relates to a shaped cementitious composition that is far more favorable for coral proliferation when compared to conventional Portland cement, pozzolan-modified Portland cement, or other carbonate-based and/or sodium-based binders. The shaped cementitious composition has a chemical constitution that is significantly different from calcium-based cement, since the main constituents of the cementitious composition's surface are hydrostatic and are other magnesium-based minerals. This causes the surface pH of the shaped cementitious composition to be significantly lower than the pH of a calcium-based concrete.

The present inventions address the need for an adaptable and sustainable cementitious composition that does not produce CO₂ during manufacturing, and which encourages and facilitates coral regeneration and relocation. Notable feature of the shaped cementitious composition of the present disclosure:
1. The shaped cementitious composition of the present disclosure maintains, local pH and salinity levels which promotes coral growth. In some embodiments, concentrated sea water, or brine, is used in the production of the cementitious composition; the cementitious composition's manufacturing reduces the amount of brine that is ejected into the sea, which is harmful to corals. A shaped cementitious composition of the present disclosure has a concentration of nutrients and naturally matching pH levels that coral needs to be healthy.
2. A shaped cementitious composition of the present disclosure is adaptable. It has the ability to be porous or dense, depending on what is needed to promote growth of coral in one area and restrict growth in another. A shaped cementitious composition of the present disclosure has the ability to use locally-sourced materials to respond to regional needs and regional availability.
3. A shaped cementitious composition of the present disclosure provides a better attachment substrate for corals. The material itself promotes the chemical reactions that create strong attachment. The material can also be used in innovative ways to improve coral relocation.
4. A shaped cementitious composition of the present is more stable, strong, and mitigate currents and storm surges when compared to standard concrete. Using hydrodynamic innovations, a shaped cementitious composition of the present disclosure can also lower localized water temperatures.

### Summary of the Coral Life Cycle.

The life cycle of coral, either soft or hard, begins with larva, formed in the seawater after spawning. The larva drifts with the currents, until it encounters a substrate to which it can attach. The larva excretes a sticky mucus which provides the initial binding of the larva to the substrate. The larva then uses carboxy amylase to fix carbon dioxide from the seawater, to produce bicarbonate which begins to adjust the substrate's surface pH to one that is more compatible with the larva's life processes. Over time, the larva develops into a coral polyp.

Coral polyps extract calcium and carbonate ions from the surrounding seawater. These ions are essential building blocks for the formation of calcium carbonate. The coral polyps secrete a calcium carbonate skeleton, which serves as the structural framework of the coral colony. This skeleton is composed of aragonite, a crystalline form of calcium carbonate. The coral polyps also produce a thin layer of tissue known as the coral's living layer, which covers its calcium carbonate skeleton. This layer contains the polyps' soft tissues and a symbiotic, photosynthetic algae, called zooxanthellae, which lives within the coral polyps.

The zooxanthellae, through photosynthesis, produces organic compounds, such as sugars and amino acids, which provide energy and nutrients to the coral polyps. Indeed, coral polyps primarily obtain their nutrients through the symbiotic relationship with zooxanthellae. In return, the coral polyps provide a protected environment and access to sunlight for the zooxanthellae.

As a coral colony grows, new polyps are added, in some cases by asexual reproduction, and the calcium carbonate skeleton continues to expand. Over time, this growth forms the intricate structures and shapes that we associate with coral reefs.

### A Shaped Cementitious Composition of the Present Disclosure Improves Coral Growth.

The shaped cementitious composition of the present disclosure is a concrete having a surface that is more favorable to the attachment of coral larva, and their development into coral polyps, when compared to conventional Portland cement, pozzolan-modified Portland cement, or other carbonate-based and/or sodium-based binders.

The shaped cementitious composition of the present disclosure has a chemical constitution that is significantly different from calcium-based cement, in that the main constituents at the surface of the material are hydrostatics and other magnesium-based minerals. This causes the surface pH of the shaped cementitious composition to be significantly lower than the pH of a calcium-based concrete.

The pH of most seawater is in the range of 7.9 to 8.5. Limestone, and metamorphic and igneous rocks, which form the natural substrate for coral larval attachment have a neutral pH, and have no soluble material.

The inter cellular pH (pHi) required for coral larva to thrive, and develop into a polyp, is considerably lower than that of seawater. On neutral surfaces, such as naturally-occurring rock, this is not problematic since the coral larva rapidly decreases the pH of the rock's surface. When Portland cement and other synthetic concrete materials are used to form substrates for the propagation of coral larva, there is a significant difference between its the surface pH and the preferred pH for coral, causing harm by inhibiting the development of the larva into a polyp. In contrast, the shaped cementitious composition of the present disclosure has a lower surface pH than that of standard concrete.

A coral larva is provided with a limited amount of energy from its parents upon fertilization and this limited amount of energy is all that is available for the larva to perform its early life processes and until it becomes attached to a substrate and develops its mature digestive structures, including its gut and feeding parts. In order to do this efficiently, it needs to adjust the environment between its cells to the pHi. This pHi allows its life processes to operate at a considerably lower energy cost. For this reason, the pH of the surface it is attaching to is a critical predictor of success.

The shaped cementitious composition of the present disclosure requires 100-fold less bicarbonate than would be required for a substrate comprising a calcium-based binder (e.g., Portland cement). Thus, a coral larva has a much lower energy cost to attach to a shaped cementitious composition of the present disclosure than to standard concrete.

For similar reasons, the mucus that the larva uses initially attach itself to a substrate is affected by surface pH. Evolutionary wise, there are few acidic surfaces present in seawater due to the elevated pH. The closer the surface chemistry of a substrate material to a coral's ideal surface chemistry, such as the shaped cementitious composition of the present disclosure, the less energy from the coral larva that is needed to attach and develop is needed. And, the less larval energy needed, the more likely that the larva will attach and develop, and ultimately, that a larval colony can form.

Although pH is an important factor for coral growth, it is just one piece of the puzzle. The shaped cementitious composition of the present disclosure is a holistic approach to coral growth. To promote coral growth, conditions that mimic their natural environment as closely as possible should be created, rather than relying solely on pH adjustments. These conditions include, as examples, salinity, nutrient levels, and available minerals.

### A Shaped Cementitious Composition of the Present Disclosure is Better for Coral Propagation.

Coral propagation begins when settlement of coral larva or broken fragments of adult coral land on a substrate. The substrate produces abrasions in the coral tissue, inducing a contact response. First, the corals secrete mucus at the abrasions, which attaches the coral to the substrate. At the sites of mucus build-up, the coral tissue reorganizes. The corals produce gut filaments which attach to the substrate, creating an enclosed space at the tissue-substrate interface. These filaments produce mucus, digest matter, and excrete metabolites onto the substrate. As more and more filaments accumulate, the attachment to the substrate is stabilized, but the attachment is still relatively weak. Then, an appendage forms containing cells that build the coral's calcite skeleton. The skeleton's development leads to a stable, permanent attachment to the substrate. The skeleton is formed in a fluid between the coral tissue and specialized cells on the outside of the coral. The pH of this fluid is elevated by ˜0.2 to 0.5 pH units relative to the surrounding seawater, and is regulated by removal of protons. Maintenance of intercellular pH in response to a perturbation of higher magnitude (i.e., needing to compensate for a larger pH differential between the organism and its environment), has a higher energetic and resource cost for the organism, as it would need to dedicate resources that it could be using to develop and grow.

### A Shaped Cementitious Composition of the Present Disclosure is Better for Coral Relocation.

Coral relocation, also known as coral translocation or coral gardening, is a conservation technique used to move corals from one location to another. It is employed for several reasons including to protect corals from threats such as coastal development, pollution, or damage caused by human activities. The goal of coral relocation is to preserve and restore coral populations, enhance biodiversity, and promote the recovery of damaged or degraded coral reef ecosystems.

The process typically involves one of two methodologies. The first is carefully removing sections of healthy coral colonies from their original habitat and transplanting them to a new location where they can thrive under more favorable conditions. The second, and more common approach to coral relocation, involves creating new reefs by placing nursery-grown corals on concrete substrates in the ocean. This method, often referred to as coral gardening or reef restoration, aims to facilitate the growth and establishment of corals in areas where natural reefs have been damaged or destroyed. Nursery-grown corals, propagated through techniques like coral fragmentation or larval propagation, are carefully attached to substrates, such as specially designed structures or artificial reef modules. To date, the most common substrate that is used has been Portland cement structures. However, for the reasons discussed elsewhere in this disclosure, use of Portland cement has many drawbacks, including leeching and pH issues. Thus, Portland cement-based structures are ill-suited for coral growth promotion. The cementitious composition of the present disclosure provides stable and durable platform that promotes coral attachment and growth, thereby mimicking the natural substrate of coral reefs. Over time, the corals will colonize the shaped cementitious composition of the present disclosure, initiating the formation of a new reef ecosystem. This approach not only helps to restore lost or degraded reef habitats but also enhances the speed at which these reefs are able to form.

A Shaped Cementitious Composition of the Present Disclosure is Adaptable, May be Made from Local Materials, and Includes Brine.

Coral types vary from region to region in part due to mineral availability. Because the shaped cementitious composition of the present disclosure is adaptable to and can be made from region-specific materials, i.e., locally-sourced materials, the regional coral is more receptive to the shaped cementitious composition of the present disclosure. Coral growth is promoted because these materials contain essential minerals and nutrients that are naturally present in the local marine environment. These minerals are essential for coral skeletal formation and overall health. The alkalinity and PH levels of the substrate materials can also impact coral growth. Locally-sourced materials that help maintain stable alkalinity and pH levels in the surrounding water create a favorable environment for coral calcification and growth. Maintaining proper water chemistry is crucial for coral health and reef development. Also, local aggregate materials that mimic natural coral substrate textures can enhance coral settlement and growth. Using locally-sourced materials for coral substrates help create a habitat that is more closely aligned with the natural conditions of the surrounding reef ecosystem. Corals that are exposed to locally-sourced materials from an early stage are more adapted to the specific environmental factors of the area, enhancing their resilience and growth potential. A shaped cementitious composition of the present disclosure is adaptable and can use regional materials to create a curable mix to form coral substrate.

This adaptability of material also enhances wanted and selected microorganisms and discourage unwanted microorganisms.

A shaped cementitious composition of the present disclosure includes concentrated sea water and/or brine, during its manufacture. In many cases, high-salinity brine, e.g., an output from a desalination facility, is ejected into oceans and in the areas where coral grows. This high-salinity brine has a significant negative impact on sea life and coral, resulting in death of coral reefs. A shaped cementitious composition of the present disclosure uses this high salinity during manufacture instead of it being ejected into the sea. A shaped cementitious composition of the present disclosure is made from concentrated levels of minerals found in the sea; elements and minerals that coral need to grow. These elements are naturally present in seawater and are absorbed by the coral polyps as needed.

Coral requires several key nutrients to support its growth and development; all found at high amounts in the shaped cementitious composition of the present disclosure. These key nutrients include calcium, carbonate, magnesium, strontium, and trace elements. Calcium is a crucial nutrient for coral growth, as it forms the main building block of the coral skeleton. Coral polyps extract calcium ions from the surrounding seawater and use them to build their calcium carbonate skeleton. Carbonate ions are essential for coral calcification. Coral polyps combine carbonate ions with the extracted calcium ions to form calcium carbonate, which makes up the structural framework of the coral colony. Magnesium is another important element for coral growth. It helps regulate the formation of calcium carbonate, influencing the density and strength of the coral skeleton. Magnesium is naturally present in seawater and is absorbed by coral polyps. Strontium is a trace element that plays a role in coral skeletal development. It helps enhance coral growth and calcification processes. Various trace elements, including iron, iodine, manganese, and others, are necessary for coral health and growth. These elements serve as cofactors for enzymes and play roles in metabolic processes within the coral polyps.

### A Shaped Cementitious Composition of the Present Disclosure Mitigates Algae Growth.

A shaped cementitious composition of the present disclosure can be adaptable to mitigate undesirable algal growth. Traditional concrete, which contains Portland cement, can provide a suitable environment for algal growth due to its porous nature and the presence of nutrients. Algal growth is typically promoted by the presence of moisture, nutrients, and sunlight. However, the shaped cementitious composition of the present disclosure has a denser structure and fewer pores when compared to traditional concrete, which makes it less favorable for algae colonization. Some studies have shown that magnesium-based materials can inhibit the growth of microorganisms, including algae, due to the alkaline and antimicrobial properties of magnesium compounds. As mentioned elsewhere herein, the shaped cementitious composition of the present disclosure has relatively high levels of magnesium.

### Coral Attaches Better to a Shaped Cementitious Composition of the Present Disclosure.

Coral is formed through a process called calcification, which involves the deposition of calcium carbonate (CaCO₃) by coral polyps. Coral polyps are tiny animals that live in colonies and have a symbiotic relationship with photosynthetic algae called zooxanthellae. The essential elements for coral growth are typically obtained from the surrounding seawater. However, because a shaped cementitious composition of the present disclosure is made from the minerals in concentrated seawater, there is an abundance of elements in the shaped cementitious composition that coral need to grow.

As an example, calcium is the primary cation used by marine organisms for calcification due to its abundance in seawater and its chemical properties that facilitate the formation of calcium carbonate structures. Magnesium plays a role in the calcification process and is primarily involved in regulating the crystal structure and composition of calcium carbonate minerals. Magnesium ions can substitute for some of the calcium ions in the crystal lattice, positively influencing the growth and properties of the calcium carbonate structure.

A shaped cementitious composition of the present disclosure, when compared to standard Portland cement, has different compositions and properties, which can affect their suitability as substrates for coral growth. A shaped cementitious composition of the present disclosure contains better adhesive properties compared to other types of cement due to its unique composition and chemical reactions. The adhesion of a coral larva or coral polyp to a shaped cementitious composition of the present disclosure can be attributed, at least in part, to magnesium oxychloride crystals. These crystals can interact with the coral's skeletal structure, providing a strong bond between the cementitious composition and the coral. The formation of magnesium oxychloride crystals during the hardening process of the shaped cementitious composition of the present disclosure creates a rough and textured surface. This surface provides an ideal substrate for coral attachment and settlement. The roughness of the cement allows corals to secrete calcium carbonate and other substances that help them anchor and grow on the substrate.

A Shaped Cementitious Composition of the Present Disclosure Performs Better with Foaming Agents.

The density and fineness of cement has an impact on its performance when used with foaming agents in concrete mixtures. In general, a denser and finer cement works better with foaming agents compared to coarser cements for certain applications. A shaped cementitious composition of the present disclosure is a far more fine and dense cement when compared to a traditional Portland Cement. The relationship between cement density, fineness, and the use of foaming agents can be explained in the following two points. Finer cement particles have a larger surface area, which can enhance the reactivity and hydration process when mixed with water and other additives. This increased surface area allows for better dispersion of foaming agents within the cement matrix, resulting in a more uniform distribution of air voids and improved foam stability. As a result, finer cements achieve better foam generation and stability when combined with foaming agents. The cementitious composition which is formed into a shaped cementitious composition of the present disclosure is exponentially finer than a standard Portland Cement. The density of the cement has an impact on the strength and properties of the foamed product. In general, a denser cement contributes to the overall strength of the foamed concrete. The density of the cement influences the packing of particles within the concrete mixture, which can affect the overall strength and durability of the foamed concrete blocks. Denser cements typically have a more compact structure with fewer voids, leading to better interparticle bonding and improved load-bearing capacity. This results in higher compressive strength and better overall performance of the foamed concrete when a shaped cementitious composition of the present disclosure is used.

### A Shaped Cementitious Composition of the Present Disclosure can be Designed to Better Accept Coral Relocations.

Because a shaped cementitious composition of the present disclosure performs better with concrete foams, a much wider range of product can be made. A shaped cementitious composition of the present disclosure has a surface with a rough texture, which mimics natural coral habitats, and which provides a substrate for coral larvae attachment; thereby, creating an innovative product with benefits for marine conservation efforts. Foam can be used in the concrete mix to create voids and a porous structure that can mimic natural coral habitats. The foam is added in a controlled manner to achieve the desired texture and porosity in the concrete block suitable to the needs of the coral. The surface of the shaped cementitious composition of the present disclosure product can be modified with foams, and textured in other ways, to create a rough texture that can provide attachment points for coral larvae. These techniques can be employed to create a surface that is conducive to coral settlement and growth. Aggregates can be incorporated into the concrete mix to enhance the texture and roughness of the shaped cementitious composition of the present disclosure's surface which can help create a substrate that is more suitable for coral larvae attachment.

In addition, lightweight, foamed shaped cementitious composition of the present disclosure can be made for coral relocation. These structures can be placed without the use of heavy equipment. In some instances, they are designed to simply be pushed off of a watercraft, and with the innovative hydrofoil design, land on its feet on the ocean floor, replacing the need for divers to place or even plant the structures under water. In addition, because of the shaped cementitious composition of the present disclosure properties, the structure can be made with qualities similar to Styrofoam in that the farmed coral tile could be pressed into the substrate and stay secured. This eliminates the need for mechanical attachments which are expensive, corrode and take longer to attach. Moreover, because the entire structure is able to receive farmed coral tiles, coral is then able to be reactively planted based on environmental conditions-instead of prescriptively planted based on singular locations of mechanical attachments.

### A Shaped Cementitious Composition of the Present Disclosure May Locally Reduce Water Temperatures.

A shaped cementitious composition of the present disclosure has a higher thermal mass and other properties that absorbs and stores heat more effectively when compared to Portland cement products that are unable to absorb heat. A shaped cementitious composition of the present disclosure is a hydraulic material (which gets stronger in the presence of water), absorbs heat from the surrounding environment, and dissipates the heat over time with the help of the cementitious composition's convection cooling principles discussed below. A shaped cementitious composition of the present disclosure has good thermal conductivity along with heat absorption and storage properties, providing thermal insulation for coral growth. To increase these benefits, a shaped cementitious composition of the present disclosure is also able to pump the cooler sub-floor water through the center of the structures, lowering the overall temperature of the structures as well as the surrounding waters. In an environment where every one tenth of a degree in temperature matters for the promotion of coral growth, a shaped cementitious composition of the present disclosure provides significant advances with respect to reducing increased local temperature.

Another issue that has greatly affected ocean and sea temperatures, particularly along coasts where corals grow, is brine discharged from coastal desalination facilities. Brine from desalination facilities raise ocean temperatures in the local vicinity where it is discharged. Desalination facilities extract freshwater from seawater through a process that leaves behind a concentrated brine solution. When this brine is discharged back into the ocean, it introduces higher concentrations of salt and other substances, which affect the surrounding marine environment.

The discharge of brine from a desalination facility leads to localized impact upon ocean temperatures for several reasons. The brine discharged from desalination facilities typically has higher salinity than the surrounding seawater. This denser brine can sink and create a layer of higher salinity water near the discharge point, which affects temperature gradients in the area as well as negatively impacts and/or kills surrounding sea life, including coral. The discharge of brine at elevated temperatures contributes to thermal pollution of the ocean. The heat contained in the brine raises the temperature of the surrounding water, affecting marine organisms and ecosystems in the vicinity. High water temperatures are the leading cause of bleaching and death of coral. The introduction of brine with different salinity and temperature properties affects ocean currents and mixing processes in the area. This leads to changes in water circulation patterns and temperature distributions near the discharge point. Because a shaped cementitious composition of the present disclosure uses brine in its production, the amount of brine discharged into the oceans is reduced; which reduces these negative impacts. Theoretically, use of a shaped cementitious composition of the present disclosure will be able to eliminate all brine discharge into the oceans.

### A Shaped Cementitious Composition of the Present Disclosure Mitigates Ocean Acidification.

Ocean acidification is a process driven by the increasing levels of carbon dioxide (CO₂) in the atmosphere, which is absorbed by the oceans, leading to a decrease in pH and changes in the chemistry of seawater. This acidification poses significant threats to marine ecosystems and organisms, including coral reefs, shellfish, and other marine life. A shaped cementitious composition of the present disclosure is a tool to help counteract ocean acidification through a process known as mineral carbonation. Mineral carbonation involves the chemical reaction of carbon dioxide with minerals to form stable carbonate compounds, effectively removing CO₂ from the atmosphere and reducing its impact on ocean acidification. Because a shaped cementitious composition of the present disclosure is a hydraulic cement, this process occurs under water as well.

A shaped cementitious composition of the present disclosure mitigates ocean acidification in several ways. A shaped cementitious composition of the present disclosure captures and stores carbon dioxide through a process called carbonation. When a shaped cementitious composition of the present disclosure is exposed to CO₂ above or below the surface of the water, a reaction with the carbon dioxide occurs to form magnesium carbonate and/or calcium carbonate, a stable compound that effectively removes carbon from the atmosphere and oceans. If cured above water, the process helps to reduce the amount of CO₂ available to dissolve in seawater and contribute to ocean acidification. If cured below water, the process removes the dissolved CO₂ from the ocean as well. The carbonation of a shaped cementitious composition of the present disclosure releases alkaline compounds, such as magnesium hydroxide, which can help buffer the acidity of seawater and raise its pH. By increasing the alkalinity of seawater, a shaped cementitious composition of the present disclosure can counteract the acidification effects of dissolved CO₂ and promote a more stable chemical environment for marine organisms. Magnesium and calcium carbonate, the product of the curing process of a shaped cementitious composition of the present disclosure, are stable minerals that can persist in the environment for long periods, effectively locking away carbon dioxide and preventing its release back into the atmosphere or oceans. This long-term stability enhances the effectiveness of a shaped cementitious composition of the present disclosure as a carbon removal tool to mitigate ocean acidification.

A Shaped Cementitious Composition of the Present Disclosure can be Formed into Hydrodynamic Structures.

Shaped cementitious composition of the present disclosure can be designed using hydrodynamic principles to create more efficient, resilient, and sustainable shaped cementitious compositions and which also promote coral growth. The hydrofoil shape is designed to efficiently redirect the flow of water, which reduces pressure on the structure by minimizing drag and turbulence caused by the currents. By harnessing the principles of hydrodynamics, the shape of the hydrofoil streamlines the flow of water around the structure, reducing the forces exerted by the currents and enhancing the overall stability of the underwater structure. A shaped cementitious composition of the present disclosure uses both Bernoulli's Principle and Drag and Lift principles to create various coral structures that can also be used for integrated breakwater protection. Bernoulli's Principle asserts that in a flowing fluid, an increase in the speed of the fluid occurs simultaneously with a decrease in pressure or a decrease in the fluid's potential energy. Drag and Lift principles describe the forces exerted on an object in a fluid flow. Drag is the force acting opposite to the direction of motion, while lift is a perpendicular force generated due to pressure differences around an object.

A shaped cementitious composition of the present disclosure applies these principles in innovative and novel ways through the following engineering frameworks. Designing underwater concrete structures with hydrodynamic shapes, such as streamlined profiles inspired by marine animals like dolphins or fish, to reduce drag and turbulence caused by water currents. These shapes help minimize resistance and improve the overall performance of the structure in dynamic underwater environments. Because the shaped cementitious composition of the present disclosure can be cast with a far smoother surface than typical Portland cement surfaces, this dynamic is exponentially increased. Incorporating passive flow control devices, such as vortex generators or riblets, on underwater concrete structures can manipulate fluid flow patterns and reduce drag. These devices help optimize the efficiency of the structure by controlling boundary layer separation and turbulence. These devices are also used in innovative ways to provide stability in the structure and increase anchoring dynamics in the base of the coral structure. Implementing surface texture modifications, such as riblets, dimples, or coatings, on underwater concrete structures can alter the flow characteristics and reduce drag forces. These modifications can enhance the hydrodynamic performance of the structure and improve its stability in turbulent conditions. Because a shaped cementitious composition of the present disclosure has increased surface texture ranges, including enhanced crystalline structures, these dynamics are exponentially increased. Utilizing flexible joint systems in underwater concrete structures allows for movement and deformation in response to hydrodynamic forces. These systems help distribute loads more effectively, reduce stress concentrations, and enhance the overall durability and longevity of the structure. A shaped cementitious composition of the present disclosure can be used to create fully integrated joint systems that are far more durable and eliminate petrochemical products such as rubber joint systems that need replacing. Incorporating advanced composite materials, such as fiber-reinforcing or composites, in the construction of underwater concrete structures can improve strength-to-weight ratio, corrosion resistance, and hydrodynamic performance. These materials offer enhanced durability and structural integrity in harsh underwater environments. A shaped cementitious composition of the present disclosure performs far better with fibers and composites when compared to traditional cement, making the use of these elements exponentially more effective. If water is moving faster along a surface, it has a cooling effect on the surface. This phenomenon is known as convective cooling, where the movement of a fluid (in this case, water) helps dissipate heat from the surface it flows over. When water flows faster along a surface, it carries away more heat from the surface through convection. As the water moves, it absorbs heat from the surface and transports it away, replacing the warmer water with cooler water. This continuous flow of cooler water helps lower the temperature of the surface. In practical terms, this cooling effect can be observed in various situations, such as in rivers or streams where fast-flowing water can help cool down rocks or surfaces along the riverbed. Similarly, the increased flow of water with the use of the shaped cementitious composition of the present disclosure hydrofoil technology over surfaces cool and regulate temperature and dissipate heat efficiently. The faster flow of water helps remove heat from the surface and maintain a lower temperature. Heat is the leading cause of coral bleaching and destruction. The reduction of heat is critical to maintaining the life of corals along with being able to support large ranges of genotypes in any particular region.

### A Shaped Cementitious Composition of the Present Disclosure Provides Climate Resilience.

For all of the reasons above, a shaped cementitious composition of the present disclosure promotes, through novel materials and methods, a far healthier coral reef which buffers coastal communities against the impacts of climate change. These solutions exist in both the promotion of sea life as well as structural and dynamic protection of the coast. Because a shaped cementitious composition of the present disclosure also absorb carbon and create monetary value of carbon credits, these mitigation efforts, of coral regeneration and coastal protection, are incentivized.

### Shaped Cementitious Compositions

An aspect of the present disclosure is a shaped cementitious composition that comprises a substrate for aquatic flora and/or fauna attachment.

The shaped cementitious composition is formed from a pourable cementitious mixture comprising: (a) a pozzolan comprising a natural pozzolan and/or a manmade pozzolan; (b) MgO and/or Mg(OH)₂; (c) an aqueous solution comprising one or more accelerants; and (d) at least one aggregate. In some cases, the MgO and/or Mg(OH)₂ of (b) is included in the aqueous solution of (c). And, in various cases, the manmade pozzolan comprises a slag.

In embodiments, the aqueous solution comprises a high salinity brine.

In some embodiments, the salt concentration of the high salinity brine is greater than or about equal to the salt concentration of seawater.

In various embodiments, the high salinity brine comprises water with a salt concentration (e.g., chloride, sulphate, and sodium) higher than 50 parts per thousand.

In numerous embodiments, the high salinity brine is treated prior to manufacturing the pourable cementitious mixture to reduce the amount of sodium, sulphates, and/or chloride. In some cases, the brine has reduced amounts of sodium, potassium, chloride, sulphate, magnesium, and/or calcium ions via chemical precipitation, electrochemical methods, ion selective membranes, reverse osmosis, and/or selective precipitation by pH. In various cases, the chemical precipitation comprises contacting the sodium, potassium, chloride, sulphate, magnesium, and/or calcium ions with lime (calcium hydroxide, Ca(OH)₂) or alum (aluminum sulfate, Al₂(SO₄)₃) which forms insoluble precipitates with the sodium, potassium, chloride, sulphate, magnesium, and/or calcium ions. In numerous cases, the sodium is reduced via a method known in the art, e.g., via a chloralkali process. In certain cases, the sodium is collected.

In several embodiments, the high salinity brine is obtained from a desalination facility, is natural seawater, or an industrial brine.

In many embodiments, the pourable cementitious mixture further comprises CO₂.

In embodiments, the pourable cementitious mixture comprises at least 0.04 kg CO₂ per kg of the mixture.

In embodiments, the CO₂ is chemically reacted to form a crystalline form of carbon.

In some embodiments, the CO₂ is absorbed into the pourable cementitious mixture as a crystalline form of carbon.

In various embodiments, the CO₂ is from industrial waste, from environmental sources, or from molecular capture. In some cases, the industrial waste relates to alcoholic fermentation or the burning of fossil fuels.

In numerous embodiments, the CO₂ is provided in gaseous, solid, and/or as a supercritical fluid form or as a dissolved gas.

In several embodiments, the CO₂ is incorporated into the pourable cementitious mixture as a carbonate.

In many embodiments, the shaped cementitious composition retains carbon dioxide of at least 5% by weight of the shaped cementitious composition over a 15-year period.

In embodiments, the shaped cementitious composition retains carbon dioxide of about 5% by weight to about 16% by weight of the shaped cementitious composition over a 15-year period.

In embodiments, the pourable cementitious mixture absorbs more CO₂ during its manufacture than is emitted.

In some embodiments, the pourable cementitious mixture comprises more CO₂ per gram than a standard cement.

In various embodiments, the pourable cementitious mixture comprises up to 50% more CO₂ per gram than a standard cement.

In numerous embodiments, the pourable cementitious mixture requires less bicarbonate per gram than a standard cement.

In several embodiments, the pourable cementitious mixture comprises more calcium, carbonate, silicon, aluminum, magnesium, strontium, iodine, manganese, and/or iron per gram than a standard cement.

In many embodiments, the pourable cementitious mixture comprises up to 50% more calcium, carbonate, silicon, aluminum, magnesium, strontium, iodine, manganese, and/or iron per gram than a standard cement.

In embodiments, the pourable cementitious mixture comprises more concentrated levels of minerals found in the sea than a standard cement.

In embodiments, the pourable cementitious mixture comprises more magnesium oxychloride crystals than a standard cement.

In some embodiments, the pourable cementitious mixture comprises more hydrostatics than a standard cement.

In various embodiments, the pourable cementitious mixture captures and stores more CO₂, through a process called carbonation, than a standard cement.

In numerous embodiments, the cementitious composition help reduce ocean acidification, through a process known as mineral carbonation, more than a standard cement.

In several embodiments, the cementitious composition mitigates undesirable algal growth when compared a standard cement.

In many embodiments, the cementitious composition has a higher thermal mass which effectively absorbs and stores heat than a standard cement.

In embodiments, the pourable cementitious mixture comprises more numerous pores, e.g., voids, per unit volume and/or larger average pores than a standard cement.

In embodiments, the pourable cementitious mixture is less dense per unit volume than a standard cement.

In some embodiments, the pourable cementitious mixture comprises fewer pores, e.g., voids, per unit volume and/or smaller average pores than a standard cement.

In various embodiments, the pourable cementitious mixture is denser per unit volume than a standard cement.

In numerous embodiments, the standard cement comprises CaO, CaCO₃, SiO₂, Al₂O₃, Fe₂O₃, and CaSO₄·H₂O.

In several embodiments, the standard cement comprises a slaked or hydraulic dolomitic or calcareous lime blended with a natural or man-made pozzolanic or latently hydraulic material.

In many embodiments, the standard cement, e.g., a standard hydrated cement, is a Portland Cement comprising cement clinker rather than pozzolan, a pozzolan-modified Portland cement, or other carbonate-based and/or sodium-based binder.

In embodiments, the accelerant is one or more of nitrate, sulfate, sodium, chloride, phosphate, triethenolamine, calcium formate, silica fume, finely divided silica gel, and calcium chloride.

In embodiments, the at least one aggregate is selected from sand, gravel, lightweight aggregate, and crushed stone, or a combination thereof.

In some embodiments, the pourable cementitious mixture further comprises an activator selected from any sodium, lithium or potassium salt or hydroxide and any alkali or alkali earth metal ions.

In various embodiments, the pourable cementitious mixture further comprises an activator comprising one or more of Mg(OH)₂, MgO, Ca(OH)₂, CaCO₃, Al₂(SO₄)₃, and CaO.

In numerous embodiments, the amount of nitrate present relative to the amount of pozzolan ranges from about 2 wt. % to about 30 wt. %.

The cementitious compositions described herein (e.g., the shaped cementitious compositions) can comprise any proportion by weight of pozzolan in relation to the proportion of magnesium oxide (e.g., MgO) or magnesium hydroxide (e.g., Mg(OH)₂) by weight of the cementitious composition. The proportions can be calculated by the wet weight (e.g., the weight of the cementitious composition following the addition of a liquid such as water) or the dry weight (e.g., the weight of the cementitious composition prior to addition of a liquid such as water). The proportion of pozzolan by percentage weight can be about 30% to about 130% (e.g., about 30% to about 120%, about 30% to about 110%, about 30% to about 100%, about 30% to about 95%, about 30% to about 90%, about 30% to about 85%, about 30% to about 80%, about 30% to about 75%, about 30% to about 70%, about 30% to about 65%, about 30% to about 60%, about 30% to about 55%, about 30% to about 50%, about 30% to about 45%, about 30% to about 40%, about 30% to about 35%, about 35% to about 130%, about 40% to about 130%, about 45% to about 130%, about 50% to about 130%, about 55% to about 130%, about 60% to about 130%, about 65% to about 130%, about 70% to about 130%, about 75% to about 130%, about 80% to about 130%, about 85% to about 130%, about 90% to about 130%, about 95% to about 130%, about 100% to about 130%, about 110% to about 130%, about 120% to about 130%, about 95% to about 105%, about 90% to about 110%, about 85% to about 115%, about 80% to about 120%, or about 75% to about 125%) of the proportion of magnesium oxide (e.g., MgO) by percentage weight of the cementitious composition. The proportion of pozzolan by percentage weight can be about 30% to about 130% (e.g., about 30% to about 120%, about 30% to about 110%, about 30% to about 100%, about 30% to about 95%, about 30% to about 90%, about 30% to about 85%, about 30% to about 80%, about 30% to about 75%, about 30% to about 70%, about 30% to about 65%, about 30% to about 60%, about 30% to about 55%, about 30% to about 50%, about 30% to about 45%, about 30% to about 40%, about 30% to about 35%, about 35% to about 130%, about 40% to about 130%, about 45% to about 130%, about 50% to about 130%, about 55% to about 130%, about 60% to about 130%, about 65% to about 130%, about 70% to about 130%, about 75% to about 130%, about 80% to about 130%, about 85% to about 130%, about 90% to about 130%, about 95% to about 130%, about 100% to about 130%, about 110% to about 130%, about 120% to about 130%, about 95% to about 105%, about 90% to about 110%, about 85% to about 115%, about 80% to about 120%, or about 75% to about 125%) of the proportion of magnesium hydroxide (e.g., Mg(OH)₂) by percentage weight of the cementitious composition.

The sum of the proportions of magnesium oxide, magnesium hydroxide, and pozzolan can be any percentage by weight of the cementitious compositions described herein (e.g., the shaped cementitious compositions). The proportions or percentages can be calculated by the wet weight (e.g., the weight of the cementitious composition following the addition of a liquid such as water) or the dry weight (e.g., the weight of the cementitious composition prior to addition of a liquid such as water). The sum of the proportions of magnesium oxide, magnesium hydroxide, and pozzolan can be about 5% to about 90% (e.g., about 5% to about 85%, about 5% to about 80%, about 5% to about 75%, about 5% to about 70%, about 5% to about 65%, about 5% to about 60%, about 5% to about 55%, about 5% to about 50%, about 5% to about 45%, about 5% to about 40%, about 5% to about 35%, about 5% to about 30%, about 5% to about 25%, about 5% to about 20%, about 5% to about 15%, about 5% to about 10%, about 10% to about 90%, about 15% to about 90%, about 20% to about 90%, about 25% to about 90%, about 30% to about 90%, about 35% to about 90%, about 40% to about 90%, about 45% to about 90%, about 50% to about 90%, about 55% to about 90%, about 60% to about 90%, about 65% to about 90%, about 70% to about 90%, about 75% to about 90%, about 80% to about 90%, about 85% to about 90%, about 45% to about 55%, about 40% to about 60%, about 35% to about 65%, about 30% to about 70%, about 25% to about 75%, about 20% to about 80%, about 15% to about 85%, about 10% to about 85%, or about 15% to about 50%) by weight of the cementitious composition.

In several embodiments, the cementitious compositions (e.g., shaped cementitious compositions) described herein can comprise:
(a) magnesium oxide;
(b) a pozzolan (e.g., comprising one or both of slag cement and Class C fly ash);
(c) at least one accelerant (e.g., wherein the at least one accelerant comprises magnesium chloride, magnesium nitrate, magnesium sulfate, or a phosphate-based accelerant);
   wherein the at least one accelerant is about 5% to about 145% of the proportion of magnesium oxide by weight of the cementitious composition;
   wherein the proportion of pozzolan by percent weight can be about 30% to about 130% (e.g., about 90% to about 110%) of the proportion of magnesium oxide by percentage weight of the cementitious composition; and
   wherein the sum of the proportions of magnesium oxide and pozzolan is about 5% to about 90% (e.g., about 15% to about 50%) by weight of the cementitious composition.

In several embodiments, the cementitious compositions (e.g., shaped cementitious compositions) described herein can comprise:
(a) magnesium oxide;
(b) a pozzolan (e.g., comprising one or both of slag cement and Class C fly ash);
(c) at least one accelerant (e.g., wherein the at least one accelerant comprises magnesium chloride, magnesium nitrate, magnesium sulfate, or a phosphate-based accelerant);
   wherein the at least one accelerant is about 0.1% to about 30% of the proportion of magnesium oxide of the cementitious composition;
   wherein the proportion of pozzolan by percent weight can be about 30% to about 130% (e.g., about 90% to about 110%) of the proportion of magnesium oxide by percentage weight of the cementitious composition; and
   wherein the sum of the proportions of magnesium oxide and pozzolan is about 5% to about 90% (e.g., about 15% to about 50%) by weight of the cementitious composition.

In several embodiments, the cementitious compositions (e.g., shaped cementitious compositions) described herein can comprise:
(a) magnesium hydroxide;
(b) a pozzolan (e.g., comprising one or both of slag cement and Class C fly ash);
(c) at least one accelerant (e.g., wherein the at least one accelerant comprises magnesium chloride, magnesium nitrate, magnesium sulfate, or a phosphate-based accelerant);
   wherein the at least one accelerant is about 5% to about 145% of the proportion of magnesium hydroxide by weight of the cementitious composition;
   wherein the proportion of pozzolan by percent weight can be about 30% to about 130% (e.g., about 90% to about 110%) of the proportion of magnesium hydroxide by percentage weight of the cementitious composition; and
   wherein the sum of the proportions of magnesium hydroxide and pozzolan is about 5% to about 90% (e.g., about 15% to about 50%) by weight of the cementitious composition.

In several embodiments, the cementitious compositions (e.g., shaped cementitious compositions) described herein can comprise:
(a) magnesium hydroxide;
(b) a pozzolan (e.g., comprising one or both of slag cement and Class C fly ash);
(c) at least one accelerant (e.g., wherein the at least one accelerant comprises magnesium chloride, magnesium nitrate, magnesium sulfate, or a phosphate-based accelerant);
   wherein the at least one accelerant is about 0.1% to about 30% of the proportion of magnesium hydroxide of the cementitious composition;
   wherein the proportion of pozzolan by percent weight can be about 30% to about 130% (e.g., about 90% to about 110%) of the proportion of magnesium hydroxide by percentage weight of the cementitious composition; and
   wherein the sum of the proportions of magnesium hydroxide and pozzolan is about 5% to about 90% (e.g., about 15% to about 50%) by weight of the cementitious composition.

In several embodiments, the cementitious compositions (e.g., shaped cementitious compositions) described herein can comprise:
(a) magnesium oxide;
(b) a pozzolan (e.g., comprising one or both of slag cement and Class C fly ash);
(c) at least one accelerant (e.g., wherein the at least one accelerant comprises magnesium chloride, magnesium nitrate, magnesium sulfate, or a phosphate-based accelerant);
   wherein the at least one accelerant is about 5% to about 145% of the proportion of magnesium oxide by weight of the cementitious composition;
   wherein when the at least one accelerant comprises magnesium chloride or magnesium nitrate, a proportion by weight of MgCl₂ or Mg(NO₃)₂ is 0.1% to 30% of the proportion of magnesium oxide by weight of the cementitious composition.
   wherein the proportion of pozzolan by percent weight can be about 30% to about 130% (e.g., about 90% to about 110%) of the proportion of magnesium oxide by percentage weight of the cementitious composition; and
   wherein the sum of the proportions of magnesium oxide and pozzolan is about 5% to about 90% (e.g., about 15% to about 50%) by weight of the cementitious composition.

In several embodiments, the cementitious compositions (e.g., shaped cementitious compositions) described herein can comprise:
(a) magnesium oxide;
(b) a pozzolan (e.g., comprising one or both of slag cement and Class C fly ash);
(c) at least one accelerant (e.g., wherein the at least one accelerant comprises magnesium chloride, magnesium nitrate, magnesium sulfate, or a phosphate-based accelerant);
   wherein the at least one accelerant is about 0.1% to about 30% of the proportion of magnesium oxide of the cementitious composition;
   wherein when the at least one accelerant comprises magnesium chloride or magnesium nitrate, a proportion by weight of MgCl₂ or Mg(NO₃)₂ is 0.1% to 30% of the proportion of magnesium oxide by weight of the cementitious composition.
   wherein the proportion of pozzolan by percent weight can be about 30% to about 130% (e.g., about 90% to about 110%) of the proportion of magnesium oxide by percentage weight of the cementitious composition; and
   wherein the sum of the proportions of magnesium oxide and pozzolan is about 5% to about 90% (e.g., about 15% to about 50%) by weight of the cementitious composition.

In several embodiments, the cementitious compositions (e.g., shaped cementitious compositions) described herein can comprise:
(a) magnesium hydroxide;
(b) a pozzolan (e.g., comprising one or both of slag cement and Class C fly ash);
(c) at least one accelerant (e.g., wherein the at least one accelerant comprises magnesium chloride, magnesium nitrate, magnesium sulfate, or a phosphate-based accelerant);
   wherein the at least one accelerant is about 5% to about 145% of the proportion of magnesium hydroxide by weight of the cementitious composition;
   wherein when the at least one accelerant comprises magnesium chloride or magnesium nitrate, a proportion by weight of MgCl₂ or Mg(NO₃)₂ is 0.1% to 30% of the proportion of magnesium hydroxide by weight of the cementitious composition.
   wherein the proportion of pozzolan by percent weight can be about 30% to about 130% (e.g., about 90% to about 110%) of the proportion of magnesium hydroxide by percentage weight of the cementitious composition; and
   wherein the sum of the proportions of magnesium hydroxide and pozzolan is about 5% to about 90% (e.g., about 15% to about 50%) by weight of the cementitious composition.

In several embodiments, the cementitious compositions (e.g., shaped cementitious compositions) described herein can comprise:
(a) magnesium hydroxide;
(b) a pozzolan (e.g., comprising one or both of slag cement and Class C fly ash);
(c) at least one accelerant (e.g., wherein the at least one accelerant comprises magnesium chloride, magnesium nitrate, magnesium sulfate, or a phosphate-based accelerant);
   wherein the at least one accelerant is about 0.1% to about 30% of the proportion of magnesium hydroxide of the cementitious composition;
   wherein when the at least one accelerant comprises magnesium chloride or magnesium nitrate, a proportion by weight of MgCl₂ or Mg(NO₃)₂ is 0.1% to 30% of the proportion of magnesium hydroxide by weight of the cementitious composition.
   wherein the proportion of pozzolan by percent weight can be about 30% to about 130% (e.g., about 90% to about 110%) of the proportion of magnesium hydroxide by percentage weight of the cementitious composition; and
   wherein the sum of the proportions of magnesium hydroxide and pozzolan is about 5% to about 90% (e.g., about 15% to about 50%) by weight of the cementitious composition.

In several embodiments, the amount of sulfate present relative to the amount of pozzolan from about 0.1 wt. % to about 90 wt. %.

In many embodiments, the amount of sulfate present relative to the amount of pozzolan from about 20 wt. % to about 50% wt. %.

In embodiments, the amount of chloride present relative to the amount of pozzolan from about 0.1 wt. % to about 12 wt. %.

In embodiments, the amount of phosphate present relative to the amount of pozzolan ranges from about 0.1 wt. % to about 20 wt. %.

In some embodiments, the shaped cementitious composition comprises MgO, the amount of pozzolan present relative to the amount of MgO ranges from about 33 wt. % to about 300 wt. %.

In various embodiments, the shaped cementitious composition comprises MgO, the amount of pozzolan present relative to the amount of MgO from about 50 wt. % to about 200 wt. %.

In numerous embodiments, the shaped cementitious composition comprises MgO, the amount of pozzolan present relative to the amount of MgO from about 85 wt. % to about 115 wt. %.

In several embodiments, the shaped cementitious composition comprises Mg(OH)₂, the amount of pozzolan present relative to the amount of Mg(OH)₂ ranges from about 33 wt. % to about 300 wt. %.

In many embodiments, the shaped cementitious composition comprises Mg(OH)₂, and the amount of pozzolan present relative to the amount of Mg(OH)₂ ranges from about 50 wt. % to about 200 wt.

In embodiments, the shaped cementitious composition comprises Mg(OH)₂, and the amount of pozzolan present relative to the amount of Mg(OH)₂ ranges from about 85 wt. % to about 115 wt.

In embodiments, the amount of sulfate present in the aqueous solution ranges from about 1 wt. % to about 10 wt. %.

In some embodiments, the amount of sulfate present in the aqueous solution ranges from about 2 wt. % to about 8 wt. %.

In various embodiments, the amount of chloride present in the aqueous solution ranges from about 0.1 wt. % to about 5 wt. %.

In numerous embodiments, the amount of potassium present in the aqueous solution ranges from about 0.1 wt. % to about 5 wt. %.

In several embodiments, the amount of Mg(OH)₂ present in the aqueous solution ranges from about 2 wt. % to about 25 wt. %.

In many embodiments, the amount of Mg(OH)₂ present in the aqueous solution ranges from about 5 wt. % to about 20 wt. %.

In embodiments, the Mg(OH)₂ of the aqueous solution is not calcined.

In embodiments, the pourable cementitious mixture has a pH of at least 12.

In some embodiments, the pourable cementitious mixture has a pH of at least 13.

In various embodiments, the pourable cementitious mixture has a pH from 13 to 14.

In numerous embodiments, the shaped cementitious composition comprises natural pozzolan and manmade pozzolan, and the amount of natural pozzolan present relative to the amount of manmade pozzolan ranges from about 33 wt. % to about 300 wt. %.

In several embodiments, the shaped cementitious composition comprises natural pozzolan and manmade pozzolan, and the amount of natural pozzolan present relative to the amount of manmade pozzolan ranges from about 50 wt. % to about 200 wt. %.

In many embodiments, the shaped cementitious composition comprises natural pozzolan and manmade pozzolan, and the amount of natural pozzolan present relative to the amount of manmade pozzolan ranges from about 85 wt. % to about 115 wt. %.

In embodiments, the pozzolan comprises silica (SiO₂), alumina (Al₂O₃), and/or iron oxide (Fe₂O₃).

In embodiments, the pozzolan comprises or is obtained from one or more of volcanic rock (e.g., rhyolite, obsidian, pitchstone, pumice, basalt or trap, or andesite); volcanic ash; sedimentary clays or shales' calcined clays; rice husk ash; diatomaceous earth; metakaolin; and olivine.

In some embodiments, the use of a pozzolan avoids the problem of sourcing cementitious material that is used in standard concrete manufacturing. In some cases, avoiding the problem of sourcing cementitious material further reduces the amount of energy required and/or waste CO₂ produced relative to standard concrete manufacturing.

In various embodiments, the natural pozzolan is selected from rhyolite, obsidian, pitchstone, pumice, basalt, andesite, volcanic ash, sedimentary clay, shale, wollastonite, opaline shale, diatomaceous earth, and olivine, or a combination thereof.

In numerous embodiments, the natural pozzolan comprises basalt.

In several embodiments, the manmade pozzolan is selected from metakaolin, fly ash, silica fume, ground glass (e.g., ground waste glass), slag (e.g. ground-granulated blast-furnace slag, blast-furnace slag, steel-furnace slag, basic-oxygen-furnace slag, electric-arc-furnace slag, ladle slag, copper slag, steel slag, iron slag, lead slag, nickel slag, zinc slag, aluminum slag, or slag from other metals), burned organic matter residues (e.g., rice husk ash or rice hull ash), expanded clay, expanded shale, and calcine clay, or a combination thereof. In some cases, the manmade pozzolan comprises a slag, e.g., comprising a blast-furnace slag. The blast-furnace slag may comprise ground-granulated blast-furnace slag. The amount of nitrate present relative to the amount of ground-granulated blast-furnace slag may range from about 2 wt. % to about 30 wt. %. The amount of sulfate present relative to the amount of ground-granulated blast-furnace slag may be from about 0.1 wt. % to about 90 wt. %. The amount of sulfate present relative to the amount of ground-granulated blast-furnace slag may be from about 20 wt. % to about 50% wt. %. The amount of chloride present relative to the amount of ground-granulated blast-furnace slag may be from about 0.1 wt. % to about 12 wt. %. The amount of phosphate present relative to the amount of ground-granulated blast-furnace slag may range from about 0.1 wt. % to about 20 wt. %. The amount of natural pozzolan present relative to the amount of ground-granulated blast-furnace slag may range from about 33 wt. % to about 300 wt. %. The amount of natural pozzolan present relative to the amount of ground-granulated blast-furnace slag may be from about 50 wt. % to about 200 wt. %. The amount of natural pozzolan present relative to the amount of ground-granulated blast-furnace slag may be from about 85 wt. % to about 115 wt. %. In some cases, the blast-furnace slag comprises ground-granulated blast-furnace slag.

In many embodiments, the shaped cementitious composition comprises Mg(OH)₂ and slag, and the ratio of Mg(OH)₂ to slag is from 75:25 by wt. % to 25:75 by wt. %.

In embodiments, the shaped cementitious composition comprises Mg(OH)₂ and slag, and the ratio of Mg(OH)₂ to slag is from 70:30 by wt. % to 30:70 by wt. %.

In embodiments, the shaped cementitious composition comprises Mg(OH)₂ and slag, and the ratio of Mg(OH)₂ to slag is from 65:35 by wt. % to 35:65 by wt. %.

In some embodiments, the shaped cementitious composition comprises Mg(OH)₂ and slag, and the ratio of Mg(OH)₂ to slag is from 60:40 by wt. % to 40:60 by wt. %.

In various embodiments, the shaped cementitious composition comprises Mg(OH)₂ and slag, and the ratio of Mg(OH)₂ to slag is from 55:45 by wt. % to 45:55 by wt. %.

In numerous embodiments, the shaped cementitious composition comprises Mg(OH)₂ and slag, and the ratio of Mg(OH)₂ to slag is about 50:50 by wt. %.

In several embodiments, the pourable cementitious mixture when manufactured was exposed to an applied pressure. In some cases, the pressure is from about ambient (1 bar) to about 250 bar, e.g., from about 100 bar to about 250 bar. In various cases, the pressure is from about ambient (1 bar) bar to about 100 bar.

In many embodiments, the temperature of the pourable cementitious mixture when manufactured ranges from about 1° C. to about 100° C. mixture absent an applied heat.

In embodiments, the pourable cementitious mixture when manufactured was exposed to an applied heat. In some cases, the applied heat provides a temperature of greater than 100° C. and up to 3000° C. The heat may increase the rate of a reaction and/or the extent of a reaction. The heat may activate the latent hydraulic nature of some components. In various cases, the applied pressure and/or applied heat occurs for from about 1 minute to about 10 hours.

In embodiments, the applied pressure and/or applied heat occurs for from about 1 minute to about 10 minutes.

In some embodiments, during manufacturing of the pourable cementitious mixture the salinity of the aqueous solution is lessened, thereby producing a reduced salinity water component. In some cases, the reduced salinity water component has a salt concentration that is less than or about equal to the salt concentration of seawater. The reduced salinity water component may have a salt concentration that is less than the high salinity brine.

In various embodiments, the shaped cementitious composition comprises any sodium, lithium or potassium salt or hydroxide and any alkali or alkali earth metal ions and including Mg(OH)₂, MgO, Ca(OH)₂, CaCO₃, Al₂(SO₄)₃, CaO, CaSO₄·H₂O, SiO₂, Fe₂O₃, Al₂O₃ and/or Brucite.

In numerous embodiments, the shaped cementitious composition does not substantially comprise MgO obtained from a calcination reaction.

In several embodiments, the pourable cementitious mixture further comprises a foaming agent.

In many embodiments, the foaming agent create voids and a porous structure that can mimic natural coral habitats.

In embodiments, the pourable cementitious mixture comprises locally-sourced materials.

In embodiments, the pourable cementitious mixture is molded into the shaped cementitious composition.

In some embodiments, the shaped cementitious composition is set by pouring the cementitious mixture into a mold and then applying a curing technique to the pourable cementitious mixture.

In various embodiments, the shaped cementitious composition permits stronger attachment by aquatic flora and/or fauna relative to a standard cement.

In numerous embodiments, the shaped cementitious composition permits more plentiful attachment by aquatic flora and/or fauna relative to a standard cement.

In several embodiments, the shaped cementitious composition permits a preferred level of colonization by aquatic flora and/or fauna relative to a standard cement.

In many embodiments, the shaped cementitious composition permits more plentiful attachment by aquatic flora and/or fauna relative to a standard cement.

In embodiments, there is a reduced energy cost for attachment by aquatic flora and/or fauna, e.g., larval aquatic fauna, to the shaped cementitious composition relative to a standard cement. In some cases, the reduced energy cost by aquatic flora and/or fauna permits more rapid attachment and stronger attachment, e.g., by larval aquatic fauna, to the surface of the shaped cementitious composition relative to a standard cement. The reduced energy cost by aquatic flora and/or fauna may permit more rapid growth and more rapid development, e.g., by larval aquatic fauna, relative to a standard cement.

In embodiments, mucus secreted by larval aquatic fauna is more adherent to a surface of the shaped cementitious composition relative to a standard cement.

In some embodiments, gut filaments produced by larval aquatic fauna is more adherent to a surface of the shaped cementitious composition relative to a standard cement.

In various embodiments, the shaped cementitious composition has a more porous surface, is more porous throughout its volume, and/or is less dense than a standard cement.

In numerous embodiments, the pores of the shaped cementitious composition are up to 500 nm in diameter.

In several embodiments, the surface of the shaped cementitious composition is more hydrostatic than the surface of a standard cement.

In many embodiments, the surface of the shaped cementitious composition comprises more magnesium (Mg) than the surface of a standard cement.

In embodiments, the pH of surface of the shaped cementitious composition, prior to attachment by aquatic flora and/or fauna, is higher than the pH of sea water.

In embodiments, the pH of surface of the shaped cementitious composition is less than the pH of the surface of a standard cement.

In some embodiments, the shape of the shaped cementitious composition is any shape capable of providing a substrate for aquatic flora and/or fauna attachment.

In various embodiments, the shape of the shaped cementitious composition is planar, circular, rounded, elongated, flat, rectangular, tubular, hollow, solid, or any combination thereof.

In numerous embodiments, the shape of the shaped cementitious composition is a cube, cuboid, cone, cylinder, dodecahedron, polyhedron, prism, pyramid, sphere, tetrahedron, anthropomorphic, zoomorphic, symbolic, or any combination thereof.

In several embodiments, the shape of the shaped cementitious composition is pyramidal with open surfaces such that the shape comprises four bars or cylinders that form a square base and four bars or cylinders each originating at a corner of the square and converging to form the pyramid's apex.

In many embodiments, the surface is flat or the surface comprises contouring, e.g., regular contours or irregular contours, which provide increased surface area and/or locations for attachment by the aquatic flora and/or fauna.

In embodiments, the shape of the shaped cementitious composition is like a hydrofoil. In some cases, the hydrofoil shape efficiently redirects the flow of water, which reduces pressure on the structure by minimizing drag and turbulence caused by currents.

In embodiments, the surface is rougher and/or more textured than a surface of a standard cement.

In some embodiments, the aquatic fauna comprises coral.

In various embodiments, the surface is rougher and/or more textured than a surface of a standard cement, allowing a coral to secrete calcium carbonate and other substances that help it anchor and grow on the cementitious composition's surface.

In numerous embodiments, the aquatic flora comprises algae.

In numerous embodiments, the ratio (weight to weight or weight to volume or volume to volume) of the high salinity brine to pozzolan and/or a latently hydraulic material varies from 1:100 to 100:1. As examples the ratio is about 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, 1:21, 1:22, 1:23, 1:24, 1:25, 1:26, 1:27, 1:28, 1:29, 1:30, 1:31, 1:32, 1:33, 1:34, 1:35, 1:36, 1:37, 1:38, 1:39, 1:40, 1:41, 1:42, 1:43, 1:44, 1:45, 1:46, 1:47, 1:48, 1:49, 1:50, 1:51, 1:52, 1:53, 1:54, 1:55, 1:56, 1:57, 1:58, 1:59, 1:60, 1:61, 1:62, 1:63, 1:64, 1:65, 1:66, 1:67, 1:68, 1:69, 1:70, 1:71, 1:72, 1:73, 1:74, 1:75, 1:76, 1:77, 1:78, 1:79, 1:80, 1:81, 1:82, 1:83, 1:84, 1:85, 1:86, 1:87, 1:88, 1:89, 1:90, 1:91, 1:92, 1:93, 1:94, 1:95, 1:96, 1:97, 1:98, 1:99, 1:100, 100:1, 99:1, 98:1, 97:1, 96:1, 95:1, 94:1, 93:1, 92:1, 91:1, 90:1, 89:1, 88:1, 87:1, 86:1, 85:1, 84:1, 83:1, 82:1, 81:1, 80:1, 79:1, 78:1, 77:1, 76:1, 75:1, 74:1, 73:1, 72:1, 71:1, 70:1, 69:1, 68:1, 67:1, 66:1, 65:1, 64:1, 63:1, 62:1, 61:1, 60:1, 59:1, 58:1, 57:1, 56:1, 55:1, 54:1, 53:1, 52:1, 51:1, 50:1, 49:1, 48:1, 47:1, 46:1, 45:1, 44:1, 43:1, 42:1, 41:1, 40:1, 39:1, 38:1, 37:1, 36:1, 35:1, 34:1, 33:1, 32:1, 31:1, 30:1, 29:1, 28:1, 27:1, 26:1, 25:1, 24:1, 23:1, 22:1, 21:1, 20:1, 19:1, 18:1, 17:1, 16:1, 15:1, 14:1, 13:1, 12:1, 11:1, 10:1, 9:1, 8:1, 7:1, 6:1, 5:1, 4:1, 3:1, 2:1, or about 1:1 and any range or value therebetween.

In various embodiments, the ratio (weight to weight or weight to volume or volume to volume) of the high salinity brine to CO₂ varies from 1:100 to 100:1. As examples the ratio is about 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, 1:21, 1:22, 1:23, 1:24, 1:25, 1:26, 1:27, 1:28, 1:29, 1:30, 1:31, 1:32, 1:33, 1:34, 1:35, 1:36, 1:37, 1:38, 1:39, 1:40, 1:41, 1:42, 1:43, 1:44, 1:45, 1:46, 1:47, 1:48, 1:49, 1:50, 1:51, 1:52, 1:53, 1:54, 1:55, 1:56, 1:57, 1:58, 1:59, 1:60, 1:61, 1:62, 1:63, 1:64, 1:65, 1:66, 1:67, 1:68, 1:69, 1:70, 1:71, 1:72, 1:73, 1:74, 1:75, 1:76, 1:77, 1:78, 1:79, 1:80, 1:81, 1:82, 1:83, 1:84, 1:85, 1:86, 1:87, 1:88, 1:89, 1:90, 1:91, 1:92, 1:93, 1:94, 1:95, 1:96, 1:97, 1:98, 1:99, 1:100, 100:1, 99:1, 98:1, 97:1, 96:1, 95:1, 94:1, 93:1, 92:1, 91:1, 90:1, 89:1, 88:1, 87:1, 86:1, 85:1, 84:1, 83:1, 82:1, 81:1, 80:1, 79:1, 78:1, 77:1, 76:1, 75:1, 74:1, 73:1, 72:1, 71:1, 70:1, 69:1, 68:1, 67:1, 66:1, 65:1, 64:1, 63:1, 62:1, 61:1, 60:1, 59:1, 58:1, 57:1, 56:1, 55:1, 54:1, 53:1, 52:1, 51:1, 50:1, 49:1, 48:1, 47:1, 46:1, 45:1, 44:1, 43:1, 42:1, 41:1, 40:1, 39:1, 38:1, 37:1, 36:1, 35:1, 34:1, 33:1, 32:1, 31:1, 30:1, 29:1, 28:1, 27:1, 26:1, 25:1, 24:1, 23:1, 22:1, 21:1, 20:1, 19:1, 18:1, 17:1, 16:1, 15:1, 14:1, 13:1, 12:1, 11:1, 10:1, 9:1, 8:1, 7:1, 6:1, 5:1, 4:1, 3:1, 2:1, or about 1:1 and any range or value therebetween.

In embodiments, the ratio (weight to weight or weight to volume or volume to volume) of the pozzolan and/or a latently hydraulic material to CO₂ varies from 1:100 to 100:1. As examples the ratio is about 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, 1:21, 1:22, 1:23, 1:24, 1:25, 1:26, 1:27, 1:28, 1:29, 1:30, 1:31, 1:32, 1:33, 1:34, 1:35, 1:36, 1:37, 1:38, 1:39, 1:40, 1:41, 1:42, 1:43, 1:44, 1:45, 1:46, 1:47, 1:48, 1:49, 1:50, 1:51, 1:52, 1:53, 1:54, 1:55, 1:56, 1:57, 1:58, 1:59, 1:60, 1:61, 1:62, 1:63, 1:64, 1:65, 1:66, 1:67, 1:68, 1:69, 1:70, 1:71, 1:72, 1:73, 1:74, 1:75, 1:76, 1:77, 1:78, 1:79, 1:80, 1:81, 1:82, 1:83, 1:84, 1:85, 1:86, 1:87, 1:88, 1:89, 1:90, 1:91, 1:92, 1:93, 1:94, 1:95, 1:96, 1:97, 1:98, 1:99, 1:100, 100:1, 99:1, 98:1, 97:1, 96:1, 95:1, 94:1, 93:1, 92:1, 91:1, 90:1, 89:1, 88:1, 87:1, 86:1, 85:1, 84:1, 83:1, 82:1, 81:1, 80:1, 79:1, 78:1, 77:1, 76:1, 75:1, 74:1, 73:1, 72:1, 71:1, 70:1, 69:1, 68:1, 67:1, 66:1, 65:1, 64:1, 63:1, 62:1, 61:1, 60:1, 59:1, 58:1, 57:1, 56:1, 55:1, 54:1, 53:1, 52:1, 51:1, 50:1, 49:1, 48:1, 47:1, 46:1, 45:1, 44:1, 43:1, 42:1, 41:1, 40:1, 39:1, 38:1, 37:1, 36:1, 35:1, 34:1, 33:1, 32:1, 31:1, 30:1, 29:1, 28:1, 27:1, 26:1, 25:1, 24:1, 23:1, 22:1, 21:1, 20:1, 19:1, 18:1, 17:1, 16:1, 15:1, 14:1, 13:1, 12:1, 11:1, 10:1, 9:1, 8:1, 7:1, 6:1, 5:1, 4:1, 3:1, 2:1, or about 1:1 and any range or value therebetween.

In some embodiments, a filler material or another additive is added to pourable cementitious composition. In some cases, the filler material or the other additive comprises sand, gravel, lightweight aggregate, or crushed stone, and a combination thereof.

In numerous embodiments, the ratio (weight to weight or weight to volume or volume to volume) of the aggregate to each of the high salinity brine, CO₂, and the pozzolan and/or the latently hydraulic material from 1:100 to 100:1. As examples the ratio is about 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, 1:21, 1:22, 1:23, 1:24, 1:25, 1:26, 1:27, 1:28, 1:29, 1:30, 1:31, 1:32, 1:33, 1:34, 1:35, 1:36, 1:37, 1:38, 1:39, 1:40, 1:41, 1:42, 1:43, 1:44, 1:45, 1:46, 1:47, 1:48, 1:49, 1:50, 1:51, 1:52, 1:53, 1:54, 1:55, 1:56, 1:57, 1:58, 1:59, 1:60, 1:61, 1:62, 1:63, 1:64, 1:65, 1:66, 1:67, 1:68, 1:69, 1:70, 1:71, 1:72, 1:73, 1:74, 1:75, 1:76, 1:77, 1:78, 1:79, 1:80, 1:81, 1:82, 1:83, 1:84, 1:85, 1:86, 1:87, 1:88, 1:89, 1:90, 1:91, 1:92, 1:93, 1:94, 1:95, 1:96, 1:97, 1:98, 1:99, 1:100, 100:1, 99:1, 98:1, 97:1, 96:1, 95:1, 94:1, 93:1, 92:1, 91:1, 90:1, 89:1, 88:1, 87:1, 86:1, 85:1, 84:1, 83:1, 82:1, 81:1, 80:1, 79:1, 78:1, 77:1, 76:1, 75:1, 74:1, 73:1, 72:1, 71:1, 70:1, 69:1, 68:1, 67:1, 66:1, 65:1, 64:1, 63:1, 62:1, 61:1, 60:1, 59:1, 58:1, 57:1, 56:1, 55:1, 54:1, 53:1, 52:1, 51:1, 50:1, 49:1, 48:1, 47:1, 46:1, 45:1, 44:1, 43:1, 42:1, 41:1, 40:1, 39:1, 38:1, 37:1, 36:1, 35:1, 34:1, 33:1, 32:1, 31:1, 30:1, 29:1, 28:1, 27:1, 26:1, 25:1, 24:1, 23:1, 22:1, 21:1, 20:1, 19:1, 18:1, 17:1, 16:1, 15:1, 14:1, 13:1, 12:1, 11:1, 10:1, 9:1, 8:1, 7:1, 6:1, 5:1, 4:1, 3:1, 2:1, or about 1:1 and any range or value therebetween.

In embodiments, the ratio (weight to weight or weight to volume or volume to volume) of the aggregate to the combined weight or volume of the high salinity brine, CO₂, and the pozzolan and/or the latently hydraulic material from 1:100 to 100:1. As examples the ratio is about 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, 1:21, 1:22, 1:23, 1:24, 1:25, 1:26, 1:27, 1:28, 1:29, 1:30, 1:31, 1:32, 1:33, 1:34, 1:35, 1:36, 1:37, 1:38, 1:39, 1:40, 1:41, 1:42, 1:43, 1:44, 1:45, 1:46, 1:47, 1:48, 1:49, 1:50, 1:51, 1:52, 1:53, 1:54, 1:55, 1:56, 1:57, 1:58, 1:59, 1:60, 1:61, 1:62, 1:63, 1:64, 1:65, 1:66, 1:67, 1:68, 1:69, 1:70, 1:71, 1:72, 1:73, 1:74, 1:75, 1:76, 1:77, 1:78, 1:79, 1:80, 1:81, 1:82, 1:83, 1:84, 1:85, 1:86, 1:87, 1:88, 1:89, 1:90, 1:91, 1:92, 1:93, 1:94, 1:95, 1:96, 1:97, 1:98, 1:99, 1:100, 100:1, 99:1, 98:1, 97:1, 96:1, 95:1, 94:1, 93:1, 92:1, 91:1, 90:1, 89:1, 88:1, 87:1, 86:1, 85:1, 84:1, 83:1, 82:1, 81:1, 80:1, 79:1, 78:1, 77:1, 76:1, 75:1, 74:1, 73:1, 72:1, 71:1, 70:1, 69:1, 68:1, 67:1, 66:1, 65:1, 64:1, 63:1, 62:1, 61:1, 60:1, 59:1, 58:1, 57:1, 56:1, 55:1, 54:1, 53:1, 52:1, 51:1, 50:1, 49:1, 48:1, 47:1, 46:1, 45:1, 44:1, 43:1, 42:1, 41:1, 40:1, 39:1, 38:1, 37:1, 36:1, 35:1, 34:1, 33:1, 32:1, 31:1, 30:1, 29:1, 28:1, 27:1, 26:1, 25:1, 24:1, 23:1, 22:1, 21:1, 20:1, 19:1, 18:1, 17:1, 16:1, 15:1, 14:1, 13:1, 12:1, 11:1, 10:1, 9:1, 8:1, 7:1, 6:1, 5:1, 4:1, 3:1, 2:1, or about 1:1 and any range or value therebetween.

In many embodiments, the latently hydraulic material is a slag.

In many embodiments, the cementitious composition further comprises at least one filler material or other additive, the at least one filler or other additive can be pumice or other volcanic rock or material, sand, gravel, crushed stone, aggregate (e.g., fine aggregate, coarse aggregate, intermediate aggregate, other types of aggregate, etc.), lightweight aggregate, talc, other clay material, fibers (e.g., steel and/or other metallic fibers, polypropylene and/or other polymeric fibers, glass fibers, asbestos fibers, carbon fibers, organic fibers, etc.), glass fiber reinforced plastic (GFRP), other reinforced polymers, admixtures or other additives that facilitate with fire protection, water protection, corrosion resistance/inhibition, workability, and/or one more other properties of the final cured product (e.g., MasterPel, RheoCell, MasterCell, etc.), sodium naphthalene sulfonate formaldehyde (SNF) and/or other surfactants, plasticizers, pigments, dyes and other color additives, titanium dioxide, other minerals, other natural or synthetic materials, other filler materials and/or the like.

In some embodiments, the ratio (weight to weight or weight to volume or volume to volume) of the filler material or other additive to each of the high salinity brine, CO₂, and the pozzolan and/or the latently hydraulic material from 1:100 to 100:1. As examples the ratio is about 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, 1:21, 1:22, 1:23, 1:24, 1:25, 1:26, 1:27, 1:28, 1:29, 1:30, 1:31, 1:32, 1:33, 1:34, 1:35, 1:36, 1:37, 1:38, 1:39, 1:40, 1:41, 1:42, 1:43, 1:44, 1:45, 1:46, 1:47, 1:48, 1:49, 1:50, 1:51, 1:52, 1:53, 1:54, 1:55, 1:56, 1:57, 1:58, 1:59, 1:60, 1:61, 1:62, 1:63, 1:64, 1:65, 1:66, 1:67, 1:68, 1:69, 1:70, 1:71, 1:72, 1:73, 1:74, 1:75, 1:76, 1:77, 1:78, 1:79, 1:80, 1:81, 1:82, 1:83, 1:84, 1:85, 1:86, 1:87, 1:88, 1:89, 1:90, 1:91, 1:92, 1:93, 1:94, 1:95, 1:96, 1:97, 1:98, 1:99, 1:100, 100:1, 99:1, 98:1, 97:1, 96:1, 95:1, 94:1, 93:1, 92:1, 91:1, 90:1, 89:1, 88:1, 87:1, 86:1, 85:1, 84:1, 83:1, 82:1, 81:1, 80:1, 79:1, 78:1, 77:1, 76:1, 75:1, 74:1, 73:1, 72:1, 71:1, 70:1, 69:1, 68:1, 67:1, 66:1, 65:1, 64:1, 63:1, 62:1, 61:1, 60:1, 59:1, 58:1, 57:1, 56:1, 55:1, 54:1, 53:1, 52:1, 51:1, 50:1, 49:1, 48:1, 47:1, 46:1, 45:1, 44:1, 43:1, 42:1, 41:1, 40:1, 39:1, 38:1, 37:1, 36:1, 35:1, 34:1, 33:1, 32:1, 31:1, 30:1, 29:1, 28:1, 27:1, 26:1, 25:1, 24:1, 23:1, 22:1, 21:1, 20:1, 19:1, 18:1, 17:1, 16:1, 15:1, 14:1, 13:1, 12:1, 11:1, 10:1, 9:1, 8:1, 7:1, 6:1, 5:1, 4:1, 3:1, 2:1, or about 1:1 and any range or value therebetween.

In embodiments, the ratio (weight to weight or weight to volume or volume to volume) of the filler material or other additive to the combined weight or volume of the high salinity brine, CO₂, and the pozzolan and/or the latently hydraulic material from 1:100 to 100:1. As examples the ratio is about 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, 1:21, 1:22, 1:23, 1:24, 1:25, 1:26, 1:27, 1:28, 1:29, 1:30, 1:31, 1:32, 1:33, 1:34, 1:35, 1:36, 1:37, 1:38, 1:39, 1:40, 1:41, 1:42, 1:43, 1:44, 1:45, 1:46, 1:47, 1:48, 1:49, 1:50, 1:51, 1:52, 1:53, 1:54, 1:55, 1:56, 1:57, 1:58, 1:59, 1:60, 1:61, 1:62, 1:63, 1:64, 1:65, 1:66, 1:67, 1:68, 1:69, 1:70, 1:71, 1:72, 1:73, 1:74, 1:75, 1:76, 1:77, 1:78, 1:79, 1:80, 1:81, 1:82, 1:83, 1:84, 1:85, 1:86, 1:87, 1:88, 1:89, 1:90, 1:91, 1:92, 1:93, 1:94, 1:95, 1:96, 1:97, 1:98, 1:99, 1:100, 100:1, 99:1, 98:1, 97:1, 96:1, 95:1, 94:1, 93:1, 92:1, 91:1, 90:1, 89:1, 88:1, 87:1, 86:1, 85:1, 84:1, 83:1, 82:1, 81:1, 80:1, 79:1, 78:1, 77:1, 76:1, 75:1, 74:1, 73:1, 72:1, 71:1, 70:1, 69:1, 68:1, 67:1, 66:1, 65:1, 64:1, 63:1, 62:1, 61:1, 60:1, 59:1, 58:1, 57:1, 56:1, 55:1, 54:1, 53:1, 52:1, 51:1, 50:1, 49:1, 48:1, 47:1, 46:1, 45:1, 44:1, 43:1, 42:1, 41:1, 40:1, 39:1, 38:1, 37:1, 36:1, 35:1, 34:1, 33:1, 32:1, 31:1, 30:1, 29:1, 28:1, 27:1, 26:1, 25:1, 24:1, 23:1, 22:1, 21:1, 20:1, 19:1, 18:1, 17:1, 16:1, 15:1, 14:1, 13:1, 12:1, 11:1, 10:1, 9:1, 8:1, 7:1, 6:1, 5:1, 4:1, 3:1, 2:1, or about 1:1 and any range or value therebetween.

In various embodiments, a pourable cementitious mixture which is formed into a shaped cementitious composition, may comprise one of the following combinations:
(1) brine, (2) CO₂, and (3) a natural pozzolan;
(1) brine, (2) CO₂, (3) a natural pozzolan, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
(1) brine, (2) CO₂, and (3) a man-made pozzolan;
(1) brine, (2) CO₂, (3) a man-made pozzolan, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
(1) brine, (2) CO₂, and (3) a latently hydraulic material;
(1) brine, (2) CO₂, (3) a latently hydraulic material, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
(1) brine, (2) CO₂, and (3) a natural pozzolan and a man-made pozzolan;
(1) brine, (2) CO₂, (3) a natural pozzolan and a man-made pozzolan, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
(1) brine, (2) CO₂, and (3) a natural pozzolan and a latently hydraulic material;
(1) brine, (2) CO₂, (3) a natural pozzolan and a latently hydraulic material, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
(1) brine, (2) CO₂, and (3) a man-made pozzolan and a latently hydraulic material;
(1) brine, (2) CO₂, (3) a man-made pozzolan and a latently hydraulic material, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
(1) brine, (2) CO₂, and (3) a natural pozzolan, a man-made pozzolan, and a latently hydraulic material; or
(1) brine, (2) CO₂, (3) a natural pozzolan, a man-made pozzolan, and a latently hydraulic material, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO).

Any composition or component thereof, or method for manufacturing a composition or component thereof, or reagent used in a method for manufacturing a composition or component thereof disclosed herein is applicable to any herein-disclosed composition, component, method or reagent. In other words, any aspect or embodiment described herein can be combined with any other aspect or embodiment as disclosed herein.

### Pozzolans

Without being bound by theory, particle size of the pozzolan(s) may affect reactivity of the material. For example, smaller particle size may provide increased reactivity. The pozzolan(s) may be provided at any particle size. In embodiments, at least about 90% of the particles of the pozzolan(s) fit through a mesh size of about #120 to about #1200. In embodiments, at least about 90% of the particles of the pozzolan(s) fit through a mesh size of about #120 to about #1000. In embodiments, at least about 90% of the particles of the pozzolan(s) fit through a mesh size of about #120 to about #800. In embodiments, at least about 90% of the particles of the pozzolan(s) fit through a mesh size of about #120 to about #600. In embodiments, at least about 90% of the particles of the pozzolan(s) fit through a mesh size of about #120 to about #400. In embodiments, at least about 90% of the particles of the pozzolan(s) fit through a mesh size of about #120 to about #325. In embodiments, at least about 90% of the particles of the pozzolan(s) fit through a mesh size of about #200 to about #1200. In embodiments, at least about 90% of the particles of the pozzolan(s) fit through a mesh size of about #200 to about #1000. In embodiments, at least about 90% of the particles of the pozzolan(s) fit through a mesh size of about #200 to about #800. In embodiments, at least about 90% of the particles of the pozzolan(s) fit through a mesh size of about #200 to about #700. In embodiments, at least about 90% of the particles of the pozzolan(s) fit through a mesh size of about #200 to about #600. In embodiments, at least about 90% of the particles of the pozzolan(s) fit through a mesh size of about #200 to about #500. In embodiments, at least about 90% of the particles of the pozzolan(s) fit through a mesh size of about #200 to about #400. In embodiments, at least about 90% of the particles of the pozzolan(s) fit through a mesh size of about #200 to about #325. Mesh size can be any value or subrange within the recited ranges.

In embodiments, at least about 95% of the particles of the pozzolan(s) fit through a mesh size of about #120 to about #1200. In embodiments, at least about 96% of the particles of the pozzolan(s) fit through a mesh size of about #120 to about #1200. In embodiments, at least about 97% of the particles of the pozzolan(s) fit through a mesh size of about #120 to about #1200. In embodiments, at least about 98% of the particles of the pozzolan(s) fit through a mesh size of about #120 to about #1200. In embodiments, at least about 99% of the particles of the pozzolan(s) fit through a mesh size of about #120 to about #1200. In embodiments, at least about 98% of the particles of the pozzolan(s) fit through a mesh size of about #120 to about #1000. In embodiments, at least about 98% of the particles of the pozzolan(s) fit through a mesh size of about #120 to about #800. In embodiments, at least about 98% of the particles of the pozzolan(s) fit through a mesh size of about #120 to about #600. In embodiments, at least about 98% of the particles of the pozzolan(s) fit through a mesh size of about #120 to about #400. In embodiments, at least about 98% of the particles of the pozzolan(s) fit through a mesh size of about #120 to about #325. In embodiments, at least about 98% of the particles of the pozzolan(s) fit through a mesh size of about #200 to about #1200. In embodiments, at least about 98% of the particles of the pozzolan(s) fit through a mesh size of about #200 to about #1000. In embodiments, at least about 98% of the particles of the pozzolan(s) fit through a mesh size of about #200 to about #800. In embodiments, at least about 98% of the particles of the pozzolan(s) fit through a mesh size of about #200 to about #700. In embodiments, at least about 98% of the particles of the pozzolan(s) fit through a mesh size of about #200 to about #600. In embodiments, at least about 98% of the particles of the pozzolan(s) fit through a mesh size of about #200 to about #500. In embodiments, at least about 98% of the particles of the pozzolan(s) fit through a mesh size of about #200 to about #400. In embodiments, at least about 98% of the particles of the pozzolan(s) fit through a mesh size of about #200 to about #325. Mesh size can be any value or subrange within the recited ranges.

A pozzolan (either natural or man-made) may be or is a silicious or siliceous and aluminous material.

### Natural Pozzolans

A natural pozzolan is a raw pozzolan that is found in natural deposits. In embodiments, the natural pozzolan is not calcined. A material is referred to as “calcined” when it has been heated below the temperature of fusion to alter its composition or physical state.

Natural pozzolans have been used to replace cement clinker in the production of Portland Cement. Cement clinker is a solid material produced by sintering limestone and aluminosilicate material comprising four mineral phases: two calcium silicates, alite (Ca₃Si) and belite (Ca₂Si), tricalcium aluminate (Ca₃Al) and calcium aluminoferrite (Ca₄AlFe). The clinker is ground to a fine powder and used as the binder, where a small amount of gypsum must be added to avoid the flash setting of the tricalcium aluminate (Ca₃Al₂O₆), the most reactive mineral phase (exothermic hydration reaction) in Portland clinker.

In contrast, the reactive chemical composition of pozzolans and natural pozzolans may comprise, but not limited to, silica (SiO₂), alumina (Al₂O₃), and iron oxide (Fe₂O₃). Natural pozzolans encompass a broad range of materials that include, but are not limited to, volcanic rock (rhyolite, obsidian, pitchstone, pumice, basalt or trap, and andesite) volcanic ash, sedimentary clays and shales, calcined clays, rice husk ash, diatomaceous earth, metakaolin and olivine.

Despite the advantages and historical use of natural pozzolans in the production of Portland cement-based concrete as clinker alternatives, there are several obstacles or disadvantages: the use of pozzolans may reduce the early strength of concrete, making such cements unsuitable for precast applications and potentially increasing construction times. They also may increase water demand during concrete production and can lower resistance to carbonation, which raises the risk of corrosion to carbon (black) steel reinforcement. However, the materials and methods described herein provide improved alternatives.

In embodiments, the natural pozzolan used in a composition or method provided herein is selected from rhyolite, obsidian, pitchstone, pumice, basalt, andesite, volcanic ash, sedimentary clay, shale, wollastonite, opaline shale, diatomaceous earth, olivine, and combinations thereof. In embodiments, the natural pozzolan includes rhyolite. In embodiments, the natural pozzolan includes obsidian. In embodiments, the natural pozzolan includes pitchstone. In embodiments, the natural pozzolan includes pumice. In embodiments, the natural pozzolan includes basalt. In embodiments, the natural pozzolan includes andesite. In embodiments, the natural pozzolan includes volcanic ash. In embodiments, the natural pozzolan includes sedimentary clay. In embodiments, the natural pozzolan includes shale. In embodiments, the natural pozzolan includes wollastonite. In embodiments, the natural pozzolan includes diatomaceous earth. In embodiments, the natural pozzolan includes opaline shale. In embodiments, the natural pozzolan includes olivine.

In embodiments, the natural pozzolan used in a composition or method provided expressly excludes one or more of the natural pozzolans listed herein.

### Natural Pozzolans: Volcanic Rock

Rhyolite is a silica-rich volcanic rock, which has a fine-grain or glassy in texture. It is formed from magma rich in silica that is extruded from a volcanic vent to cool quickly on the surface rather than slowly in the subsurface. The mineral composition of rhyolite comprises quartz, sanidine, and plagioclase, with minor amounts of hornblende and biotite. Chemically, the composition of rhyolite generally comprises SiO₂ and an alkali metal oxide, such as K₂O and Na₂O.

Obsidian is also formed from extruded lava from a volcano that cools rapidly with minimal crystal growth (i.e., glassy or fine-grained.) Like rhyolite, obsidian is extremely rich in SiO₂ at about 70 wt. % or more and also includes MgO and Fe₂O₃. While obsidian is used for manufacturing, the uses are typically for cutting and piercing tools.

Pitchstone is a volcanic glass similar to obsidian, formed when extruded lava rapidly cools. Pitchstone has a similar chemical composition to both rhyolite and obsidian, with the amount of SiO₂ ranging in the amount from about 70 wt. % to 75 wt. %. Pitchstone comprises minerals as quartz, alkali feldspar, and plagioclase, and in smaller amounts pyroxene and hornblende.

Pumice is a porous volcanic rock created when super-heated, highly pressurized rock is violently ejected from a volcano. Pumice typically has a porosity of approximately 64%-85% by volume. The mineral composition of pumice includes feldspar, augite, hornblend, and zircon. Pumice mainly comprises SiO₂, Al₂O₃, and minor amounts of other oxides such as FeO, Fe₂O₃, Na₂O, and K₂O.

Basalt is a fine-grained, extrusive igneous rock formed from the rapid cooling of low-viscosity lava rich in magnesium and iron. While basalt has a relatively lower amount of SiO₂ compared to other common igneous rocks, basalt generally has a composition of 45-52 wt. % SiO₂, 2-5 wt. % total alkalis, 0.5-2.0 wt. % TiO₂, 5-14% wt. %, and 14 wt. % Al₂O₃. Basalt may include additional components, including (without limitation) calcium oxide and/or magnesium oxide.

Andesite is a fine-grained volcanic rock that forms as a result of the rapid cooling and solidification of lava due to the eruption of arc volcanoes or oozing fissures. Andesite contains sodium-rich plagioclase feldspar (Na,Ca)[(Si,Al)AlSi₂]O₈ and may contain (usually <20%) hornblende amphibole, biotite, pyroxene and quartz minerals. In addition, andesite compositions include 52-63% silicon dioxide as well as an alkali oxide content (e.g., Na₂O, K₂O) ranging from 0 to 7% w/w. Andesite compositions are referred to respectively as low-silica or high-silica andesites when they contain either 52-57% or 57-63% SiO₂.

Olivine is a magnesium iron silicate found abundantly in the earth's upper mantel as a dense aggregate. Olivine is chemically represented as (Mg,Fe)₂SiO₄. Generally, olivine is abundant in low-silica mafic and ultramafic igneous rocks.

### Man-Made Pozzolans

Other materials may have pozzolanic activity, including some man-made materials. In some embodiments, the compositions and methods described herein may utilize pozzolans, including non-natural (e.g., man-made) pozzolans. In embodiments, man-made pozzolans are calcined materials. A material is referred to as “calcined” when it has been heated below the temperature of fusion to alter its composition or physical state. In embodiments, man-made pozzolans are recycled materials from industry (e.g., GGBFS).

Non-limiting examples of man-made pozzolans include metakaolin, fly ash (e.g., Class C fly ash), silica fume, ground glass (e.g., ground waste glass), slag (e.g. ground-granulated blast-furnace slag, blast-furnace slag, steel-furnace slag, basic-oxygen-furnace slag, electric-arc-furnace slag, ladle slag, copper slag, steel slag, iron slag, lead slag, nickel slag, zinc slag, aluminum slag, slag from other metals), burned organic matter residues (e.g., rice husk ash or rice hull ash), expanded clay, expanded shale, and calcine clay, and combinations thereof.

In embodiments, the man-made pozzolan used in a composition or method provided includes metakaolin. In embodiments, the man-made pozzolan includes fly ash. In embodiments, the man-made pozzolan includes silica fume. In embodiments, the man-made pozzolan includes burned organic matter residue. In embodiments, the man-made pozzolan includes ground glass. In embodiments, the man-made pozzolan includes ground waste glass. In embodiments, the man-made pozzolan includes slag. In embodiments, the man-made pozzolan includes ground-granulated blast-furnace slag. In embodiments, the man-made pozzolan includes blast-furnace slag. In embodiments, the man-made pozzolan includes steel-furnace slag. In embodiments, the man-made pozzolan includes basic-oxygen-furnace slag. In embodiments, the man-made pozzolan includes electric-arc-furnace slag. In embodiments, the man-made pozzolan includes ladle slag. In embodiments, the man-made pozzolan includes copper slag. In embodiments, the man-made pozzolan includes steel slag. In embodiments, the man-made pozzolan includes iron slag. In embodiments, the man-made pozzolan includes lead slag. In embodiments, the man-made pozzolan includes nickel slag. In embodiments, the man-made pozzolan includes zinc slag. In embodiments, the man-made pozzolan includes aluminum slag. In embodiments, the man-made pozzolan includes slag from other metals. In embodiments, the man-made pozzolan includes burned organic matter residues. In embodiments, the man-made pozzolan includes rice husk ash (rice hull ash). In embodiments, the man-made pozzolan includes expanded clay. In embodiments, the man-made pozzolan includes expanded shale. In embodiments, the man-made pozzolan includes calcine clay. In some embodiments, the man-made pozzolan comprises one or both of slag cement and fly ash. In some embodiments, the man-made pozzolan comprises one or both of slag cement and Class C fly ash. In some embodiments, the man-made pozzolan does not comprise Class F fly ash. In some embodiments, the cementitious compositions (e.g., the shaped cementitious compositions) described herein do not contain Class F fly ash.

In embodiments, the materials described herein may be chemically treated (e.g., with acid) prior to use. In embodiments, the materials described herein are not chemically treated prior to use.

In embodiments, the man-made pozzolan used in a composition or method provided expressly excludes one or more of the man-made pozzolans listed herein.

Where the term “pozzolan” is recited, it is to be understood that natural pozzolan, man-made pozzolan, or a mixture thereof is intended.

Methods for Providing a Substrate for Aquatic Flora and/or Fauna Attachment.

Another aspect of the present invention is a method for providing a substrate for aquatic flora and/or fauna attachment. The method comprising depositing any-herein described shaped cementitious composition, into a natural or artificial body of water which comprises aquatic flora and/or fauna in need of an attachment.

In several embodiments, the artificial body of water is in a laboratory, a hatchery, a nursery, or the like.

In many embodiments, the natural body of water is a pond, a river, a lake, a sea, or an ocean.

Described herein are methods for promoting coral attachment and/or coral growth. A method for promoting coral attachment and/or coral growth can include the steps of making any shaped cementitious composition described herein. A method for promoting coral attachment and/or coral growth can comprise the steps of:
(1) mixing a cementitious mixture comprising:
   (a) a pozzolan comprising a natural pozzolan and/or a manmade pozzolan;
   (b) MgO and/or Mg(OH)₂;
   (c) an aqueous solution comprising one or more accelerants; and,
   (d) at least one aggregate;
optionally, wherein the MgO and/or Mg(OH)₂ of (b) is included in the aqueous solution of (c);
optionally, wherein the manmade pozzolan comprises a slag;
(2) pouring the cementitious mixture into a mold or extruding the cementitious mixture via a 3-D printer to form any shaped cementitious composition described herein; and
(3) depositing the shaped cementitious composition into a natural or artificial body of water;
wherein the attachment to the shaped cementitious composition and/or growth of coral is promoted. The natural body of water can be a pond, a river, a lake, a sea, or an ocean. The artificial body of water can be a laboratory, a hatchery, a nursery, or the like. The method can further comprise the step of transplanting the coral onto the shaped cementitious composition. In such a method, the coral can be coral colonies removed from their original habitat. The method can further comprise the step of placing corals on the shaped cementitious composition. In such a method, the coral can be nursery-grown coral. Any steps of methods described herein can be repeated any number of times (e.g., repeated once, twice, three times). Steps of methods described herein can be practiced in any order.

The shaped cementitious composition is formed from a pourable cementitious mixture comprising: (a) a pozzolan comprising a natural pozzolan and/or a manmade pozzolan; (b) MgO and/or Mg(OH)₂; (c) an aqueous solution comprising one or more accelerants; and (d) at least one aggregate. In some cases, the MgO and/or Mg(OH)₂ of (b) is included in the aqueous solution of (c). And, in various cases, the manmade pozzolan comprises a slag.

In embodiments, the aqueous solution comprises a high salinity brine.

In some embodiments, the salt concentration of the high salinity brine is greater than or about equal to the salt concentration of seawater.

In various embodiments, the high salinity brine comprises water with a salt concentration (e.g., chloride, sulphate, and sodium) higher than 50 parts per thousand.

In numerous embodiments, the high salinity brine is treated prior to manufacturing the pourable cementitious mixture to reduce the amount of sodium, sulphates, and/or chloride. In some cases, the brine has reduced amounts of sodium, potassium, chloride, sulphate, magnesium, and/or calcium ions via chemical precipitation, electrochemical methods, ion selective membranes, reverse osmosis, and/or selective precipitation by pH. In various cases, the chemical precipitation comprises contacting the sodium, potassium, chloride, sulphate, magnesium, and/or calcium ions with lime (calcium hydroxide, Ca(OH)₂) or alum (aluminum sulfate, Al₂(SO₄)₃) which forms insoluble precipitates with the sodium, potassium, chloride, sulphate, magnesium, and/or calcium ions. In numerous cases, the sodium is reduced via a method known in the art, e.g., via a chloralkali process. In certain cases, the sodium is collected.

In several embodiments, the high salinity brine is obtained from a desalination facility, is natural seawater, or an industrial brine.

In many embodiments, the pourable cementitious mixture further comprises CO₂.

In embodiments, the pourable cementitious mixture comprises at least 0.04 kg CO₂ per kg of the mixture.

In embodiments, the CO₂ is chemically reacted to form a crystalline form of carbon.

In some embodiments, the CO₂ is absorbed into the pourable cementitious mixture as a crystalline form of carbon.

In various embodiments, the CO₂ is from industrial waste, from environmental sources, or from molecular capture. In some cases, the industrial waste relates to alcoholic fermentation or the burning of fossil fuels.

In numerous embodiments, the CO₂ is provided in gaseous, solid, and/or as a supercritical fluid form or as a dissolved gas.

In several embodiments, the CO₂ is incorporated into the pourable cementitious mixture as a carbonate.

In many embodiments, the shaped cementitious composition retains carbon dioxide of at least 5% by weight of the shaped cementitious composition over a 15-year period.

In embodiments, the shaped cementitious composition retains carbon dioxide of about 5% by weight to about 16% by weight of the shaped cementitious composition over a 15-year period.

In embodiments, the pourable cementitious mixture absorbs more CO₂ during its manufacture than is emitted.

In some embodiments, the pourable cementitious mixture comprises more CO₂ per gram than a standard cement.

In various embodiments, the pourable cementitious mixture comprises up to 50% more CO₂ per gram than a standard cement.

In numerous embodiments, the pourable cementitious mixture requires less bicarbonate per gram than a standard cement.

In several embodiments, the pourable cementitious mixture comprises more calcium, carbonate, silicon, aluminum, magnesium, strontium, iodine, manganese, and/or iron per gram than a standard cement.

In many embodiments, the pourable cementitious mixture comprises up to 50% more calcium, carbonate, silicon, aluminum, magnesium, strontium, iodine, manganese, and/or iron per gram than a standard cement.

In embodiments, the pourable cementitious mixture comprises more concentrated levels of minerals found in the sea than a standard cement.

In embodiments, the pourable cementitious mixture comprises more magnesium oxychloride crystals than a standard cement.

In some embodiments, the pourable cementitious mixture comprises more hydrostatics than a standard cement.

In various embodiments, the pourable cementitious mixture captures and stores more CO₂, through a process called carbonation, than a standard cement.

In numerous embodiments, the cementitious composition help reduce ocean acidification, through a process known as mineral carbonation, more than a standard cement.

In several embodiments, the cementitious composition mitigates undesirable algal growth when compared a standard cement.

In many embodiments, the cementitious composition has a higher thermal mass which effectively absorbs and stores heat than a standard cement.

In embodiments, the pourable cementitious mixture comprises more numerous pores, e.g., voids, per unit volume and/or larger average pores than a standard cement.

In embodiments, the pourable cementitious mixture is less dense per unit volume than a standard cement.

In some embodiments, the pourable cementitious mixture comprises fewer pores, e.g., voids, per unit volume and/or smaller average pores than a standard cement.

In various embodiments, the pourable cementitious mixture is denser per unit volume than a standard cement.

In numerous embodiments, the standard cement comprises CaO, CaCO3, SiO₂, Al₂O₃, Fe₂O₃, and CaSO₄·H₂O.

In several embodiments, the standard cement comprises a slaked or hydraulic dolomitic or calcareous lime blended with a natural or man-made pozzolanic or latently hydraulic material.

In many embodiments, the standard cement, e.g., a standard hydrated cement, is a Portland Cement comprising cement clinker rather than pozzolan, a pozzolan-modified Portland cement, or other carbonate-based and/or sodium-based binder.

In embodiments, the accelerant is one or more of nitrate, sulfate, sodium, chloride, phosphate, triethenolamine, calcium formate, silica fume, finely divided silica gel, and calcium chloride.

In embodiments, the at least one aggregate is selected from sand, gravel, lightweight aggregate, and crushed stone, or a combination thereof.

In some embodiments, the pourable cementitious mixture further comprises an activator selected from any sodium, lithium or potassium salt or hydroxide and any alkali or alkali earth metal ions.

In various embodiments, the pourable cementitious mixture further comprises an activator comprising one or more of Mg(OH)₂, MgO, Ca(OH)₂, CaCO₃, Al₂(SO₄)₃, and CaO.

In numerous embodiments, the amount of nitrate present relative to the amount of pozzolan ranges from about 2 wt. % to about 30 wt. %.

In several embodiments, the amount of sulfate present relative to the amount of pozzolan from about 0.1 wt. % to about 90 wt. %.

In many embodiments, the amount of sulfate present relative to the amount of pozzolan from about 20 wt. % to about 50% wt. %.

In embodiments, the amount of chloride present relative to the amount of pozzolan from about 0.1 wt. % to about 12 wt. %.

In embodiments, the amount of phosphate present relative to the amount of pozzolan ranges from about 0.1 wt. % to about 20 wt. %.

In some embodiments, the shaped cementitious composition comprises MgO, the amount of pozzolan present relative to the amount of MgO ranges from about 33 wt. % to about 300 wt. %.

In various embodiments, the shaped cementitious composition comprises MgO, the amount of pozzolan present relative to the amount of MgO from about 50 wt. % to about 200 wt. %.

In numerous embodiments, the shaped cementitious composition comprises MgO, the amount of pozzolan present relative to the amount of MgO from about 85 wt. % to about 115 wt. %.

In several embodiments, the shaped cementitious composition comprises Mg(OH)₂, the amount of pozzolan present relative to the amount of Mg(OH)₂ ranges from about 33 wt. % to about 300 wt. %.

In many embodiments, the shaped cementitious composition comprises Mg(OH)₂, and the amount of pozzolan present relative to the amount of Mg(OH)₂ ranges from about 50 wt. % to about 200 wt.

In embodiments, the shaped cementitious composition comprises Mg(OH)₂, and the amount of pozzolan present relative to the amount of Mg(OH)₂ ranges from about 85 wt. % to about 115 wt.

In embodiments, the amount of sulfate present in the aqueous solution ranges from about 1 wt. % to about 10 wt. %.

In some embodiments, the amount of sulfate present in the aqueous solution ranges from about 2 wt. % to about 8 wt. %.

In various embodiments, the amount of chloride present in the aqueous solution ranges from about 0.1 wt. % to about 5 wt. %.

In numerous embodiments, the amount of potassium present in the aqueous solution ranges from about 0.1 wt. % to about 5 wt. %.

In several embodiments, the amount of Mg(OH)₂ present in the aqueous solution ranges from about 2 wt. % to about 25 wt. %.

In many embodiments, the amount of Mg(OH)₂ present in the aqueous solution ranges from about 5 wt. % to about 20 wt. %.

In embodiments, the Mg(OH)₂ of the aqueous solution is not calcined.

In embodiments, the pourable cementitious mixture has a pH of at least 12.

In some embodiments, the pourable cementitious mixture has a pH of at least 13.

In various embodiments, the pourable cementitious mixture has a pH from 13 to 14.

In numerous embodiments, the shaped cementitious composition comprises natural pozzolan and manmade pozzolan, and the amount of natural pozzolan present relative to the amount of manmade pozzolan ranges from about 33 wt. % to about 300 wt. %.

In several embodiments, the shaped cementitious composition comprises natural pozzolan and manmade pozzolan, and the amount of natural pozzolan present relative to the amount of manmade pozzolan ranges from about 50 wt. % to about 200 wt. %.

In many embodiments, the shaped cementitious composition comprises natural pozzolan and manmade pozzolan, and the amount of natural pozzolan present relative to the amount of manmade pozzolan ranges from about 85 wt. % to about 115 wt. %.

In embodiments, the pozzolan comprises silica (SiO₂), alumina (Al₂O₃), and/or iron oxide (Fe₂O₃).

In embodiments, the pozzolan comprises or is obtained from one or more of volcanic rock (e.g., rhyolite, obsidian, pitchstone, pumice, basalt or trap, or andesite); volcanic ash; sedimentary clays or shales' calcined clays; rice husk ash; diatomaceous earth; metakaolin; and olivine.

In some embodiments, the use of a pozzolan avoids the problem of sourcing cementitious material that is used in standard concrete manufacturing. In some cases, avoiding the problem of sourcing cementitious material further reduces the amount of energy required and/or waste CO₂ produced relative to standard concrete manufacturing.

In various embodiments, the natural pozzolan is selected from rhyolite, obsidian, pitchstone, pumice, basalt, andesite, volcanic ash, sedimentary clay, shale, wollastonite, opaline shale, diatomaceous earth, and olivine, or a combination thereof.

In numerous embodiments, the natural pozzolan comprises basalt.

In several embodiments, the manmade pozzolan is selected from metakaolin, fly ash, silica fume, ground glass (e.g., ground waste glass), slag (e.g. ground-granulated blast-furnace slag, blast-furnace slag, steel-furnace slag, basic-oxygen-furnace slag, electric-arc-furnace slag, ladle slag, copper slag, steel slag, iron slag, lead slag, nickel slag, zinc slag, aluminum slag, or slag from other metals), burned organic matter residues (e.g., rice husk ash or rice hull ash), expanded clay, expanded shale, and calcine clay, or a combination thereof. In some cases, the manmade pozzolan comprises a slag, e.g., comprising a blast-furnace slag. The blast-furnace slag may comprise ground-granulated blast-furnace slag. The amount of nitrate present relative to the amount of ground-granulated blast-furnace slag may range from about 2 wt. % to about 30 wt. %. The amount of sulfate present relative to the amount of ground-granulated blast-furnace slag may be from about 0.1 wt. % to about 90 wt. %. The amount of sulfate present relative to the amount of ground-granulated blast-furnace slag may be from about 20 wt. % to about 50% wt. %. The amount of chloride present relative to the amount of ground-granulated blast-furnace slag may be from about 0.1 wt. % to about 12 wt. %. The amount of phosphate present relative to the amount of ground-granulated blast-furnace slag may range from about 0.1 wt. % to about 20 wt. %. The amount of natural pozzolan present relative to the amount of ground-granulated blast-furnace slag may range from about 33 wt. % to about 300 wt. %. The amount of natural pozzolan present relative to the amount of ground-granulated blast-furnace slag may be from about 50 wt. % to about 200 wt. %. The amount of natural pozzolan present relative to the amount of ground-granulated blast-furnace slag may be from about 85 wt. % to about 115 wt. %. In some cases, the blast-furnace slag comprises ground-granulated blast-furnace slag.

In many embodiments, the shaped cementitious composition comprises Mg(OH)₂ and slag, and the ratio of Mg(OH)₂ to slag is from 75:25 by wt. % to 25:75 by wt. %.

In embodiments, the shaped cementitious composition comprises Mg(OH)₂ and slag, and the ratio of Mg(OH)₂ to slag is from 70:30 by wt. % to 30:70 by wt. %.

In embodiments, the shaped cementitious composition comprises Mg(OH)₂ and slag, and the ratio of Mg(OH)₂ to slag is from 65:35 by wt. % to 35:65 by wt. %.

In some embodiments, the shaped cementitious composition comprises Mg(OH)₂ and slag, and the ratio of Mg(OH)₂ to slag is from 60:40 by wt. % to 40:60 by wt. %.

In various embodiments, the shaped cementitious composition comprises Mg(OH)₂ and slag, and the ratio of Mg(OH)₂ to slag is from 55:45 by wt. % to 45:55 by wt. %.

In numerous embodiments, the shaped cementitious composition comprises Mg(OH)₂ and slag, and the ratio of Mg(OH)₂ to slag is about 50:50 by wt. %.

In several embodiments, the pourable cementitious mixture when manufactured was exposed to an applied pressure. In some cases, the pressure is from about ambient (1 bar) to about 250 bar, e.g., from about 100 bar to about 250 bar. In various cases, the pressure is from about ambient (1 bar) bar to about 100 bar.

In many embodiments, the temperature of the pourable cementitious mixture when manufactured ranges from about 1° C. to about 100° C. mixture absent an applied heat.

In embodiments, the pourable cementitious mixture when manufactured was exposed to an applied heat. In some cases, the applied heat provides a temperature of greater than 100° C. and up to 3000° C. The heat may increase the rate of a reaction and/or the extent of a reaction. The heat may activate the latent hydraulic nature of some components. In various cases, the applied pressure and/or applied heat occurs for from about 1 minute to about 10 hours.

In embodiments, the applied pressure and/or applied heat occurs for from about 1 minute to about 10 minutes.

In some embodiments, during manufacturing of the pourable cementitious mixture the salinity of the aqueous solution is lessened, thereby producing a reduced salinity water component. In some cases, the reduced salinity water component has a salt concentration that is less than or about equal to the salt concentration of seawater. The reduced salinity water component may have a salt concentration that is less than the high salinity brine.

In various embodiments, the shaped cementitious composition comprises any sodium, lithium or potassium salt or hydroxide and any alkali or alkali earth metal ions and including Mg(OH)₂, MgO, Ca(OH)₂, CaCO₃, Al₂(SO₄)₃, CaO, CaSO₄·H₂O, SiO₂, Fe₂O₃, Al₂O₃ and/or Brucite.

In numerous embodiments, the shaped cementitious composition does not substantially comprise MgO obtained from a calcination reaction.

In several embodiments, the pourable cementitious mixture further comprises a foaming agent.

In many embodiments, the foaming agent create voids and a porous structure that can mimic natural coral habitats.

In embodiments, the pourable cementitious mixture comprises locally-sourced materials.

In embodiments, the pourable cementitious mixture is molded into the shaped cementitious composition.

In some embodiments, the shaped cementitious composition is set by pouring the cementitious mixture into a mold and then applying a curing technique to the pourable cementitious mixture.

In various embodiments, the shaped cementitious composition permits stronger attachment by aquatic flora and/or fauna relative to a standard cement.

In numerous embodiments, the shaped cementitious composition permits more plentiful attachment by aquatic flora and/or fauna relative to a standard cement.

In several embodiments, the shaped cementitious composition permits a preferred level of colonization by aquatic flora and/or fauna relative to a standard cement.

In many embodiments, the shaped cementitious composition permits more plentiful attachment by aquatic flora and/or fauna relative to a standard cement.

In embodiments, there is a reduced energy cost for attachment by aquatic flora and/or fauna, e.g., larval aquatic fauna, to the shaped cementitious composition relative to a standard cement. In some cases, the reduced energy cost by aquatic flora and/or fauna permits more rapid attachment and stronger attachment, e.g., by larval aquatic fauna, to the surface of the shaped cementitious composition relative to a standard cement. The reduced energy cost by aquatic flora and/or fauna may permit more rapid growth and more rapid development, e.g., by larval aquatic fauna, relative to a standard cement.

In embodiments, mucus secreted by larval aquatic fauna is more adherent to a surface of the shaped cementitious composition relative to a standard cement.

In some embodiments, gut filaments produced by larval aquatic fauna is more adherent to a surface of the shaped cementitious composition relative to a standard cement.

In various embodiments, the shaped cementitious composition has a more porous surface, is more porous throughout its volume, and/or is less dense than a standard cement.

In numerous embodiments, the pores of the shaped cementitious composition are up to 500 nm in diameter.

In several embodiments, the surface of the shaped cementitious composition is more hydrostatic than the surface of a standard cement.

In many embodiments, the surface of the shaped cementitious composition comprises more magnesium (Mg) than the surface of a standard cement.

In embodiments, the pH of surface of the shaped cementitious composition, prior to attachment by aquatic flora and/or fauna, is higher than the pH of sea water.

In embodiments, the pH of surface of the shaped cementitious composition is less than the pH of the surface of a standard cement.

In some embodiments, the shape of the shaped cementitious composition is any shape capable of providing a substrate for aquatic flora and/or fauna attachment.

In various embodiments, the shape of the shaped cementitious composition is planar, circular, rounded, elongated, flat, rectangular, tubular, hollow, solid, or any combination thereof.

In numerous embodiments, the shape of the shaped cementitious composition is a cube, cuboid, cone, cylinder, dodecahedron, polyhedron, prism, pyramid, sphere, tetrahedron, anthropomorphic, zoomorphic, symbolic, or any combination thereof.

In several embodiments, the shape of the shaped cementitious composition is pyramidal with open surfaces such that the shape comprises four bars or cylinders that form a square base and four bars or cylinders each originating at a corner of the square and converging to form the pyramid's apex.

In many embodiments, the surface is flat or the surface comprises contouring, e.g., regular contours or irregular contours, which provide increased surface area and/or locations for attachment by the aquatic flora and/or fauna.

In embodiments, the shape of the shaped cementitious composition is like a hydrofoil. In some cases, the hydrofoil shape efficiently redirects the flow of water, which reduces pressure on the structure by minimizing drag and turbulence caused by currents.

In embodiments, the surface is rougher and/or more textured than a surface of a standard cement.

In some embodiments, the aquatic fauna comprises coral.

In various embodiments, the surface is rougher and/or more textured than a surface of a standard cement, allowing a coral to secrete calcium carbonate and other substances that help it anchor and grow on the cementitious composition's surface.

In numerous embodiments, the aquatic flora comprises algae.

Any method or method step disclosed herein is applicable to any other herein-disclosed method or method step. In other words, any aspect or embodiment described herein can be combined with any other aspect or embodiment as disclosed herein.

### Methods for Making a Shaped Cementitious Composition.

An additional aspect of the present disclosure is a method for making a shaped cementitious composition. The method comprising manufacturing a pourable cementitious mixture comprising steps of: (1) mixing (a) a pozzolan comprising a natural pozzolan and/or a manmade pozzolan; (b) MgO and/or Mg(OH)₂; (c) an aqueous solution comprising one or more accelerants; and (d) at least one aggregate; and (2) pouring the cementitious mixture into a mold. In some cases, the MgO and/or Mg(OH)₂ of (b) is included in the aqueous solution of (c). In various embodiments, the manmade pozzolan comprises a slag.

In embodiments, the method further comprises applying a curing technique to the pourable cementitious mixture.

A further aspect of the present disclosure is a method for making a shaped cementitious composition. The method comprises manufacturing a pourable cementitious mixture comprising steps of: (1) mixing (a) a pozzolan comprising a natural pozzolan and/or a manmade pozzolan; (b) MgO and/or Mg(OH)₂; (c) an aqueous solution comprising one or more accelerants; and (d) at least one aggregate; and (2) extruding the pourable cementitious mixture via a 3-D printer. In some cases, the MgO and/or Mg(OH)₂ of (b) is included in the aqueous solution of (c). In various cases, the manmade pozzolan comprises a slag.

In embodiments, the method further comprises applying a curing technique to the pourable cementitious mixture.

In embodiments, the aqueous solution comprises a high salinity brine.

In some embodiments, the salt concentration of the high salinity brine is greater than or about equal to the salt concentration of seawater.

In various embodiments, the high salinity brine comprises water with a salt concentration (e.g., chloride, sulphate, and sodium) higher than 50 parts per thousand.

In numerous embodiments, the high salinity brine is treated prior to manufacturing the pourable cementitious mixture to reduce the amount of sodium, sulphates, and/or chloride. In some cases, the brine has reduced amounts of sodium, potassium, chloride, sulphate, magnesium, and/or calcium ions via chemical precipitation, electrochemical methods, ion selective membranes, reverse osmosis, and/or selective precipitation by pH. In various cases, the chemical precipitation comprises contacting the sodium, potassium, chloride, sulphate, magnesium, and/or calcium ions with lime (calcium hydroxide, Ca(OH)₂) or alum (aluminum sulfate, Al₂(SO₄)₃) which forms insoluble precipitates with the sodium, potassium, chloride, sulphate, magnesium, and/or calcium ions. In numerous cases, the sodium is reduced via a method known in the art, e.g., via a chloralkali process. In certain cases, the sodium is collected.

In several embodiments, the high salinity brine is obtained from a desalination facility, is natural seawater, or an industrial brine.

In many embodiments, the pourable cementitious mixture further comprises CO₂.

In embodiments, the pourable cementitious mixture comprises at least 0.04 kg CO₂ per kg of the mixture.

In embodiments, the CO₂ is chemically reacted to form a crystalline form of carbon.

In some embodiments, the CO₂ is absorbed into the pourable cementitious mixture as a crystalline form of carbon.

In various embodiments, the CO₂ is from industrial waste, from environmental sources, or from molecular capture. In some cases, the industrial waste relates to alcoholic fermentation or the burning of fossil fuels.

In numerous embodiments, the CO₂ is provided in gaseous, solid, and/or as a supercritical fluid form or as a dissolved gas.

In several embodiments, the CO₂ is incorporated into the pourable cementitious mixture as a carbonate.

In many embodiments, the shaped cementitious composition retains carbon dioxide of at least 5% by weight of the shaped cementitious composition over a 15-year period.

In embodiments, the shaped cementitious composition retains carbon dioxide of about 5% by weight to about 16% by weight of the shaped cementitious composition over a 15-year period.

In embodiments, the pourable cementitious mixture absorbs more CO₂ during its manufacture than is emitted.

In some embodiments, the pourable cementitious mixture comprises more CO₂ per gram than a standard cement.

In various embodiments, the pourable cementitious mixture comprises up to 50% more CO₂ per gram than a standard cement.

In numerous embodiments, the pourable cementitious mixture requires less bicarbonate per gram than a standard cement.

In several embodiments, the pourable cementitious mixture comprises more calcium, carbonate, silicon, aluminum, magnesium, strontium, iodine, manganese, and/or iron per gram than a standard cement.

In many embodiments, the pourable cementitious mixture comprises up to 50% more calcium, carbonate, silicon, aluminum, magnesium, strontium, iodine, manganese, and/or iron per gram than a standard cement.

In embodiments, the pourable cementitious mixture comprises more concentrated levels of minerals found in the sea than a standard cement.

In embodiments, the pourable cementitious mixture comprises more magnesium oxychloride crystals than a standard cement.

In some embodiments, the pourable cementitious mixture comprises more hydrostatics than a standard cement.

In various embodiments, the pourable cementitious mixture captures and stores more CO₂, through a process called carbonation, than a standard cement.

In numerous embodiments, the cementitious composition help reduce ocean acidification, through a process known as mineral carbonation, more than a standard cement.

In several embodiments, the cementitious composition mitigates undesirable algal growth when compared a standard cement.

In many embodiments, the cementitious composition has a higher thermal mass which effectively absorbs and stores heat than a standard cement.

In embodiments, the pourable cementitious mixture comprises more numerous pores, e.g., voids, per unit volume and/or larger average pores than a standard cement.

In embodiments, the pourable cementitious mixture is less dense per unit volume than a standard cement.

In some embodiments, the pourable cementitious mixture comprises fewer pores, e.g., voids, per unit volume and/or smaller average pores than a standard cement.

In various embodiments, the pourable cementitious mixture is denser per unit volume than a standard cement.

In numerous embodiments, the standard cement comprises CaO, CaCO3, SiO₂, Al₂O₃, Fe₂O₃, and CaSO₄·H₂O.

In several embodiments, the standard cement comprises a slaked or hydraulic dolomitic or calcareous lime blended with a natural or man-made pozzolanic or latently hydraulic material.

In many embodiments, the standard cement, e.g., a standard hydrated cement, is a Portland Cement comprising cement clinker rather than pozzolan, a pozzolan-modified Portland cement, or other carbonate-based and/or sodium-based binder.

In embodiments, the accelerant is one or more of nitrate, sulfate, sodium, chloride, phosphate, triethenolamine, calcium formate, silica fume, finely divided silica gel, and calcium chloride.

The accelerant of cementitious compositions and cementitious mixtures described herein can comprise at least one accelerant selected from magnesium chloride (e.g., MgCl₂), magnesium sulfate (e.g., MgSO₄), magnesium nitrate (e.g., Mg(NO₃)₂), and a phosphate-based accelerant. In some embodiments, the accelerant and/or cementitious composition does not comprise magnesium sulfate. In some embodiments, the accelerant and/or cementitious composition does not comprise magnesium chloride. In some embodiments, the accelerant and/or cementitious composition does not comprise magnesium nitrate. In some embodiments, the accelerant and/or cementitious composition does not comprise a phosphate-based accelerant.

The cementitious compositions (e.g., shaped cementitious compositions) disclosed herein can comprise any amount or proportion of accelerant (e.g., at least one accelerant). The proportion can be calculated by the wet weight (e.g., the weight of the cementitious composition following the addition of a liquid such as water) or the dry weight (e.g., the weight of the cementitious composition prior to addition of a liquid such as water). The proportion by weight of the at least one accelerant can be about 5% to about 145% (e.g., about 5% to about 140%, about 5% to about 135%, about 5% to about 130%, about 5% to about 125%, about 5% to about 120%, about 5% to about 115%, about 5% to about 110%, about 5% to about 105%, about 5% to about 100%, about 5% to about 95%, about 5% to about 90%, about 5% to about 85%, about 5% to about 80%, about 5% to about 75%, about 5% to about 70%, about 5% to about 65%, about 5% to about 60%, about 5% to about 55%, about 5% to about 50%, about 5% to about 45%, about 5% to about 40%, about 5% to about 35%, about 5% to about 30%, about 5% to about 25%, about 5% to about 20%, about 5% to about 15%, about 5% to about 10%, about 10% to about 145%, about 15% to about 145%, about 20% to about 145%, about 25% to about 145%, about 30% to about 145%, about 35% to about 145%, about 40% to about 145%, about 45% to about 145%, about 50% to about 145%, about 55% to about 145%, about 60% to about 145%, about 65% to about 145%, about 70% to about 145%, about 75% to about 145%, about 80% to about 145%, about 85% to about 145%, about 90% to about 145%, about 95% to about 145%, about 100% to about 145%, about 105% to about 145%, about 110% to about 145%, about 115% to about 145%, about 120% to about 145%, about 125% to about 145%, about 130% to about 145%, about 135% to about 145%, about 140% to about 145%, about 65% to about 75%, about 60% to about 80%, about 55% to about 85%, about 50% to about 90%, about 45% to about 95%, about 40% to about 100%, about 35% to about 105%, about 30% to about 110%, about 25% to about 115%, about 20% to about 120%, about 15% to about 125%, about 10% to about 130%, about 15% to about 50%, about 80% to about 120%, about 70% to about 120%, or about 80% to about 145%) of the proportion of magnesium oxide (e.g., MgO) by weight of the cementitious composition. The proportion by weight of the at least one accelerant can be about 5% to about 145% (e.g., about 5% to about 140%, about 5% to about 135%, about 5% to about 130%, about 5% to about 125%, about 5% to about 120%, about 5% to about 115%, about 5% to about 110%, about 5% to about 105%, about 5% to about 100%, about 5% to about 95%, about 5% to about 90%, about 5% to about 85%, about 5% to about 80%, about 5% to about 75%, about 5% to about 70%, about 5% to about 65%, about 5% to about 60%, about 5% to about 55%, about 5% to about 50%, about 5% to about 45%, about 5% to about 40%, about 5% to about 35%, about 5% to about 30%, about 5% to about 25%, about 5% to about 20%, about 5% to about 15%, about 5% to about 10%, about 10% to about 145%, about 15% to about 145%, about 20% to about 145%, about 25% to about 145%, about 30% to about 145%, about 35% to about 145%, about 40% to about 145%, about 45% to about 145%, about 50% to about 145%, about 55% to about 145%, about 60% to about 145%, about 65% to about 145%, about 70% to about 145%, about 75% to about 145%, about 80% to about 145%, about 85% to about 145%, about 90% to about 145%, about 95% to about 145%, about 100% to about 145%, about 105% to about 145%, about 110% to about 145%, about 115% to about 145%, about 120% to about 145%, about 125% to about 145%, about 130% to about 145%, about 135% to about 145%, about 140% to about 145%, about 65% to about 75%, about 60% to about 80%, about 55% to about 85%, about 50% to about 90%, about 45% to about 95%, about 40% to about 100%, about 35% to about 105%, about 30% to about 110%, about 25% to about 115%, about 20% to about 120%, about 15% to about 125%, about 10% to about 130%, about 15% to about 50%, about 80% to about 120%, about 70% to about 120%, or about 80% to about 145%) of the proportion of the magnesium hydroxide (e.g., Mg(OH₂)) by weight of the cementitious composition. The proportion by weight of the at least one accelerant can be about 0.1% to about 30% (e.g., about 0.1% to about 30%, about 0.5% to about 30%, about 1% to about 30%, about 2% to about 30%, about 4% to about 30%, about 6% to about 30%, about 8% to about 30%, about 10% to about 30%, about 15% to about 30%, about 20% to about 30%, about 25% to about 30%, about 0.1% to about 25%, about 0.1% to about 20%, about 0.1% to about 15%, about 0.1% to about 10%, about 0.1% to about 8%, about 0.1% to about 6%, about 0.1% to about 4%, about 0.1% to about 2%, about 0.1% to about 1%, about 0.1% to about 0.5%, about 6% to about 10%, about 4% to about 15%, about 2% to about 20%, or about 1% to about 25%) of the proportion of magnesium oxide by weight of the cementitious composition. The proportion by weight of the at least one accelerant can be about 0.1% to about 30% (e.g., about 0.1% to about 30%, about 0.5% to about 30%, about 1% to about 30%, about 2% to about 30%, about 4% to about 30%, about 6% to about 30%, about 8% to about 30%, about 10% to about 30%, about 15% to about 30%, about 20% to about 30%, about 25% to about 30%, about 0.1% to about 25%, about 0.1% to about 20%, about 0.1% to about 15%, about 0.1% to about 10%, about 0.1% to about 8%, about 0.1% to about 6%, about 0.1% to about 4%, about 0.1% to about 2%, about 0.1% to about 1%, about 0.1% to about 0.5%, about 6% to about 10%, about 4% to about 15%, about 2% to about 20%, or about 1% to about 25%) of the proportion of magnesium hydroxide by weight of the cementitious composition.

The cementitious compositions (e.g., shaped cementitious compositions) described herein can comprise any amount or proportion of magnesium chloride (e.g., MgCl₂). The proportions can be calculated by the wet weight (e.g., the weight of the cementitious composition following the addition of a liquid such as water) or the dry weight (e.g., the weight of the cementitious composition prior to addition of a liquid such as water). The proportion by weight of magnesium chloride can be about 5% to about 145% (e.g., about 5% to about 140%, about 5% to about 135%, about 5% to about 130%, about 5% to about 125%, about 5% to about 120%, about 5% to about 115%, about 5% to about 110%, about 5% to about 105%, about 5% to about 100%, about 5% to about 95%, about 5% to about 90%, about 5% to about 85%, about 5% to about 80%, about 5% to about 75%, about 5% to about 70%, about 5% to about 65%, about 5% to about 60%, about 5% to about 55%, about 5% to about 50%, about 5% to about 45%, about 5% to about 40%, about 5% to about 35%, about 5% to about 30%, about 5% to about 25%, about 5% to about 20%, about 5% to about 15%, about 5% to about 10%, about 10% to about 145%, about 15% to about 145%, about 20% to about 145%, about 25% to about 145%, about 30% to about 145%, about 35% to about 145%, about 40% to about 145%, about 45% to about 145%, about 50% to about 145%, about 55% to about 145%, about 60% to about 145%, about 65% to about 145%, about 70% to about 145%, about 75% to about 145%, about 80% to about 145%, about 85% to about 145%, about 90% to about 145%, about 95% to about 145%, about 100% to about 145%, about 105% to about 145%, about 110% to about 145%, about 115% to about 145%, about 120% to about 145%, about 125% to about 145%, about 130% to about 145%, about 135% to about 145%, about 140% to about 145%, about 65% to about 75%, about 60% to about 80%, about 55% to about 85%, about 50% to about 90%, about 45% to about 95%, about 40% to about 100%, about 35% to about 105%, about 30% to about 110%, about 25% to about 115%, about 20% to about 120%, about 15% to about 125%, about 10% to about 130%, about 15% to about 50%, about 80% to about 120%, about 70% to about 120%, or about 80% to about 145%) of the proportion of magnesium oxide (e.g., MgO) by weight of the cementitious composition. The proportion by weight of magnesium chloride can be about 5% to about 145% (e.g., about 5% to about 140%, about 5% to about 135%, about 5% to about 130%, about 5% to about 125%, about 5% to about 120%, about 5% to about 115%, about 5% to about 110%, about 5% to about 105%, about 5% to about 100%, about 5% to about 95%, about 5% to about 90%, about 5% to about 85%, about 5% to about 80%, about 5% to about 75%, about 5% to about 70%, about 5% to about 65%, about 5% to about 60%, about 5% to about 55%, about 5% to about 50%, about 5% to about 45%, about 5% to about 40%, about 5% to about 35%, about 5% to about 30%, about 5% to about 25%, about 5% to about 20%, about 5% to about 15%, about 5% to about 10%, about 10% to about 145%, about 15% to about 145%, about 20% to about 145%, about 25% to about 145%, about 30% to about 145%, about 35% to about 145%, about 40% to about 145%, about 45% to about 145%, about 50% to about 145%, about 55% to about 145%, about 60% to about 145%, about 65% to about 145%, about 70% to about 145%, about 75% to about 145%, about 80% to about 145%, about 85% to about 145%, about 90% to about 145%, about 95% to about 145%, about 100% to about 145%, about 105% to about 145%, about 110% to about 145%, about 115% to about 145%, about 120% to about 145%, about 125% to about 145%, about 130% to about 145%, about 135% to about 145%, about 140% to about 145%, about 65% to about 75%, about 60% to about 80%, about 55% to about 85%, about 50% to about 90%, about 45% to about 95%, about 40% to about 100%, about 35% to about 105%, about 30% to about 110%, about 25% to about 115%, about 20% to about 120%, about 15% to about 125%, about 10% to about 130%, about 15% to about 50%, about 80% to about 120%, about 70% to about 120%, or about 80% to about 145%) of the proportion of the magnesium hydroxide (e.g., Mg(OH₂)) by weight of the cementitious composition. The proportion by weight of magnesium chloride can be about 0.1% to about 30% (e.g., about 0.1% to about 30%, about 0.5% to about 30%, about 1% to about 30%, about 2% to about 30%, about 4% to about 30%, about 6% to about 30%, about 8% to about 30%, about 10% to about 30%, about 15% to about 30%, about 20% to about 30%, about 25% to about 30%, about 0.1% to about 25%, about 0.1% to about 20%, about 0.1% to about 15%, about 0.1% to about 10%, about 0.1% to about 8%, about 0.1% to about 6%, about 0.1% to about 4%, about 0.1% to about 2%, about 0.1% to about 1%, about 0.1% to about 0.5%, about 6% to about 10%, about 4% to about 15%, about 2% to about 20%, or about 1% to about 25%) of the proportion of magnesium oxide by weight of the cementitious composition. The proportion by weight of magnesium chloride can be about 0.1% to about 30% (e.g., about 0.1% to about 30%, about 0.5% to about 30%, about 1% to about 30%, about 2% to about 30%, about 4% to about 30%, about 6% to about 30%, about 8% to about 30%, about 10% to about 30%, about 15% to about 30%, about 20% to about 30%, about 25% to about 30%, about 0.1% to about 25%, about 0.1% to about 20%, about 0.1% to about 15%, about 0.1% to about 10%, about 0.1% to about 8%, about 0.1% to about 6%, about 0.1% to about 4%, about 0.1% to about 2%, about 0.1% to about 1%, about 0.1% to about 0.5%, about 6% to about 10%, about 4% to about 15%, about 2% to about 20%, or about 1% to about 25%) of the proportion of magnesium hydroxide by weight of the cementitious composition.

The cementitious compositions (e.g., shaped cementitious compositions) described herein can comprise any amount or proportion of magnesium nitrate (e.g., Mg(NO₃)₂). The proportions can be calculated by the wet weight (e.g., the weight of the cementitious composition following the addition of a liquid such as water) or the dry weight (e.g., the weight of the cementitious composition prior to addition of a liquid such as water). The proportion by weight of magnesium nitrate can be about 5% to about 145% (e.g., about 5% to about 140%, about 5% to about 135%, about 5% to about 130%, about 5% to about 125%, about 5% to about 120%, about 5% to about 115%, about 5% to about 110%, about 5% to about 105%, about 5% to about 100%, about 5% to about 95%, about 5% to about 90%, about 5% to about 85%, about 5% to about 80%, about 5% to about 75%, about 5% to about 70%, about 5% to about 65%, about 5% to about 60%, about 5% to about 55%, about 5% to about 50%, about 5% to about 45%, about 5% to about 40%, about 5% to about 35%, about 5% to about 30%, about 5% to about 25%, about 5% to about 20%, about 5% to about 15%, about 5% to about 10%, about 10% to about 145%, about 15% to about 145%, about 20% to about 145%, about 25% to about 145%, about 30% to about 145%, about 35% to about 145%, about 40% to about 145%, about 45% to about 145%, about 50% to about 145%, about 55% to about 145%, about 60% to about 145%, about 65% to about 145%, about 70% to about 145%, about 75% to about 145%, about 80% to about 145%, about 85% to about 145%, about 90% to about 145%, about 95% to about 145%, about 100% to about 145%, about 105% to about 145%, about 110% to about 145%, about 115% to about 145%, about 120% to about 145%, about 125% to about 145%, about 130% to about 145%, about 135% to about 145%, about 140% to about 145%, about 65% to about 75%, about 60% to about 80%, about 55% to about 85%, about 50% to about 90%, about 45% to about 95%, about 40% to about 100%, about 35% to about 105%, about 30% to about 110%, about 25% to about 115%, about 20% to about 120%, about 15% to about 125%, about 10% to about 130%, about 15% to about 50%, about 80% to about 120%, about 70% to about 120%, or about 80% to about 145%) of the proportion of magnesium oxide (e.g., MgO) by weight of the cementitious composition. The proportion by weight of magnesium nitrate can be about 5% to about 145% (e.g., about 5% to about 140%, about 5% to about 135%, about 5% to about 130%, about 5% to about 125%, about 5% to about 120%, about 5% to about 115%, about 5% to about 110%, about 5% to about 105%, about 5% to about 100%, about 5% to about 95%, about 5% to about 90%, about 5% to about 85%, about 5% to about 80%, about 5% to about 75%, about 5% to about 70%, about 5% to about 65%, about 5% to about 60%, about 5% to about 55%, about 5% to about 50%, about 5% to about 45%, about 5% to about 40%, about 5% to about 35%, about 5% to about 30%, about 5% to about 25%, about 5% to about 20%, about 5% to about 15%, about 5% to about 10%, about 10% to about 145%, about 15% to about 145%, about 20% to about 145%, about 25% to about 145%, about 30% to about 145%, about 35% to about 145%, about 40% to about 145%, about 45% to about 145%, about 50% to about 145%, about 55% to about 145%, about 60% to about 145%, about 65% to about 145%, about 70% to about 145%, about 75% to about 145%, about 80% to about 145%, about 85% to about 145%, about 90% to about 145%, about 95% to about 145%, about 100% to about 145%, about 105% to about 145%, about 110% to about 145%, about 115% to about 145%, about 120% to about 145%, about 125% to about 145%, about 130% to about 145%, about 135% to about 145%, about 140% to about 145%, about 65% to about 75%, about 60% to about 80%, about 55% to about 85%, about 50% to about 90%, about 45% to about 95%, about 40% to about 100%, about 35% to about 105%, about 30% to about 110%, about 25% to about 115%, about 20% to about 120%, about 15% to about 125%, about 10% to about 130%, about 15% to about 50%, about 80% to about 120%, about 70% to about 120%, or about 80% to about 145%) of the proportion of the magnesium hydroxide (e.g., Mg(OH₂)) by weight of the cementitious composition. The proportion by weight of magnesium nitrate can be about 0.1% to about 30% (e.g., about 0.1% to about 30%, about 0.5% to about 30%, about 1% to about 30%, about 2% to about 30%, about 4% to about 30%, about 6% to about 30%, about 8% to about 30%, about 10% to about 30%, about 15% to about 30%, about 20% to about 30%, about 25% to about 30%, about 0.1% to about 25%, about 0.1% to about 20%, about 0.1% to about 15%, about 0.1% to about 10%, about 0.1% to about 8%, about 0.1% to about 6%, about 0.1% to about 4%, about 0.1% to about 2%, about 0.1% to about 1%, about 0.1% to about 0.5%, about 6% to about 10%, about 4% to about 15%, about 2% to about 20%, or about 1% to about 25%) of the proportion of magnesium oxide by weight of the cementitious composition. The proportion by weight of magnesium nitrate can be about 0.1% to about 30% (e.g., about 0.1% to about 30%, about 0.5% to about 30%, about 1% to about 30%, about 2% to about 30%, about 4% to about 30%, about 6% to about 30%, about 8% to about 30%, about 10% to about 30%, about 15% to about 30%, about 20% to about 30%, about 25% to about 30%, about 0.1% to about 25%, about 0.1% to about 20%, about 0.1% to about 15%, about 0.1% to about 10%, about 0.1% to about 8%, about 0.1% to about 6%, about 0.1% to about 4%, about 0.1% to about 2%, about 0.1% to about 1%, about 0.1% to about 0.5%, about 6% to about 10%, about 4% to about 15%, about 2% to about 20%, or about 1% to about 25%) of the proportion of magnesium hydroxide by weight of the cementitious composition.

The cementitious compositions (e.g., shaped cementitious compositions) described herein can comprise any amount or proportion of magnesium sulfate (e.g., MgSO₄). The proportions can be calculated by the wet weight (e.g., the weight of the cementitious composition following the addition of a liquid such as water) or the dry weight (e.g., the weight of the cementitious composition prior to addition of a liquid such as water). The proportion by weight of magnesium sulfate can be about 5% to about 145% (e.g., about 5% to about 140%, about 5% to about 135%, about 5% to about 130%, about 5% to about 125%, about 5% to about 120%, about 5% to about 115%, about 5% to about 110%, about 5% to about 105%, about 5% to about 100%, about 5% to about 95%, about 5% to about 90%, about 5% to about 85%, about 5% to about 80%, about 5% to about 75%, about 5% to about 70%, about 5% to about 65%, about 5% to about 60%, about 5% to about 55%, about 5% to about 50%, about 5% to about 45%, about 5% to about 40%, about 5% to about 35%, about 5% to about 30%, about 5% to about 25%, about 5% to about 20%, about 5% to about 15%, about 5% to about 10%, about 10% to about 145%, about 15% to about 145%, about 20% to about 145%, about 25% to about 145%, about 30% to about 145%, about 35% to about 145%, about 40% to about 145%, about 45% to about 145%, about 50% to about 145%, about 55% to about 145%, about 60% to about 145%, about 65% to about 145%, about 70% to about 145%, about 75% to about 145%, about 80% to about 145%, about 85% to about 145%, about 90% to about 145%, about 95% to about 145%, about 100% to about 145%, about 105% to about 145%, about 110% to about 145%, about 115% to about 145%, about 120% to about 145%, about 125% to about 145%, about 130% to about 145%, about 135% to about 145%, about 140% to about 145%, about 65% to about 75%, about 60% to about 80%, about 55% to about 85%, about 50% to about 90%, about 45% to about 95%, about 40% to about 100%, about 35% to about 105%, about 30% to about 110%, about 25% to about 115%, about 20% to about 120%, about 15% to about 125%, about 10% to about 130%, about 15% to about 50%, about 80% to about 120%, about 70% to about 120%, or about 80% to about 145%) of the proportion of magnesium oxide (e.g., MgO) by weight of the cementitious composition. The proportion by weight of magnesium sulfate can be about 5% to about 150% (e.g., about 10% to about 150%, about 5% to about 145%, about 5% to about 140%, about 5% to about 135%, about 5% to about 130%, about 5% to about 125%, about 5% to about 120%, about 5% to about 115%, about 5% to about 110%, about 5% to about 105%, about 5% to about 100%, about 5% to about 95%, about 5% to about 90%, about 5% to about 85%, about 5% to about 80%, about 5% to about 75%, about 5% to about 70%, about 5% to about 65%, about 5% to about 60%, about 5% to about 55%, about 5% to about 50%, about 5% to about 45%, about 5% to about 40%, about 5% to about 35%, about 5% to about 30%, about 5% to about 25%, about 5% to about 20%, about 5% to about 15%, about 5% to about 10%, about 10% to about 145%, about 15% to about 145%, about 20% to about 145%, about 25% to about 145%, about 30% to about 145%, about 35% to about 145%, about 40% to about 145%, about 45% to about 145%, about 50% to about 145%, about 55% to about 145%, about 60% to about 145%, about 65% to about 145%, about 70% to about 145%, about 75% to about 145%, about 80% to about 145%, about 85% to about 145%, about 90% to about 145%, about 95% to about 145%, about 100% to about 145%, about 105% to about 145%, about 110% to about 145%, about 115% to about 145%, about 120% to about 145%, about 125% to about 145%, about 130% to about 145%, about 135% to about 145%, about 140% to about 145%, about 65% to about 75%, about 60% to about 80%, about 55% to about 85%, about 50% to about 90%, about 45% to about 95%, about 40% to about 100%, about 35% to about 105%, about 30% to about 110%, about 25% to about 115%, about 20% to about 120%, about 15% to about 125%, about 10% to about 130%, about 15% to about 50%, about 80% to about 120%, about 70% to about 120%, or about 80% to about 145%) of the proportion of the magnesium hydroxide (e.g., Mg(OH₂)) by weight of the cementitious composition. The proportion by weight of magnesium sulfate can be about 0.1% to about 30% (e.g., about 0.1% to about 30%, about 0.5% to about 30%, about 1% to about 30%, about 2% to about 30%, about 4% to about 30%, about 6% to about 30%, about 8% to about 30%, about 10% to about 30%, about 15% to about 30%, about 20% to about 30%, about 25% to about 30%, about 0.1% to about 25%, about 0.1% to about 20%, about 0.1% to about 15%, about 0.1% to about 10%, about 0.1% to about 8%, about 0.1% to about 6%, about 0.1% to about 4%, about 0.1% to about 2%, about 0.1% to about 1%, about 0.1% to about 0.5%, about 6% to about 10%, about 4% to about 15%, about 2% to about 20%, or about 1% to about 25%) of the proportion of magnesium oxide by weight of the cementitious composition. The proportion by weight of magnesium sulfate can be about 0.1% to about 30% (e.g., about 0.1% to about 30%, about 0.5% to about 30%, about 1% to about 30%, about 2% to about 30%, about 4% to about 30%, about 6% to about 30%, about 8% to about 30%, about 10% to about 30%, about 15% to about 30%, about 20% to about 30%, about 25% to about 30%, about 0.1% to about 25%, about 0.1% to about 20%, about 0.1% to about 15%, about 0.1% to about 10%, about 0.1% to about 8%, about 0.1% to about 6%, about 0.1% to about 4%, about 0.1% to about 2%, about 0.1% to about 1%, about 0.1% to about 0.5%, about 6% to about 10%, about 4% to about 15%, about 2% to about 20%, or about 1% to about 25%) of the proportion of magnesium hydroxide by weight of the cementitious composition.

In some embodiments, the at least one accelerant comprises a phosphate-based accelerant, wherein a proportion by weight of the phosphate-based accelerant is 0.1% to 5% (e.g., 0.5%-5%, 1-5%, 1.5%-5%, 2%-5%, 2%-4.5%, 2%-4%, 2%-3.5%, 2.5%-5%, 2.5-4.5%, 2.5%-4%, 2.5%-3.5%, 2.5%-3%, 3%-3.5%, 3%-5%, 4%-5%, values between the foregoing ranges, etc.) of the proportion of magnesium oxide by weight of the cementitious composition. The proportions can be calculated by the wet weight (e.g., the weight of the cementitious composition following the addition of a liquid such as water) or the dry weight (e.g., the weight of the cementitious composition prior to addition of a liquid such as water). In some embodiments, the at least one accelerant comprises a phosphate-based accelerant, wherein a proportion by weight of the phosphate-based accelerant is 0.1% to 5% (e.g., 0.5%-5%, 1-5%, 1.5%-5%, 2%-5%, 2%-4.5%, 2%-4%, 2%-3.5%, 2.5%-5%, 2.5-4.5%, 2.5%-4%, 2.5%-3.5%, 2.5%-3%, 3%-3.5%, 3%-5%, 4%-5%, values between the foregoing ranges, etc.) of the proportion of magnesium hydroxide by weight of the cementitious composition. In some embodiments, the phosphate-based accelerant comprises sodium hexametaphosphate. In some embodiments, the phosphate-based accelerant is selected from sodium hexametaphosphate, any other alkali metal phosphates, and phosphoric acid.

In embodiments, the at least one aggregate is selected from sand, gravel, lightweight aggregate, and crushed stone, or a combination thereof.

In some embodiments, the pourable cementitious mixture further comprises an activator selected from any sodium, lithium or potassium salt or hydroxide and any alkali or alkali earth metal ions.

In various embodiments, the pourable cementitious mixture further comprises an activator comprising one or more of Mg(OH)₂, MgO, Ca(OH)₂, CaCO₃, Al₂(SO₄)₃, and CaO.

In numerous embodiments, the amount of nitrate present relative to the amount of pozzolan ranges from about 2 wt. % to about 30 wt. %.

In several embodiments, the amount of sulfate present relative to the amount of pozzolan from about 0.1 wt. % to about 90 wt. %.

In many embodiments, the amount of sulfate present relative to the amount of pozzolan from about 20 wt. % to about 50% wt. %.

In embodiments, the amount of chloride present relative to the amount of pozzolan from about 0.1 wt. % to about 12 wt. %.

In embodiments, the amount of phosphate present relative to the amount of pozzolan ranges from about 0.1 wt. % to about 20 wt. %.

In some embodiments, the shaped cementitious composition comprises MgO, the amount of pozzolan present relative to the amount of MgO ranges from about 33 wt. % to about 300 wt. %.

In various embodiments, the shaped cementitious composition comprises MgO, the amount of pozzolan present relative to the amount of MgO from about 50 wt. % to about 200 wt. %.

In numerous embodiments, the shaped cementitious composition comprises MgO, the amount of pozzolan present relative to the amount of MgO from about 85 wt. % to about 115 wt. %.

In several embodiments, the shaped cementitious composition comprises Mg(OH)₂, the amount of pozzolan present relative to the amount of Mg(OH)₂ ranges from about 33 wt. % to about 300 wt. %.

In many embodiments, the shaped cementitious composition comprises Mg(OH)₂, and the amount of pozzolan present relative to the amount of Mg(OH)₂ ranges from about 50 wt. % to about 200 wt.

In embodiments, the shaped cementitious composition comprises Mg(OH)₂, and the amount of pozzolan present relative to the amount of Mg(OH)₂ ranges from about 85 wt. % to about 115 wt.

In embodiments, the amount of sulfate present in the aqueous solution ranges from about 1 wt. % to about 10 wt. %.

In some embodiments, the amount of sulfate present in the aqueous solution ranges from about 2 wt. % to about 8 wt. %.

In various embodiments, the amount of chloride present in the aqueous solution ranges from about 0.1 wt. % to about 5 wt. %.

In numerous embodiments, the amount of potassium present in the aqueous solution ranges from about 0.1 wt. % to about 5 wt. %.

In several embodiments, the amount of Mg(OH)₂ present in the aqueous solution ranges from about 2 wt. % to about 25 wt. %.

In many embodiments, the amount of Mg(OH)₂ present in the aqueous solution ranges from about 5 wt. % to about 20 wt. %.

In embodiments, the Mg(OH)₂ of the aqueous solution is not calcined.

In embodiments, the pourable cementitious mixture has a pH of at least 12.

In some embodiments, the pourable cementitious mixture has a pH of at least 13.

In various embodiments, the pourable cementitious mixture has a pH from 13 to 14.

In numerous embodiments, the shaped cementitious composition comprises natural pozzolan and manmade pozzolan, and the amount of natural pozzolan present relative to the amount of manmade pozzolan ranges from about 33 wt. % to about 300 wt. %.

In several embodiments, the shaped cementitious composition comprises natural pozzolan and manmade pozzolan, and the amount of natural pozzolan present relative to the amount of manmade pozzolan ranges from about 50 wt. % to about 200 wt. %.

In many embodiments, the shaped cementitious composition comprises natural pozzolan and manmade pozzolan, and the amount of natural pozzolan present relative to the amount of manmade pozzolan ranges from about 85 wt. % to about 115 wt. %.

In embodiments, the pozzolan comprises silica (SiO₂), alumina (Al₂O₃), and/or iron oxide (Fe₂O₃).

In embodiments, the pozzolan comprises or is obtained from one or more of volcanic rock (e.g., rhyolite, obsidian, pitchstone, pumice, basalt or trap, or andesite); volcanic ash; sedimentary clays or shales' calcined clays; rice husk ash; diatomaceous earth; metakaolin; and olivine.

In some embodiments, the use of a pozzolan avoids the problem of sourcing cementitious material that is used in standard concrete manufacturing. In some cases, avoiding the problem of sourcing cementitious material further reduces the amount of energy required and/or waste CO₂ produced relative to standard concrete manufacturing.

In various embodiments, the natural pozzolan is selected from rhyolite, obsidian, pitchstone, pumice, basalt, andesite, volcanic ash, sedimentary clay, shale, wollastonite, opaline shale, diatomaceous earth, and olivine, or a combination thereof.

In several embodiments, the manmade pozzolan is selected from metakaolin, fly ash, silica fume, ground glass (e.g., ground waste glass), slag (e.g. ground-granulated blast-furnace slag, blast-furnace slag, steel-furnace slag, basic-oxygen-furnace slag, electric-arc-furnace slag, ladle slag, copper slag, steel slag, iron slag, lead slag, nickel slag, zinc slag, aluminum slag, or slag from other metals), burned organic matter residues (e.g., rice husk ash or rice hull ash), expanded clay, expanded shale, and calcine clay, or a combination thereof. In some cases, the manmade pozzolan comprises a slag, e.g., comprising a blast-furnace slag. The blast-furnace slag may comprise ground-granulated blast-furnace slag. The amount of nitrate present relative to the amount of ground-granulated blast-furnace slag may range from about 2 wt. % to about 30 wt. %. The amount of sulfate present relative to the amount of ground-granulated blast-furnace slag may be from about 0.1 wt. % to about 90 wt. %. The amount of sulfate present relative to the amount of ground-granulated blast-furnace slag may be from about 20 wt. % to about 50% wt. %. The amount of chloride present relative to the amount of ground-granulated blast-furnace slag may be from about 0.1 wt. % to about 12 wt. %. The amount of phosphate present relative to the amount of ground-granulated blast-furnace slag may range from about 0.1 wt. % to about 20 wt. %. The amount of natural pozzolan present relative to the amount of ground-granulated blast-furnace slag may range from about 33 wt. % to about 300 wt. %. The amount of natural pozzolan present relative to the amount of ground-granulated blast-furnace slag may be from about 50 wt. % to about 200 wt. %. The amount of natural pozzolan present relative to the amount of ground-granulated blast-furnace slag may be from about 85 wt. % to about 115 wt. %. In some cases, the blast-furnace slag comprises ground-granulated blast-furnace slag.

In many embodiments, the shaped cementitious composition comprises Mg(OH)₂ and slag, and the ratio of Mg(OH)₂ to slag is from 75:25 by wt. % to 25:75 by wt. %.

In embodiments, the shaped cementitious composition comprises Mg(OH)₂ and slag, and the ratio of Mg(OH)₂ to slag is from 70:30 by wt. % to 30:70 by wt. %.

In embodiments, the shaped cementitious composition comprises Mg(OH)₂ and slag, and the ratio of Mg(OH)₂ to slag is from 65:35 by wt. % to 35:65 by wt. %.

In some embodiments, the shaped cementitious composition comprises Mg(OH)₂ and slag, and the ratio of Mg(OH)₂ to slag is from 60:40 by wt. % to 40:60 by wt. %.

In various embodiments, the shaped cementitious composition comprises Mg(OH)₂ and slag, and the ratio of Mg(OH)₂ to slag is from 55:45 by wt. % to 45:55 by wt. %.

In numerous embodiments, the shaped cementitious composition comprises Mg(OH)₂ and slag, and the ratio of Mg(OH)₂ to slag is about 50:50 by wt. %.

In several embodiments, the pourable cementitious mixture when manufactured was exposed to an applied pressure. In some cases, the pressure is from about ambient (1 bar) to about 250 bar, e.g., from about 100 bar to about 250 bar. In various cases, the pressure is from about ambient (1 bar) bar to about 100 bar.

In numerous embodiments, the pressure is from about ambient (1 bar) to about 100 bar. As examples, the pressure is about 1 bar, 2 bar, 3 bar, 4 bar, 5 bar, 6 bar, 7 bar, 8 bar, 9 bar, 10 bar, 11 bar, 12 bar, 13 bar, 14 bar, 15 bar, 16 bar, 17 bar, 18 bar, 19 bar, 20 bar, 21 bar, 22 bar, 23 bar, 24 bar, 25 bar, 26 bar, 27 bar, 28 bar, 29 bar, 30 bar, 31 bar, 32 bar, 33 bar, 34 bar, 35 bar, 36 bar, 37 bar, 38 bar, 39 bar, 40 bar, 41 bar, 42 bar, 43 bar, 44 bar, 45 bar, 46 bar, 47 bar, 48 bar, 49 bar, 50 bar, 51 bar, 52 bar, 53 bar, 54 bar, 55 bar, 56 bar, 57 bar, 58 bar, 59 bar, 60 bar, 61 bar, 62 bar, 63 bar, 64 bar, 65 bar, 66 bar, 67 bar, 68 bar, 69 bar, 70 bar, 71 bar, 72 bar, 73 bar, 74 bar, 75 bar, 76 bar, 77 bar, 78 bar, 79 bar, 80 bar, 81 bar, 82 bar, 83 bar, 84 bar, 85 bar, 86 bar, 87 bar, 88 bar, 89 bar, 90 bar, 91 bar, 92 bar, 93 bar, 94 bar, 95 bar, 96 bar, 97 bar, 98 bar, 99 bar, or about 100 bar, and any range or value therebetween.

In various embodiments, the pressure is from about 100 bar to about 250 bar. As examples, the pressure in about 101 bar, 102 bar, 103 bar, 104 bar, 105 bar, 106 bar, 107 bar, 108 bar, 109 bar, 110 bar, 111 bar, 112 bar, 113 bar, 114 bar, 115 bar, 116 bar, 117 bar, 118 bar, 119 bar, 120 bar, 121 bar, 122 bar, 123 bar, 124 bar, 125 bar, 126 bar, 127 bar, 128 bar, 129 bar, 130 bar, 131 bar, 132 bar, 133 bar, 134 bar, 135 bar, 136 bar, 137 bar, 138 bar, 139 bar, 140 bar, 141 bar, 142 bar, 143 bar, 144 bar, 145 bar, 146 bar, 147 bar, 148 bar, 149 bar, 150 bar, 151 bar, 152 bar, 153 bar, 154 bar, 155 bar, 156 bar, 157 bar, 158 bar, 159 bar, 160 bar, 161 bar, 162 bar, 163 bar, 164 bar, 165 bar, 166 bar, 167 bar, 168 bar, 169 bar, 170 bar, 171 bar, 172 bar, 173 bar, 174 bar, 175 bar, 176 bar, 177 bar, 178 bar, 179 bar, 180 bar, 181 bar, 182 bar, 183 bar, 184 bar, 185 bar, 186 bar, 187 bar, 188 bar, 189 bar, 190 bar, 191 bar, 192 bar, 193 bar, 194 bar, 195 bar, 196 bar, 197 bar, 198 bar, 199 bar, 200 bar, 101 bar, 202 bar, 203 bar, 204 bar, 205 bar, 206 bar, 207 bar, 208 bar, 209 bar, 210 bar, 211 bar, 212 bar, 213 bar, 214 bar, 215 bar, 216 bar, 217 bar, 218 bar, 219 bar, 220 bar, 221 bar, 222 bar, 223 bar, 224 bar, 225 bar, 226 bar, 227 bar, 228 bar, 229 bar, 230 bar, 231 bar, 232 bar, 233 bar, 234 bar, 235 bar, 236 bar, 237 bar, 238 bar, 239 bar, 240 bar, 241 bar, 242 bar, 243 bar, 244 bar, 245 bar, 246 bar, 247 bar, 248 bar, 249 bar, or about 250 bar, and any range or value therebetween.

In various embodiments, the pressure in step (b) is greater than about 250 bar. For example, the pressure in step (b) is greater than, 250 bar, 500 bar, 750 bar, 1000 bar, 1250 bar, 1500 bar, 1750 bar, 2000 bar, 2250 bar, 2500 bar, 2750 bar, 3000 bar, 3250 bar, 3500 bar, 3750 bar, 4000 bar, 4250 bar, 4500 bar, 4750 bar, 5000 bar and any range or value therebetween. In various cases the pressure in step (b) is greater than 250 bar, 260 bar, 270 bar, 280 bar, 290 bar, 300 bar, 310 bar, 320 bar, 330 bar, 340 bar, 350 bar, 360 bar, 370 bar, 380 bar, 390 bar, 400 bar, 410 bar, 420 bar, 430 bar, 440 bar, 450 bar, 460 bar, 470 bar, 480 bar, 490 bar, 500 bar and any range or value therebetween. The pressure in step (b) may be greater than 500 bar, 510 bar, 520 bar, 530 bar, 540 bar, 550 bar, 560 bar, 570 bar, 580 bar, 590 bar, 600 bar, 610 bar, 620 bar, 630 bar, 640 bar, 650 bar, 660 bar, 670 bar, 680 bar, 690 bar, 700 bar, 710 bar, 720 bar, 730 bar, 740 bar, 750 bar, 760 bar, 770 bar, 780 bar, 790 bar, 800 bar, 810 bar, 820 bar, 830 bar, 840 bar, 850 bar, 860 bar, 870 bar, 880 bar, 890 bar, 900 bar, 910 bar, 920 bar, 930 bar, 940 bar, 950 bar, 960 bar, 970 bar, 980 bar, 990 bar, 1000 bar and any range or value therebetween.

In many embodiments, the temperature of the pourable cementitious mixture when manufactured ranges from about 1° C. to about 100° C. mixture absent an applied heat. As examples, the temperature is about 1° C., 2° C., 3° C., 4° C., 5° C., 6° C., 7° C., 8° C., 9° C., 10° C., 11° C., 12° C., 13° C., 14° C., 15° C., 16° C., 17° C., 18° C., 19° C., 20° C., 21° C., 22° C., 23° C., 24° C., 25° C., 26° C., 27° C., 28° C., 29° C., 30° C., 31° C., 32° C., 33° C., 34° C., 35° C., 36° C., 37° C., 38° C., 39° C., 40° C., 41° C., 42° C., 43° C., 44° C., 45° C., 46° C., 47° C., 48° C., 49° C., 50° C., 51° C., 52° C., 53° C., 54° C., 55° C., 56° C., 57° C., 58° C., 59° C., 60° C., 61° C., 62° C., 63° C., 64° C., 65° C., 66° C., 67° C., 68° C., 69° C., 70° C., 71° C., 72° C., 73° C., 74° C., 75° C., 76° C., 77° C., 78° C., 79° C., 80° C., 81° C., 82° C., 83° C., 84° C., 85° C., 86° C., 87° C., 88° C., 89° C., 90° C., 91° C., 92° C., 93° C., 94° C., 95° C., 96° C., 97° C., 98° C., 99° C., or about 100° C., and any range or value therebetween.

In embodiments, the pourable cementitious mixture when manufactured was exposed to an applied heat. In some cases, the applied heat provides a temperature of greater than 100° C. and up to 3000° C. The heat may increase the rate of a reaction and/or the extent of a reaction. The heat may activate the latent hydraulic nature of some components.

In various cases, the applied pressure and/or applied heat occurs for from about 1 minute to about 10 hours. As examples the duration is about 10 minutes, 20 minutes, 30 minutes, 40 minutes, 50 minutes, 60 minutes, 70 minutes, 80 minutes, 90 minutes, 2 hours, 3 hours, 4 hours, 5 hours, 6 hours, 7 hours, 8 hours, 9 hours, or about 10 hours, and any range or value therebetween.

In embodiments, the applied pressure and/or applied heat occurs for from about 1 minute to about 10 minutes. As examples the duration is about 1 minute, 2 minutes, 3 minutes, 4 minutes, 5 minutes, 6 minutes, 7 minutes, 8 minutes, 9 minutes, or about 10 minutes, and any range or value therebetween.

In several embodiments, the applied pressure and/or applied heat occurs from about 10 hours to about 10 days. As examples the duration is about 10 hours, 20 hours, 30 hours, 40 hours, 50 hours, 60 hours, 70 hours, 80 hours, 90 hours, 2 days, 3 days, 4 days, 5 days, 6 days, 7 days, 8 days, 9 days, or about 10 days, and any range or value therebetween.

In some embodiments, during manufacturing of the pourable cementitious mixture the salinity of the aqueous solution is lessened, thereby producing a reduced salinity water component. In some cases, the reduced salinity water component has a salt concentration that is less than or about equal to the salt concentration of seawater. The reduced salinity water component may have a salt concentration that is less than the high salinity brine.

In various embodiments, the shaped cementitious composition comprises any sodium, lithium or potassium salt or hydroxide and any alkali or alkali earth metal ions and including Mg(OH)₂, MgO, Ca(OH)2, CaCO₃, Al₂(SO₄)₃, CaO, CaSO₄·H₂O, SiO₂, Fe₂O₃, Al₂O₃ and/or Brucite.

In numerous embodiments, the shaped cementitious composition does not substantially comprise MgO obtained from a calcination reaction.

In several embodiments, the pourable cementitious mixture further comprises a foaming agent.

In many embodiments, the foaming agent create voids and a porous structure that can mimic natural coral habitats.

In embodiments, the pourable cementitious mixture comprises locally-sourced materials.

In embodiments, the pourable cementitious mixture is molded into the shaped cementitious composition.

In some embodiments, the shaped cementitious composition is set by pouring the cementitious mixture into a mold and then applying a curing technique to the pourable cementitious mixture.

In various embodiments, the shaped cementitious composition permits stronger attachment by aquatic flora and/or fauna relative to a standard cement.

In numerous embodiments, the shaped cementitious composition permits more plentiful attachment by aquatic flora and/or fauna relative to a standard cement.

In several embodiments, the shaped cementitious composition permits a preferred level of colonization by aquatic flora and/or fauna relative to a standard cement.

In many embodiments, the shaped cementitious composition permits more plentiful attachment by aquatic flora and/or fauna relative to a standard cement.

In embodiments, there is a reduced energy cost for attachment by aquatic flora and/or fauna, e.g., larval aquatic fauna, to the shaped cementitious composition relative to a standard cement. In some cases, the reduced energy cost by aquatic flora and/or fauna permits more rapid attachment and stronger attachment, e.g., by larval aquatic fauna, to the surface of the shaped cementitious composition relative to a standard cement. The reduced energy cost by aquatic flora and/or fauna may permit more rapid growth and more rapid development, e.g., by larval aquatic fauna, relative to a standard cement.

In embodiments, mucus secreted by larval aquatic fauna is more adherent to a surface of the shaped cementitious composition relative to a standard cement.

In some embodiments, gut filaments produced by larval aquatic fauna is more adherent to a surface of the shaped cementitious composition relative to a standard cement.

In various embodiments, the shaped cementitious composition has a more porous surface, is more porous throughout its volume, and/or is less dense than a standard cement.

In numerous embodiments, the pores of the shaped cementitious composition are up to 500 nm in diameter.

In several embodiments, the surface of the shaped cementitious composition is more hydrostatic than the surface of a standard cement.

In many embodiments, the surface of the shaped cementitious composition comprises more magnesium (Mg) than the surface of a standard cement.

In embodiments, the pH of surface of the shaped cementitious composition, prior to attachment by aquatic flora and/or fauna, is higher than the pH of sea water.

In embodiments, the pH of surface of the shaped cementitious composition is less than the pH of the surface of a standard cement.

In some embodiments, the shape of the shaped cementitious composition is any shape capable of providing a substrate for aquatic flora and/or fauna attachment.

In various embodiments, the shape of the shaped cementitious composition is planar, circular, rounded, elongated, flat, rectangular, tubular, hollow, solid, or any combination thereof.

In numerous embodiments, the shape of the shaped cementitious composition is a cube, cuboid, cone, cylinder, dodecahedron, polyhedron, prism, pyramid, sphere, tetrahedron, anthropomorphic, zoomorphic, symbolic, or any combination thereof.

In several embodiments, the shape of the shaped cementitious composition is pyramidal with open surfaces such that the shape comprises four bars or cylinders that form a square base and four bars or cylinders each originating at a corner of the square and converging to form the pyramid's apex.

In many embodiments, the surface is flat or the surface comprises contouring, e.g., regular contours or irregular contours, which provide increased surface area and/or locations for attachment by the aquatic flora and/or fauna.

In embodiments, the shape of the shaped cementitious composition is like a hydrofoil. In some cases, the hydrofoil shape efficiently redirects the flow of water, which reduces pressure on the structure by minimizing drag and turbulence caused by currents.

In embodiments, the surface is rougher and/or more textured than a surface of a standard cement.

In some embodiments, the aquatic fauna comprises coral.

In various embodiments, the surface is rougher and/or more textured than a surface of a standard cement, allowing a coral to secrete calcium carbonate and other substances that help it anchor and grow on the cementitious composition's surface.

In numerous embodiments, the aquatic flora comprises algae.

Any method or method step disclosed herein is applicable to any other herein-disclosed method or method step. In other words, any aspect or embodiment described herein can be combined with any other aspect or embodiment as disclosed herein.

### Definitions

Unless defined otherwise, all terms of art, notations and other technical and scientific terms or terminology used herein are intended to have the same meaning as is commonly understood by one of ordinary skill in the art to which the claimed subject matter pertains. In some cases, terms with commonly understood meanings are defined herein for clarity and/or for ready reference, and the inclusion of such definitions herein should not necessarily be construed to represent a substantial difference over what is generally understood in the art.

As used herein, the singular forms “a”, “an”, and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising.”

The term “about” or “approximately” means within an acceptable error range for the particular value as determined by one of ordinary skill in the art, which will depend in part on how the value is measured or determined, e.g., the limitations of the measurement system. For example, “about” can mean within 1 or more than 1 standard deviation, per the practice in the art. Alternatively, “about” can mean a range of up to 20%, up to 15%, up to 10%, up to 5%, or up to 1% of a given value. In some cases, the term “about” refers to ±10% of a stated number or value. Alternatively, particularly with respect to biological systems or processes, the term can mean within an order of magnitude, preferably within 5-fold, and more preferably within 2-fold, of a value. Where particular values are described in the application and claims, unless otherwise stated the term “about” meaning within an acceptable error range for the particular value should be assumed.

As used herein, the phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

As used herein, “or” may refer to “and”, “or,” or “and/or” and may be used both exclusively and inclusively. For example, the term “A or B” may refer to “A or B”, “A but not B”, “B but not A”, and “A and B”. In some cases, context may dictate a particular meaning.

The terms “increased”, “increasing”, “increase”, “improved”, “improvement”, “improving” and the like, are used herein to generally means an increase by a statically significant amount. In some aspects, the terms “increased” or “improved” means an increase or improvement of at least 10% as compared to a reference level, for example an increase or improvement of at least about 10%, at least about 20%, or at least about 30%, or at least about 40%, or at least about 50%, or at least about 60%, or at least about 70%, or at least about 80%, or at least about 90% or up to and including a 100% increase or any improvement between 10-100% as compared to a reference level, standard, or control. Other examples of “increase” or “improvement” includes an increase of at least 2-fold, at least 5-fold, at least 10-fold, at least 20-fold, at least 50-fold, at least 100-fold, at least 1000-fold or more as compared to a reference level.

The terms “decreased”, “decreasing”, “decrease”, “reduced”, “reducing”, “reduce” and the like, are used herein generally to mean a decrease or reduction by a statistically significant amount. In some aspects, “decreased” or “reduced” means a reduction by at least 10% as compared to a reference level, for example a decrease or reduction by at least about 20%, or at least about 30%, or at least about 40%, or at least about 50%, or at least about 60%, or at least about 70%, or at least about 80%, or at least about 90% or up to and including a 100% decrease or reduction (e.g., absent level or non-detectable level as compared to a reference level), or any decrease or reduction between 10-100% as compared to a reference level.

Throughout this application, various embodiments may be presented in a range format. It should be understood that the description in range format is merely for convenience and brevity and should not be construed as an inflexible limitation on the scope of the disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Where the term “pozzolan” is recited, it is to be understood that natural pozzolan, man-made pozzolan, or a mixture thereof is intended. In embodiments, the pozzolan used in a composition or method provided expressly excludes one or more—or each of—the man-made pozzolans listed herein.

As used herein, the term “accelerant” or “activator” is used in accordance with its plain ordinary meaning and refers a substance that improves the chemical reaction and affords a higher strength material. In embodiments, activators or accelerants contemplated in the present application include, but are not limited to, sulfates, nitrates, phosphates and chloride. In embodiments, the activator may be any sodium, lithium or potassium salt or hydroxide and any alkali or alkali earth metal ions and including Mg(OH)₂, MgO, Ca(OH)₂, CaCO₃, Al₂(SO₄)₃, and/or CaO. The amount of activator or accelerant added may vary depending on various factors. For example, more activator or accelerant may be added to large amounts of material (i.e., high mass). In addition, the lower the ambient temperature, the more activator or accelerant may be used. The amount of activator or accelerant used will vary depending on the amount of and/or type of pozzolan, MgO or Mg(OH)₂ used. The amount of activator or accelerant used will vary depending on the ratio of pozzolan, MgO or Mg(OH)₂ used. The amount of activator or accelerant used will vary based on the aqueous solution (e.g., water, non-potable water, brackish water, brine, concentrated brine, seawater) used.

As used herein, the term “aggregates”, “aggregate”, “filler material” or “other additive” is used in accordance with its plain ordinary meaning and refers to inert granular materials such as sand, gravel, lightweight aggregate, or crushed stone whether normal weight and/or lightweight that, along with cementitious materials and other optional raw materials such as pigment and/or admixtures, are used in concrete. Further, the term “aggregates” as used herein can include ASTM International C 33 fine aggregates, ASTM International C 33 coarse aggregates, and other particulate materials mixed into a cementitious composition. The aggregate can be processed: crushed, screened, and washed to obtain proper cleanliness and gradation. In some cases, a beneficiation process such as jigging or heavy media separation can be used to upgrade the quality. Once processed, the aggregates can be handled and stored to minimize segregation and degradation and prevent contamination and to also protect from the weather as well as to allow to drain away and/or evaporate moisture. Aggregates, from different sources, or produced by different methods, may differ considerably in particle shape, size and texture. Shape of the aggregates of the present disclosure may be cubical and reasonably regular, essentially rounded, angular, or irregular. Surface texture may range from relatively smooth with small, exposed pores to irregular with small to large, exposed pores. Particle shape and surface texture of both fine and coarse aggregates may influence proportioning of mixtures in such factors as workability, pumpability, fine-to-coarse aggregate ratio, and water requirement.

As used herein, the term “aggregate-like, solid particle” refers to a solid particle that visually resembles sand. The particles contemplated herein range in size from about 0.0625 mm to about 40.0 mm. In embodiments, coarse aggregate sizes are larger than 4.75 mm, while fine aggregates are 4.75 mm or less. In embodiments, a maximum size up to 40 mm is used for coarse aggregate in most structural applications, while for mass concreting purposes such as dams, sizes up to 150 mm may be used. In embodiments, fine aggregates have particles up to a minimum size of 0.075 mm.

As used herein, the term “basalt” refers to a fine-grained, extrusive igneous rock formed from the rapid cooling of low-viscosity lava rich in magnesium and iron. While basalt has a relatively lower amount of SiO₂ compared to other common igneous rocks, basalt generally has a composition of 45-52 wt. % SiO₂, 2-5 wt. % total alkalis, 0.5-2.0 wt. % TiO₂, 5-14% wt. %, and 14 wt. % Al₂O₃.

As used herein, the term “brine” is used in accordance with its plain ordinary meaning, and refers to a high concentration of salt in water. In embodiments, the concentration ranges from about 3 g of salt per liter of water to 26 g of salt per liter of water. In embodiments, the salt concentration of brine exceeds that of natural seawater. In embodiments, the salt concentration of brine is at least 101% greater than the salt concentration of natural seawater. In embodiments, the salt concentration of brine ranges from about 101% greater than the salt concentration of natural seawater to about 1000% greater than the salt concentration of natural seawater. In embodiments, brine is also referred to as desalination brine effluent. In embodiments, brine may include, but is not limited to, trace metals such as iron, nickel, chromium, and molybdenum. In embodiments, the brine is not processed. In embodiments, the brine is minimally processed. In embodiments, the brine is highly concentrated. In embodiments, the brine contains one or more reactants. In embodiments, the brine contains at least 75% (by weight) of one or more reactants. In embodiments, the brine is supplemented with one or more reactants.

As used herein, “bauxite” refers to a naturally occurring, heterogeneous material composed primarily of one or more aluminum hydroxide minerals plus various mixtures of silica, iron oxide, titania, aluminosilicate, and other impurities. In embodiments, bauxite residue which is an industrial wasted generated during the processing of bauxite into alumina using the Bayer process forms what is conventionally referred to as “red mud.”

As used herein, “calcined pozzolans” is used in accordance with its plain ordinary meaning and refers to products that are derived from shales and clays.

As used herein “calcium aluminates” refers to a range of materials that are obtained by combining calcium oxide and aluminum oxide in the presence of high temperatures. Calcium aluminates include tricalcium aluminate (3CaO·Al₂O₃), dodecacalcium hepta-aluminate (12CaO·7Al₂O₃) (C₁₂A₇) (mayenite), monocalcium aluminate (CaO·Al₂O₃) (CA) (occurring in nature as krotite and dmitryivanovite as two polymorphs), monocalcium 80ealuminate (CaO·2Al₂O₃) (CA₂) (occurring in nature as grossite), monocalcium hexa-aluminate (CaO·6Al₂O₃) (CA₆) (occurring in nature as hibonite).

Calcium aluminate cements refer to compositions that are sulfate free and afford hydrated calcium aluminates or carboaluminates. In embodiments, the major constituent and most reactive phase of calcium aluminate cements is monocalcium aluminate (CaO·Al₂O₃), which contain other calcium aluminates as well as a variety of less reactive phases. In embodiments, calcium aluminate cements are able to obtain more strength than ordinary Portland cement. In embodiments, a retarding admixture is used.

As used herein, the term “cement” is used in accordance with its plain ordinary meaning and refers to powdery substance made for use in making mortar or concrete. For example, cement can be a material that sets, hardens, and/or adheres to other materials to bind them to together, for example to make materials such as concrete. In embodiments, concrete is a mineral binder free of any organic compounds. In embodiments, the present application contemplates a Portland-cement free product. Some embodiments contemplate a reduced Portland Cement containing material with less than 90%, 80%, 70%, 60%, 50%, 40%, 30%, 25%, 20%, 15%, 10%, or 5% of Portland Cement; or any sub value or subrange between 0% and 90%. In embodiments, Portland Cement comprises calcium, silicon, aluminum, and iron. In embodiments, Portland Cement comprises CaO, CaCO₃, SiO₂, Al₂O₃, Fe₂O₃, and CaSO₄·H₂O. In embodiments, cement may be characterized as non-hydraulic or hydraulic cement. It should further be understood that “cementitious” can mean a material, including a material according to the embodiments described herein that has one or more of the characteristics or features of cement. In some embodiments, the cementitious composition does not comprise Portland cement.

As used herein, the term “concrete” is used in accordance with its plain ordinary meaning and refers to an artificial, stonelike material used for various structural purposes, made by mixing cement and various aggregates, as sand, pebbles, gravel, or shale, with water and allowing the cementitious composition to harden. In embodiments, the term “stonelike” refers to a material that visually, functionally and/or characteristically resembles stone, including when its hardened state. In embodiments, “concrete-replacement material” is interchangeably used with “artificial, stonelike material” throughout.

As used herein, the term “artificial, stonelike material” refers to a cementitious material used for various structural purposes or non-structural purposes (such as a slab, panel, paver or tile), made by mixing a cement alternative as contemplated herein and various aggregates, as sand, pebbles, gravel, lightweight aggregate, or shale, with water and allowing the cementitious composition to harden. In embodiments, the term “stonelike” refers to a material that visually resembles stone. In embodiments, “concrete-replacement material” is interchangeably used with “artificial, stonelike material” throughout.

As used herein, the term “desalination” is used in accordance with its plain ordinary meaning and refers to the process of removing salts or other minerals and contaminants from seawater, brackish water, well water, and wastewater effluent and it is an increasingly common solution to obtain fresh water for human consumption and for domestic/industrial utilization.

As used herein, the phrase “desalination wastewater” refers to reject brine from desalination. In embodiments, the process of removing salt from seawater to afford freshwater produces a highly concentrated brine as a by-product. The by-product is usually disposed of by discharging it back into the sea, a process that requires costly pumping systems and that must be managed carefully to prevent damage to marine ecosystems. This process, if not managed properly, disturbs the local water and sediment by introducing a multi-component waste and increasing temperature, which also endangers the marine organisms due to the residual chemicals mixed into the brine from the pre-treatment process.

As used herein, the term “freshwater” refers to water with a low dissolved salt concentration. In embodiments, freshwater does not include seawater and brackish water. In embodiments, freshwater may include, but is not limited to, frozen and meltwater in ice sheets, ice caps, glaciers, snowfields and icebergs, natural precipitation (e.g., rainfall, snowfall, hail, sleet). In embodiments, the salt concentration is less than 5%, less than 4%, less than 3%, less than 2%, and less than 1%, including sub-values in-between.

As used herein, the term “non-hydraulic cement” is used in accordance with its plain ordinary meaning and refers to cement that does not set in wet conditions or under water. In embodiments, non-hydraulic cement sets as it dries and reacts with CO₂ in the air. In embodiments, non-hydraulic cement is resistant to degradation by chemicals after setting.

As used herein, the term “hydraulic cement” is used in accordance with its plain ordinary meaning and refers to cement that sets in wet conditions due to a chemical reaction between the dry ingredients and water. In embodiments, the chemical reaction results in mineral hydrates that are either completely or nearly insoluble in water. In embodiments, hydraulic cement also refers to Portland Cement.

As used herein, the term “latently hydraulic material” is used in accordance with its plain ordinary meaning. In some cases, the latently hydraulic material is a slag, as used herein. In some cases, the latently hydraulic material is a natural pozzolan or a manmade pozzolan and which has latently hydraulic properties. A latently hydraulic material may be a material that will react with water to form a solid over an extended period of time.

As used herein, the term “mixing” is used in accordance with its plain ordinary meaning and refers to any form of mixing and may include milling or grinding of substances in solid form.

As used herein, the term “mortar” is used in accordance with its plain ordinary meaning and refers to a material composed of binder(s).

As used herein, the term “negative carbon dioxide-emitting concrete-replacement material” refers to a material that has a net positive CO₂ absorption as opposed to having a lower carbon footprint. In embodiments, the present application contemplates a material that produces carbon credits. In embodiments, the concrete-replacement material absorbs more carbon dioxide than is emitted.

As used herein, the term “seawater” is used in accordance with its plain ordinary meaning and refers to water from the sea or ocean. In embodiments, seawater includes various salts, dissolved inorganic (e.g., minerals) and organic compounds, and other particulates.

As used herein, the term “silane” is used in accordance with its plain ordinary meaning. In embodiments, silane is used as a coupling reagent between two dissimilar materials, which creates critical surface tension.

As used herein, the term “slag” is used in accordance with its plain ordinary meaning and means any type of slag and may be used interchangeably with “ground-granulated blast-furnace slag.” Ground-granulated blast-furnace slag (“GGBFS”) refers to a composition obtained by quenching molten iron slag (a by-product of iron and steel-making) from a blast furnace in water or steam, to produce a glassy, granular product that is then dried and ground into a fine powder. In embodiments, slag includes any by-product following the separation (e.g., via smelting) of a metal from its raw ore that has cementitious components and/or characteristics. In embodiments, slag includes, but is not limited to, arc furnace slag, foundry furnace slag, induction furnace slag, and the like. In general, furnace slag is a non-metallic by-product comprising silicates, calcium-alumina-silicates. Slag may include slag from any metal, for example and without limitation steel, iron, copper, nickel, lead, aluminum, and zinc. Without being bound to any one theory, the slags contemplated herein relate to the use as a binder, which provides hydraulicity. The hydraulicity in turn may modulate the compression strength of the material. As contemplated herein, the use of ground-granulated blast-furnace slag reduces iron waste disposal in landfills. In some embodiments, the slag satisfies the ASTM requirements.

As used herein, the term “slurry” is used in accordance with its plain ordinary meaning and refers to a mixture of denser solids suspended in liquid. In embodiments, “brine slurry” refers to desalinated water waste product.

As used herein, the term “structural component” refers to any vertical or horizontal load-bearing member of a structure which supports dead or live loads in addition to its own weight and includes, but is not limited to, a foundation, an exterior or interior load-bearing wall, a column, a column beam, a floor, and a roof structure.

As used herein, the term “mold” refers to any container or form used to give shape to the material. In embodiments, a mold includes a well.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination. All combinations of the embodiments are specifically embraced by the present invention and are disclosed herein just as if each and every combination was individually and explicitly disclosed. In addition, all sub-combinations are also specifically embraced by the present invention and are disclosed herein just as if each and every such sub-combination was individually and explicitly disclosed herein.

Any composition or method disclosed herein is applicable to any herein-disclosed composition or method. In other words, any aspect or embodiment described herein can be combined with any other aspect or embodiment as disclosed herein.

### EXAMPLES

### Example 1

In this example, a method for manufacturing a pourable cementitious mixture and a reduced salinity water component is described.

The method includes steps of: (a) combining (i) a high salinity brine, (ii) CO₂, and (iii) a pozzolan and/or a latently hydraulic material; and (b) permitting the combination obtained in step (a) to persist under conditions sufficient to transform the combination into a pourable cementitious mixture and a reduced salinity water component.

The conditions sufficient to transform the combination into a pourable cementitious mixture and a reduced salinity water component in step (b) comprise time and applied pressure.

The high salinity brine, CO₂, and pozzolan and/or a latently hydraulic material are combined simultaneously or are combined sequentially and in any order.

The high salinity brine may be obtained from a desalination facility, is natural seawater, or an industrial brine.

A benefit of the present method is that the reduced salinity water component can be added to a natural or artificial body of water. The reduced salinity water component does less harm to flora and/or fauna present in the natural or artificial body of water relative to the harm that would be caused when the high salinity brine is added to a natural or artificial body of water. Without wising to be bound by theory, the reduced salinity water comprises less sulphates and chlorides than high salinity brine, which also are harmful to flora and/or fauna present in the natural or artificial body of water.

In some cases, the reduced salinity water component is returned to the desalination plant for a further round of desalination into fresh water.

In some embodiments, the reduced salinity water component is further processed to extract sodium to produce additional fresh water. In addition to or in combination with or after the above-described processes, a chloralkali process can more efficiently be performed, since, at least in part, because the sulphates and chlorides have already been removed. The extracted sodium may be isolated into a pure sodium product.

The salt concentration of the high salinity brine is greater than or about equal to the salt concentration of seawater, whereas the salt concentration of the reduced salinity water component is less than or about equal to the salt concentration of seawater. Notably, the salt concentration of the reduced salinity water component is less than the high salinity brine. In various cases, the high salinity brine comprises water with a salt concentration (e.g., chloride, sulphate, and sodium) higher than 50 parts per thousand.

Steps (a) and/or (b) occurs in a location within the desalination facility, adjacent to the desalination facility, or downstream from the desalination facility. These steps can occur in a pipeline, a tank, or basin. When step (b) occurs in a pipeline, pressure applied to the pipeline utilizing a series of pipe reducers, which are mechanical devices used to reduce the diameter of a pipe, which creates pressure by restricting the flow of a fluid. In other cases, the pressure in step (b) is applied using another method which creates pressure sufficient to make the conversion process (e.g., chemical reactions) more efficient. In numerous cases, the applied pressure further reduces the amount of energy required and/or waste CO₂ produced.

The pozzolan combined in step (a) comprises silica (SiO₂), alumina (Al₂O₃), and/or iron oxide (Fe₂O₃). The pozzolan may be a natural pozzolan or a man-made pozzolan. The pozzolan comprises or is obtained from one or more of volcanic rock (e.g., rhyolite, obsidian, pitchstone, pumice, basalt or trap, or andesite); volcanic ash; sedimentary clays or shales' calcined clays; rice husk ash; diatomaceous earth; metakaolin; and olivine.

The CO₂ of step (a) is from industrial waste, from environmental sources, or from molecular capture. In some cases, the industrial waste relates to alcoholic fermentation or the burning of fossil fuels. The CO₂ of step (a) is provided in gaseous, solid, and/or as a supercritical fluid form or as a dissolved gas.

In some cases, step (a) further comprises an activator; the activator may be any sodium, lithium or potassium salt or hydroxide and any alkali or alkali earth metal ions and including one or more of Mg(OH)₂, MgO, Ca(OH)₂, CaCO₃, Al₂(SO₄)₃, and CaO.

Step (b) produces exothermic heat and this exothermic heat is transformable from thermal energy into electrical energy.

The pressure in step (b) is from about ambient (1 bar) to about 250 bar, e.g., from about 100 bar to about 250 bar or from about ambient (1 bar) to about 100 bar, and any range or value therebetween. The pressure in step (b) may be greater than about 250 bar. For example, the pressure in step (b) is greater than, 250 bar, 500 bar, 750 bar, 1000 bar, 1250 bar, 1500 bar, 1750 bar, 2000 bar, 2250 bar, 2500 bar, 2750 bar, 3000 bar, 3250 bar, 3500 bar, 3750 bar, 4000 bar, 4250 bar, 4500 bar, 4750 bar, 5000 bar and any range or value therebetween. The temperature of step (a) and/or step (b) is from about 1° C. to about 100° C., and any range or value therebetween. The duration of step (b) is from about 1 minute to about 10 hours, and any range or value therebetween.

The ratio (weight to weight or weight to volume or volume to volume) of the high salinity brine to pozzolan and/or a latently hydraulic material varies from 1:100 to 100:1, and any range or value therebetween. As examples the ratio is about 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, 1:21, 1:22, 1:23, 1:24, 1:25, 1:26, 1:27, 1:28, 1:29, 1:30, 1:31, 1:32, 1:33, 1:34, 1:35, 1:36, 1:37, 1:38, 1:39, 1:40, 1:41, 1:42, 1:43, 1:44, 1:45, 1:46, 1:47, 1:48, 1:49, 1:50, 1:51, 1:52, 1:53, 1:54, 1:55, 1:56, 1:57, 1:58, 1:59, 1:60, 1:61, 1:62, 1:63, 1:64, 1:65, 1:66, 1:67, 1:68, 1:69, 1:70, 1:71, 1:72, 1:73, 1:74, 1:75, 1:76, 1:77, 1:78, 1:79, 1:80, 1:81, 1:82, 1:83, 1:84, 1:85, 1:86, 1:87, 1:88, 1:89, 1:90, 1:91, 1:92, 1:93, 1:94, 1:95, 1:96, 1:97, 1:98, 1:99, 1:100, 100:1, 99:1, 98:1, 97:1, 96:1, 95:1, 94:1, 93:1, 92:1, 91:1, 90:1, 89:1, 88:1, 87:1, 86:1, 85:1, 84:1, 83:1, 82:1, 81:1, 80:1, 79:1, 78:1, 77:1, 76:1, 75:1, 74:1, 73:1, 72:1, 71:1, 70:1, 69:1, 68:1, 67:1, 66:1, 65:1, 64:1, 63:1, 62:1, 61:1, 60:1, 59:1, 58:1, 57:1, 56:1, 55:1, 54:1, 53:1, 52:1, 51:1, 50:1, 49:1, 48:1, 47:1, 46:1, 45:1, 44:1, 43:1, 42:1, 41:1, 40:1, 39:1, 38:1, 37:1, 36:1, 35:1, 34:1, 33:1, 32:1, 31:1, 30:1, 29:1, 28:1, 27:1, 26:1, 25:1, 24:1, 23:1, 22:1, 21:1, 20:1, 19:1, 18:1, 17:1, 16:1, 15:1, 14:1, 13:1, 12:1, 11:1, 10:1, 9:1, 8:1, 7:1, 6:1, 5:1, 4:1, 3:1, 2:1, or about 1:1 and any range or value therebetween.

The ratio (weight to weight or weight to volume or volume to volume) of the high salinity brine to CO₂ varies from 1:100 to 100:1, and any range or value therebetween. As examples the ratio is about 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, 1:21, 1:22, 1:23, 1:24, 1:25, 1:26, 1:27, 1:28, 1:29, 1:30, 1:31, 1:32, 1:33, 1:34, 1:35, 1:36, 1:37, 1:38, 1:39, 1:40, 1:41, 1:42, 1:43, 1:44, 1:45, 1:46, 1:47, 1:48, 1:49, 1:50, 1:51, 1:52, 1:53, 1:54, 1:55, 1:56, 1:57, 1:58, 1:59, 1:60, 1:61, 1:62, 1:63, 1:64, 1:65, 1:66, 1:67, 1:68, 1:69, 1:70, 1:71, 1:72, 1:73, 1:74, 1:75, 1:76, 1:77, 1:78, 1:79, 1:80, 1:81, 1:82, 1:83, 1:84, 1:85, 1:86, 1:87, 1:88, 1:89, 1:90, 1:91, 1:92, 1:93, 1:94, 1:95, 1:96, 1:97, 1:98, 1:99, 1:100, 100:1, 99:1, 98:1, 97:1, 96:1, 95:1, 94:1, 93:1, 92:1, 91:1, 90:1, 89:1, 88:1, 87:1, 86:1, 85:1, 84:1, 83:1, 82:1, 81:1, 80:1, 79:1, 78:1, 77:1, 76:1, 75:1, 74:1, 73:1, 72:1, 71:1, 70:1, 69:1, 68:1, 67:1, 66:1, 65:1, 64:1, 63:1, 62:1, 61:1, 60:1, 59:1, 58:1, 57:1, 56:1, 55:1, 54:1, 53:1, 52:1, 51:1, 50:1, 49:1, 48:1, 47:1, 46:1, 45:1, 44:1, 43:1, 42:1, 41:1, 40:1, 39:1, 38:1, 37:1, 36:1, 35:1, 34:1, 33:1, 32:1, 31:1, 30:1, 29:1, 28:1, 27:1, 26:1, 25:1, 24:1, 23:1, 22:1, 21:1, 20:1, 19:1, 18:1, 17:1, 16:1, 15:1, 14:1, 13:1, 12:1, 11:1, 10:1, 9:1, 8:1, 7:1, 6:1, 5:1, 4:1, 3:1, 2:1, or about 1:1 and any range or value therebetween.

The ratio (weight to weight or weight to volume or volume to volume) of the pozzolan and/or a latently hydraulic material to CO₂ varies from 1:100 to 100:1, and any range or value therebetween. As examples the ratio is about 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, 1:21, 1:22, 1:23, 1:24, 1:25, 1:26, 1:27, 1:28, 1:29, 1:30, 1:31, 1:32, 1:33, 1:34, 1:35, 1:36, 1:37, 1:38, 1:39, 1:40, 1:41, 1:42, 1:43, 1:44, 1:45, 1:46, 1:47, 1:48, 1:49, 1:50, 1:51, 1:52, 1:53, 1:54, 1:55, 1:56, 1:57, 1:58, 1:59, 1:60, 1:61, 1:62, 1:63, 1:64, 1:65, 1:66, 1:67, 1:68, 1:69, 1:70, 1:71, 1:72, 1:73, 1:74, 1:75, 1:76, 1:77, 1:78, 1:79, 1:80, 1:81, 1:82, 1:83, 1:84, 1:85, 1:86, 1:87, 1:88, 1:89, 1:90, 1:91, 1:92, 1:93, 1:94, 1:95, 1:96, 1:97, 1:98, 1:99, 1:100, 100:1, 99:1, 98:1, 97:1, 96:1, 95:1, 94:1, 93:1, 92:1, 91:1, 90:1, 89:1, 88:1, 87:1, 86:1, 85:1, 84:1, 83:1, 82:1, 81:1, 80:1, 79:1, 78:1, 77:1, 76:1, 75:1, 74:1, 73:1, 72:1, 71:1, 70:1, 69:1, 68:1, 67:1, 66:1, 65:1, 64:1, 63:1, 62:1, 61:1, 60:1, 59:1, 58:1, 57:1, 56:1, 55:1, 54:1, 53:1, 52:1, 51:1, 50:1, 49:1, 48:1, 47:1, 46:1, 45:1, 44:1, 43:1, 42:1, 41:1, 40:1, 39:1, 38:1, 37:1, 36:1, 35:1, 34:1, 33:1, 32:1, 31:1, 30:1, 29:1, 28:1, 27:1, 26:1, 25:1, 24:1, 23:1, 22:1, 21:1, 20:1, 19:1, 18:1, 17:1, 16:1, 15:1, 14:1, 13:1, 12:1, 11:1, 10:1, 9:1, 8:1, 7:1, 6:1, 5:1, 4:1, 3:1, 2:1, or about 1:1 and any range or value therebetween.

In some cases, an aggregate is added to the combination of step (a). The aggregate may comprise sand, gravel, lightweight aggregate, or crushed stone, and a combination thereof.

In various cases, the latently hydraulic material is a slag. The slag may be added in step (a) in addition to the added pozzolan or the slag is added in step (a) instead of pozzolan. The slag may be added in step (a) instead of an activator.

At least one filler material or other additive, may be added to the pourable cementitious mixture. Examples of a filler or another additive: pumice or other volcanic rock or material, sand, gravel, crushed stone, aggregate (e.g., fine aggregate, coarse aggregate, intermediate aggregate, other types of aggregate, etc.), lightweight aggregate, talc, other clay material, fibers (e.g., steel and/or other metallic fibers, polypropylene and/or other polymeric fibers, glass fibers, asbestos fibers, carbon fibers, organic fibers, etc.), glass fiber reinforced plastic (GFRP), other reinforced polymers, admixtures or other additives that facilitate with fire protection, water protection, corrosion resistance/inhibition, workability, and/or one more other properties of the final cured product (e.g., MasterPel, RheoCell, MasterCell, etc.), sodium naphthalene sulfonate formaldehyde (SNF) and/or other surfactants, plasticizers, pigments, dyes and other color additives, titanium dioxide, other minerals, other natural or synthetic materials, other filler materials and/or the like.

The method may further comprise isolating the pourable cementitious mixture from the reduced salinity water component or other liquid components. The isolating may comprise straining to capture the pourable cementitious mixture.

When forming a pourable cementitious mixture, the CO₂ is chemically reacted to form a crystalline form of carbon and this crystalline form is absorbed into the pourable cementitious mixture.

The pourable cementitious mixture formed by the above-described method will have features as disclosed elsewhere herein, e.g., particle size, pore size, pore number, and so forth.

### Example 2

In this example, another method for manufacturing a pourable cementitious mixture and a reduced salinity water component is described, here, using an in-line conversion method.

The includes steps of: (a) combining (i) a high salinity brine, (ii) CO₂, and (iii) a natural pozzolan, a man-made pozzolan, and/or a latently hydraulic material; and, optionally, an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO) and (b) permitting the combination obtained in step (a) to persist under conditions sufficient to transform the combination into a pourable cementitious mixture and a reduced salinity water component, wherein the conditions in step (b) preferably comprises applied pressure and wherein steps (a) and/or (b) occur in a pipeline.

The high salinity brine, CO₂, and pozzolan and/or a latently hydraulic material are combined simultaneously or are combined sequentially and in any order.

The high salinity brine may be obtained from a desalination facility, is natural seawater, or an industrial brine.

A benefit of the present method is that the reduced salinity water component can be added to a natural or artificial body of water. The reduced salinity water component does less harm to flora and/or fauna present in the natural or artificial body of water relative to the harm that would be caused when the high salinity brine is added to a natural or artificial body of water. Without wising to be bound by theory, the reduced salinity water comprises less sulphates and chlorides than high salinity brine, which also are harmful to flora and/or fauna present in the natural or artificial body of water.

In some cases, the reduced salinity water component is returned to the desalination plant for a further round of desalination into fresh water.

In some embodiments, the reduced salinity water component is further processed to extract sodium to produce additional fresh water. In addition to or in combination with or after the above-described processes, a chloralkali process can more efficiently be performed, since, at least in part, because the sulphates and chlorides have already been removed. The extracted sodium may be isolated into a pure sodium product.

The salt concentration of the high salinity brine is greater than or about equal to the salt concentration of seawater, whereas the salt concentration of the reduced salinity water component is less than or about equal to the salt concentration of seawater. Notably, the salt concentration of the reduced salinity water component is less than the high salinity brine. In various cases, the high salinity brine comprises water with a salt concentration (e.g., chloride, sulphate, and sodium) higher than 50 parts per thousand.

Steps (a) and/or (b) occurs in a location within the desalination facility, adjacent to the desalination facility, or downstream from the desalination facility. These steps can occur in a pipeline. When step (b) occurs in a pipeline, pressure applied to the pipeline utilizing a series of pipe reducers, which are mechanical devices used to reduce the diameter of a pipe, which creates pressure by restricting the flow of a fluid. In other cases, the pressure in step (b) is applied using another method which creates pressure sufficient to make the conversion process (e.g., chemical reactions) more efficient. In numerous cases, the applied pressure further reduces the amount of energy required and/or waste CO₂ produced.

The pozzolan combined in step (a) comprises silica (SiO₂), alumina (Al₂O₃), and/or iron oxide (Fe₂O₃). The pozzolan may be a natural pozzolan or a man-made pozzolan. The pozzolan comprises or is obtained from one or more of volcanic rock (e.g., rhyolite, obsidian, pitchstone, pumice, basalt or trap, or andesite); volcanic ash; sedimentary clays or shales' calcined clays; rice husk ash; diatomaceous earth; metakaolin; and olivine.

The CO₂ of step (a) is from industrial waste, from environmental sources, or from molecular capture. In some cases, the industrial waste relates to alcoholic fermentation or the burning of fossil fuels. The CO₂ of step (a) is provided in gaseous, solid, and/or as a supercritical fluid form or as a dissolved gas.

In some cases, step (a) further comprises an activator; the activator may be any sodium, lithium or potassium salt or hydroxide and any alkali or alkali earth metal ions and including one or more of Mg(OH)₂, MgO, Ca(OH)₂, CaCO₃, Al₂(SO₄)₃, and CaO.

Step (b) produces exothermic heat and this exothermic heat is transformable from thermal energy into electrical energy.

The pressure in step (b) is from about ambient (1 bar) to about 250 bar, e.g., from about 100 bar to about 250 bar or from about ambient (1 bar) to about 100 bar, and any range or value therebetween. The pressure in step (b) may be greater than about 250 bar. For example, the pressure in step (b) is greater than, 250 bar, 500 bar, 750 bar, 1000 bar, 1250 bar, 1500 bar, 1750 bar, 2000 bar, 2250 bar, 2500 bar, 2750 bar, 3000 bar, 3250 bar, 3500 bar, 3750 bar, 4000 bar, 4250 bar, 4500 bar, 4750 bar, 5000 bar and any range or value therebetween. The temperature of step (a) and/or step (b) is from about 1° C. to about 100° C., and any range or value therebetween. The duration of step (b) is from about 1 minute to about 10 hours, and any range or value therebetween.

The ratio (weight to weight or weight to volume or volume to volume) of the high salinity brine to pozzolan and/or a latently hydraulic material varies from 1:100 to 100:1, and any range or value therebetween. The ratio (weight to weight or weight to volume or volume to volume) of the high salinity brine to CO₂ varies from 1:100 to 100:1, and any range or value therebetween. The ratio (weight to weight or weight to volume or volume to volume) of the pozzolan and/or a latently hydraulic material to CO₂ varies from 1:100 to 100:1, and any range or value therebetween.

In some cases, an aggregate is added to the combination of step (a). The aggregate may comprise sand, gravel, lightweight aggregate, or crushed stone, and a combination thereof.

In various cases, the latently hydraulic material is a slag. The slag may be added in step (a) in addition to the added pozzolan or the slag is added in step (a) instead of pozzolan. The slag may be added in step (a) instead of an activator.

At least one filler material or other additive, may be added to the pourable cementitious mixture. Examples of a filler or another additive: pumice or other volcanic rock or material, sand, gravel, crushed stone, aggregate (e.g., fine aggregate, coarse aggregate, intermediate aggregate, other types of aggregate, etc.), lightweight aggregate, talc, other clay material, fibers (e.g., steel and/or other metallic fibers, polypropylene and/or other polymeric fibers, glass fibers, asbestos fibers, carbon fibers, organic fibers, etc.), glass fiber reinforced plastic (GFRP), other reinforced polymers, admixtures or other additives that facilitate with fire protection, water protection, corrosion resistance/inhibition, workability, and/or one more other properties of the final cured product (e.g., MasterPel, RheoCell, MasterCell, etc.), sodium naphthalene sulfonate formaldehyde (SNF) and/or other surfactants, plasticizers, pigments, dyes and other color additives, titanium dioxide, other minerals, other natural or synthetic materials, other filler materials and/or the like.

The method may further comprise isolating the pourable cementitious mixture from the reduced salinity water component or other liquid components. The isolating may comprise straining to capture the pourable cementitious mixture.

When forming pourable cementitious mixture, the CO₂ is chemically reacted to form a crystalline form of carbon and this crystalline form is absorbed into the pourable cementitious mixture.

The pourable cementitious mixture formed by the above-described method will have features as disclosed elsewhere herein, e.g., particle size, pore size, pore number, and so forth.

### Example 3

In this example, a further method for manufacturing a pourable cementitious mixture and a reduced salinity water component is described, here, using an in-line conversion method.

The method includes steps of: (a) combining (i) a high salinity brine, (ii) CO₂, and (iii) a pozzolan and/or a latently hydraulic material; and (b) applying pressure to the combination obtained in step (a) for an amount and duration sufficient to transform the combination into a pourable cementitious mixture and a reduced salinity water component, wherein the conditions in step (b) comprise applied pressure and wherein steps (a) and/or (b) occur in a pipeline.

The high salinity brine, CO₂, and pozzolan and/or a latently hydraulic material are combined simultaneously or are combined sequentially and in any order.

The high salinity brine may be obtained from a desalination facility, is natural seawater, or an industrial brine.

A benefit of the present method is that the reduced salinity water component can be added to a natural or artificial body of water. The reduced salinity water component does less harm to flora and/or fauna present in the natural or artificial body of water relative to the harm that would be caused when the high salinity brine is added to a natural or artificial body of water. Without wising to be bound by theory, the reduced salinity water comprises less sulphates and chlorides than high salinity brine, which also are harmful to flora and/or fauna present in the natural or artificial body of water.

In some cases, the reduced salinity water component is returned to the desalination plant for a further round of desalination into fresh water.

In some embodiments, the reduced salinity water component is further processed to extract sodium, sulphates, and/or chlorides and produces additional fresh water. The extracted sodium may be isolated into a pure sodium product. The extraction of sodium from the reduced salinity water component is more efficient since the sodium and chloride have substantially already been removed.

The salt concentration of the high salinity brine is greater than or about equal to the salt concentration of seawater, whereas the salt concentration of the reduced salinity water component is less than or about equal to the salt concentration of seawater. Notably, the salt concentration of the reduced salinity water component is less than the high salinity brine. In various cases, the high salinity brine comprises water with a salt concentration (e.g., chloride, sulphate, and sodium) higher than 50 parts per thousand.

Steps (a) and/or (b) occurs in a location within the desalination facility, adjacent to the desalination facility, or downstream from the desalination facility. These steps can occur in a pipeline. When step (b) occurs in a pipeline, pressure applied to the pipeline utilizing a series of pipe reducers, which are mechanical devices used to reduce the diameter of a pipe, which creates pressure by restricting the flow of a fluid. In other cases, the pressure in step (b) is applied using another method which creates pressure sufficient to make the conversion process (e.g., chemical reactions) more efficient. In numerous cases, the applied pressure further reduces the amount of energy required and/or waste CO₂ produced.

The pozzolan combined in step (a) comprises silica (SiO₂), alumina (Al₂O₃), and/or iron oxide (Fe₂O₃). The pozzolan may be a natural pozzolan or a man-made pozzolan. The pozzolan comprises or is obtained from one or more of volcanic rock (e.g., rhyolite, obsidian, pitchstone, pumice, basalt or trap, or andesite); volcanic ash; sedimentary clays or shales' calcined clays; rice husk ash; diatomaceous earth; metakaolin; and olivine.

The CO₂ of step (a) is from industrial waste, from environmental sources, or from molecular capture. In some cases, the industrial waste relates to alcoholic fermentation or the burning of fossil fuels. The CO₂ of step (a) is provided in gaseous, solid, and/or as a supercritical fluid form or as a dissolved gas.

Step (b) produces exothermic heat and this exothermic heat is transformable from thermal energy into electrical energy.

The pressure in step (b) is from about ambient (1 bar) to about 250 bar, e.g., from about 100 bar to about 250 bar or from about ambient (1 bar) to about 100 bar, and any range or value therebetween. The pressure in step (b) may be greater than about 250 bar. For example, the pressure in step (b) is greater than, 250 bar, 500 bar, 750 bar, 1000 bar, 1250 bar, 1500 bar, 1750 bar, 2000 bar, 2250 bar, 2500 bar, 2750 bar, 3000 bar, 3250 bar, 3500 bar, 3750 bar, 4000 bar, 4250 bar, 4500 bar, 4750 bar, 5000 bar and any range or value therebetween. The temperature of step (a) and/or step (b) is from about 1° C. to about 100° C., and any range or value therebetween. The duration of step (b) is from about 1 minute to about 10 hours, and any range or value therebetween.

The ratio (weight to weight or weight to volume or volume to volume) of the high salinity brine to pozzolan and/or a latently hydraulic material varies from 1:100 to 100:1, and any range or value therebetween. The ratio (weight to weight or weight to volume or volume to volume) of the high salinity brine to CO₂ varies from 1:100 to 100:1, and any range or value therebetween. The ratio (weight to weight or weight to volume or volume to volume) of the pozzolan and/or a latently hydraulic material to CO₂ varies from 1:100 to 100:1, and any range or value therebetween.

In some cases, an aggregate is added to the combination of step (a). The aggregate may comprise sand, gravel, lightweight aggregate, or crushed stone, and a combination thereof.

In various cases, the latently hydraulic material is a slag. The slag may be added in step (a) in addition to the added pozzolan or the slag is added in step (a) instead of pozzolan.

At least one filler material or other additive, may be added to the pourable cementitious mixture. Examples of a filler or another additive: pumice or other volcanic rock or material, sand, gravel, crushed stone, aggregate (e.g., fine aggregate, coarse aggregate, intermediate aggregate, other types of aggregate, etc.), lightweight aggregate, talc, other clay material, fibers (e.g., steel and/or other metallic fibers, polypropylene and/or other polymeric fibers, glass fibers, asbestos fibers, carbon fibers, organic fibers, etc.), glass fiber reinforced plastic (GFRP), other reinforced polymers, admixtures or other additives that facilitate with fire protection, water protection, corrosion resistance/inhibition, workability, and/or one more other properties of the final cured product (e.g., MasterPel, RheoCell, MasterCell, etc.), sodium naphthalene sulfonate formaldehyde (SNF) and/or other surfactants, plasticizers, pigments, dyes and other color additives, titanium dioxide, other minerals, other natural or synthetic materials, other filler materials and/or the like.

The method may further comprise isolating the pourable cementitious mixture from the reduced salinity water component or other liquid components. The isolating may comprise straining to capture the pourable cementitious mixture.

When forming pourable cementitious mixture, the CO₂ is chemically reacted to form a crystalline form of carbon and this crystalline form is absorbed into the pourable cementitious mixture.

The pourable cementitious mixture formed by the above-described method will have features as disclosed elsewhere herein, e.g., particle size, pore size, pore number, and so forth.

### Example 4

In this example, a further method for manufacturing a pourable cementitious mixture and a reduced salinity water component is described, here, using an in-line conversion method.

An additional aspect of the present disclosure is an in-line conversion method comprising steps of: (a) combining (i) a high salinity brine, (ii) CO₂, and (iii) a pozzolan and/or a latently hydraulic material; (b) allowing the combination obtained in step (a) to persist for duration sufficient to transform the combination into a pourable cementitious mixture and a reduced salinity water component, wherein steps (a) and/or (b) occur in a pipeline.

The conditions sufficient to transform the combination into a pourable cementitious mixture and a reduced salinity water component in step (b) comprise time and applied pressure.

The high salinity brine, CO₂, and pozzolan and/or a latently hydraulic material are combined simultaneously or are combined sequentially and in any order.

The high salinity brine may be obtained from a desalination facility, is natural seawater, or an industrial brine.

A benefit of the present method is that the reduced salinity water component can be added to a natural or artificial body of water. The reduced salinity water component does less harm to flora and/or fauna present in the natural or artificial body of water relative to the harm that would be caused when the high salinity brine is added to a natural or artificial body of water. Without wising to be bound by theory, the reduced salinity water comprises less sulphates and chlorides than high salinity brine, which also are harmful to flora and/or fauna present in the natural or artificial body of water.

In some cases, the reduced salinity water component is returned to the desalination plant for a further round of desalination into fresh water.

In some embodiments, the reduced salinity water component is further processed to extract sodium to produce additional fresh water. In addition to or in combination with or after the above-described processes, a chloralkali process can more efficiently be performed, since, at least in part, because the sulphates and chlorides have already been removed. The extracted sodium may be isolated into a pure sodium product.

The salt concentration of the high salinity brine is greater than or about equal to the salt concentration of seawater, whereas the salt concentration of the reduced salinity water component is less than or about equal to the salt concentration of seawater. Notably, the salt concentration of the reduced salinity water component is less than the high salinity brine. In various cases, the high salinity brine comprises water with a salt concentration (e.g., chloride, sulphate, and sodium) higher than 50 parts per thousand.

Steps (a) and/or (b) occurs in a location within the desalination facility, adjacent to the desalination facility, or downstream from the desalination facility. These steps can occur in a pipeline. When step (b) occurs in a pipeline, pressure applied to the pipeline utilizing a series of pipe reducers, which are mechanical devices used to reduce the diameter of a pipe, which creates pressure by restricting the flow of a fluid. In other cases, the pressure in step (b) is applied using another method which creates pressure sufficient to make the conversion process (e.g., chemical reactions) more efficient. In numerous cases, the applied pressure further reduces the amount of energy required and/or waste CO₂ produced.

The pozzolan combined in step (a) comprises silica (SiO₂), alumina (Al₂O₃), and/or iron oxide (Fe₂O₃). The pozzolan may be a natural pozzolan or a man-made pozzolan. The pozzolan comprises or is obtained from one or more of volcanic rock (e.g., rhyolite, obsidian, pitchstone, pumice, basalt or trap, or andesite); volcanic ash; sedimentary clays or shales' calcined clays; rice husk ash; diatomaceous earth; metakaolin; and olivine.

The CO₂ of step (a) is from industrial waste, from environmental sources, or from molecular capture. In some cases, the industrial waste relates to alcoholic fermentation or the burning of fossil fuels. The CO₂ of step (a) is provided in gaseous, solid, and/or as a supercritical fluid form or as a dissolved gas.

Step (b) produces exothermic heat and this exothermic heat is transformable from thermal energy into electrical energy.

The pressure in step (b) is from about ambient (1 bar) to about 250 bar, e.g., from about 100 bar to about 250 bar or from about ambient (1 bar) to about 100 bar, and any range or value therebetween. The pressure in step (b) may be greater than about 250 bar. For example, the pressure in step (b) is greater than, 250 bar, 500 bar, 750 bar, 1000 bar, 1250 bar, 1500 bar, 1750 bar, 2000 bar, 2250 bar, 2500 bar, 2750 bar, 3000 bar, 3250 bar, 3500 bar, 3750 bar, 4000 bar, 4250 bar, 4500 bar, 4750 bar, 5000 bar and any range or value therebetween. The temperature of step (a) and/or step (b) is from about 1° C. to about 100° C., and any range or value therebetween. The duration of step (b) is from about 1 minute to about 10 hours, and any range or value therebetween.

The ratio (weight to weight or weight to volume or volume to volume) of the high salinity brine to pozzolan and/or a latently hydraulic material varies from 1:100 to 100:1, and any range or value therebetween. The ratio (weight to weight or weight to volume or volume to volume) of the high salinity brine to CO₂ varies from 1:100 to 100:1, and any range or value therebetween. The ratio (weight to weight or weight to volume or volume to volume) of the pozzolan and/or a latently hydraulic material to CO₂ varies from 1:100 to 100:1, and any range or value therebetween.

In some cases, an aggregate is added to the combination of step (a). The aggregate may comprise sand, gravel, lightweight aggregate, or crushed stone, and a combination thereof.

In various cases, the latently hydraulic material is a slag. The slag may be added in step (a) in addition to the added pozzolan or the slag is added in step (a) instead of pozzolan. The slag may be added in step (a) instead of an activator.

At least one filler material or other additive, may be added to the pourable cementitious mixture. Examples of a filler or another additive: pumice or other volcanic rock or material, sand, gravel, crushed stone, aggregate (e.g., fine aggregate, coarse aggregate, intermediate aggregate, other types of aggregate, etc.), lightweight aggregate, talc, other clay material, fibers (e.g., steel and/or other metallic fibers, polypropylene and/or other polymeric fibers, glass fibers, asbestos fibers, carbon fibers, organic fibers, etc.), glass fiber reinforced plastic (GFRP), other reinforced polymers, admixtures or other additives that facilitate with fire protection, water protection, corrosion resistance/inhibition, workability, and/or one more other properties of the final cured product (e.g., MasterPel, RheoCell, MasterCell, etc.), sodium naphthalene sulfonate formaldehyde (SNF) and/or other surfactants, plasticizers, pigments, dyes and other color additives, titanium dioxide, other minerals, other natural or synthetic materials, other filler materials and/or the like.

The method may further comprise isolating the pourable cementitious mixture from the reduced salinity water component or other liquid components. The isolating may comprise straining to capture the pourable cementitious mixture.

When forming pourable cementitious mixture, the CO₂ is chemically reacted to form a crystalline form of carbon and this crystalline form is absorbed into the pourable cementitious mixture.

The pourable cementitious mixture formed by the above-described method will have features as disclosed elsewhere herein, e.g., particle size, pore size, pore number, and so forth.

### Example 5

In this example, yet another method for manufacturing a pourable cementitious mixture and a reduced salinity water component is described, here, using an in-line conversion method.

The method includes steps of: (a) combining (i) a high salinity brine, (ii) CO₂, (iii) a pozzolan and/or a latently hydraulic material, and (iv) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO); and (b) applying pressure to the combination obtained in step (a) for an amount and duration sufficient to transform the combination into a pourable cementitious mixture and a reduced salinity water component, wherein the conditions in step (b) comprise applied pressure and wherein steps (a) and/or (b) occur in a pipeline.

The high salinity brine, CO₂, and pozzolan and/or a latently hydraulic material are combined simultaneously or are combined sequentially and in any order.

The high salinity brine may be obtained from a desalination facility, is natural seawater, or an industrial brine.

A benefit of the present method is that the reduced salinity water component can be added to a natural or artificial body of water. The reduced salinity water component does less harm to flora and/or fauna present in the natural or artificial body of water relative to the harm that would be caused when the high salinity brine is added to a natural or artificial body of water. Without wising to be bound by theory, the reduced salinity water comprises less sulphates and chlorides than high salinity brine, which also are harmful to flora and/or fauna present in the natural or artificial body of water.

In some cases, the reduced salinity water component is returned to the desalination plant for a further round of desalination into fresh water.

In some embodiments, the reduced salinity water component is further processed to extract sodium to produce additional fresh water. In addition to or in combination with or after the above-described processes, a chloralkali process can more efficiently be performed, since, at least in part, because the sulphates and chlorides have already been removed. The extracted sodium may be isolated into a pure sodium product.

The salt concentration of the high salinity brine is greater than or about equal to the salt concentration of seawater, whereas the salt concentration of the reduced salinity water component is less than or about equal to the salt concentration of seawater. Notably, the salt concentration of the reduced salinity water component is less than the high salinity brine. In various cases, the high salinity brine comprises water with a salt concentration (e.g., chloride, sulphate, and sodium) higher than 50 parts per thousand.

Steps (a) and/or (b) occurs in a location within the desalination facility, adjacent to the desalination facility, or downstream from the desalination facility. These steps can occur in a pipeline. When step (b) occurs in a pipeline, pressure applied to the pipeline utilizing a series of pipe reducers, which are mechanical devices used to reduce the diameter of a pipe, which creates pressure by restricting the flow of a fluid. In other cases, the pressure in step (b) is applied using another method which creates pressure sufficient to make the conversion process (e.g., chemical reactions) more efficient. In numerous cases, the applied pressure further reduces the amount of energy required and/or waste CO₂ produced.

The pozzolan combined in step (a) comprises silica (SiO₂), alumina (Al₂O₃), and/or iron oxide (Fe₂O₃). The pozzolan may be a natural pozzolan or a man-made pozzolan. The pozzolan comprises or is obtained from one or more of volcanic rock (e.g., rhyolite, obsidian, pitchstone, pumice, basalt or trap, or andesite); volcanic ash; sedimentary clays or shales' calcined clays; rice husk ash; diatomaceous earth; metakaolin; and olivine.

The CO₂ of step (a) is from industrial waste, from environmental sources, or from molecular capture. In some cases, the industrial waste relates to alcoholic fermentation or the burning of fossil fuels. The CO₂ of step (a) is provided in gaseous, solid, and/or as a supercritical fluid form or as a dissolved gas.

In some cases, step (a) further comprises an activator; the activator may be any sodium, lithium or potassium salt or hydroxide and any alkali or alkali earth metal ions and including one or more of Mg(OH)₂, MgO, Ca(OH)₂, CaCO₃, Al₂(SO₄)₃, and CaO.

Step (b) produces exothermic heat and this exothermic heat is transformable from thermal energy into electrical energy.

The pressure in step (b) is from about ambient (1 bar) to about 250 bar, e.g., from about 100 bar to about 250 bar or from about ambient (1 bar) to about 100 bar, and any range or value therebetween. The pressure in step (b) may be greater than about 250 bar. For example, the pressure in step (b) is greater than, 250 bar, 500 bar, 750 bar, 1000 bar, 1250 bar, 1500 bar, 1750 bar, 2000 bar, 2250 bar, 2500 bar, 2750 bar, 3000 bar, 3250 bar, 3500 bar, 3750 bar, 4000 bar, 4250 bar, 4500 bar, 4750 bar, 5000 bar and any range or value therebetween. The temperature of step (a) and/or step (b) is from about 1° C. to about 100° C., and any range or value therebetween. The duration of step (b) is from about 1 minute to about 10 hours, and any range or value therebetween.

The ratio (weight to weight or weight to volume or volume to volume) of the high salinity brine to pozzolan and/or a latently hydraulic material varies from 1:100 to 100:1, and any range or value therebetween. The ratio (weight to weight or weight to volume or volume to volume) of the high salinity brine to CO₂ varies from 1:100 to 100:1, and any range or value therebetween. The ratio (weight to weight or weight to volume or volume to volume) of the pozzolan and/or a latently hydraulic material to CO₂ varies from 1:100 to 100:1, and any range or value therebetween.

In some cases, an aggregate is added to the combination of step (a). The aggregate may comprise sand, gravel, lightweight aggregate, or crushed stone, and a combination thereof.

In various cases, the latently hydraulic material is a slag. The slag may be added in step (a) in addition to the added pozzolan or the slag is added in step (a) instead of pozzolan. The slag may be added in step (a) instead of an activator.

At least one filler material or other additive, may be added to the pourable cementitious mixture. Examples of a filler or another additive: pumice or other volcanic rock or material, sand, gravel, crushed stone, aggregate (e.g., fine aggregate, coarse aggregate, intermediate aggregate, other types of aggregate, etc.), lightweight aggregate, talc, other clay material, fibers (e.g., steel and/or other metallic fibers, polypropylene and/or other polymeric fibers, glass fibers, asbestos fibers, carbon fibers, organic fibers, etc.), glass fiber reinforced plastic (GFRP), other reinforced polymers, admixtures or other additives that facilitate with fire protection, water protection, corrosion resistance/inhibition, workability, and/or one more other properties of the final cured product (e.g., MasterPel, RheoCell, MasterCell, etc.), sodium naphthalene sulfonate formaldehyde (SNF) and/or other surfactants, plasticizers, pigments, dyes and other color additives, titanium dioxide, other minerals, other natural or synthetic materials, other filler materials and/or the like.

The method may further comprise isolating the pourable cementitious mixture from the reduced salinity water component or other liquid components. The isolating may comprise straining to capture the pourable cementitious mixture.

When forming pourable cementitious mixture, the CO₂ is chemically reacted to form a crystalline form of carbon and this crystalline form is absorbed into the pourable cementitious mixture.

The pourable cementitious mixture formed by the above-described method will have features as disclosed elsewhere herein, e.g., particle size, pore size, pore number, and so forth.

### Example 6

In this example, yet another method for manufacturing a pourable cementitious mixture and a reduced salinity water component is described, here, using a tank precipitation method.

The method including steps of: (a) combining (i) a high salinity brine, (ii) CO₂, and (iii) a pozzolan and/or a latently hydraulic material; and (b) permitting the combination obtained in step (a) to persist under conditions sufficient to transform the combination into a pourable cementitious mixture and a reduced salinity water component, wherein the conditions in step (b) does not comprise applied pressure and wherein steps (a) and/or (b) occur in a tank or basin.

The conditions sufficient to transform the combination into a cementitious aggregate composition and a reduced salinity water component in step (b) comprise time and heat.

The high salinity brine, CO₂, and pozzolan and/or a latently hydraulic material are combined simultaneously or are combined sequentially and in any order.

The high salinity brine may be obtained from a desalination facility, is natural seawater, or an industrial brine.

A benefit of the present method is that the reduced salinity water component can be added to a natural or artificial body of water. The reduced salinity water component does less harm to flora and/or fauna present in the natural or artificial body of water relative to the harm that would be caused when the high salinity brine is added to a natural or artificial body of water. Without wising to be bound by theory, the reduced salinity water comprises less sulphates and chlorides than high salinity brine, which also are harmful to flora and/or fauna present in the natural or artificial body of water.

In some cases, the reduced salinity water component is returned to the desalination plant for a further round of desalination into fresh water.

In some embodiments, the reduced salinity water component is further processed to extract sodium to produce additional fresh water. In addition to or in combination with or after the above-described processes, a chloralkali process can more efficiently be performed, since, at least in part, because the sulphates and chlorides have already been removed. The extracted sodium may be isolated into a pure sodium product.

The salt concentration of the high salinity brine is greater than or about equal to the salt concentration of seawater, whereas the salt concentration of the reduced salinity water component is less than or about equal to the salt concentration of seawater. Notably, the salt concentration of the reduced salinity water component is less than the high salinity brine. In various cases, the high salinity brine comprises water with a salt concentration (e.g., chloride, sulphate, and sodium) higher than 50 parts per thousand.

Steps (a) and/or (b) occurs in a location within the desalination facility, adjacent to the desalination facility, or downstream from the desalination facility.

The pozzolan combined in step (a) comprises silica (SiO₂), alumina (Al₂O₃), and/or iron oxide (Fe₂O₃). The pozzolan may be a natural pozzolan or a man-made pozzolan. The pozzolan comprises or is obtained from one or more of volcanic rock (e.g., rhyolite, obsidian, pitchstone, pumice, basalt or trap, or andesite); volcanic ash; sedimentary clays or shales' calcined clays; rice husk ash; diatomaceous earth; metakaolin; and olivine.

The CO₂ of step (a) is from industrial waste, from environmental sources, or from molecular capture. In some cases, the industrial waste relates to alcoholic fermentation or the burning of fossil fuels. The CO₂ of step (a) is provided in gaseous, solid, and/or as a supercritical fluid form or as a dissolved gas.

Step (b) produces exothermic heat and this exothermic heat is transformable from thermal energy into electrical energy.

The temperature of step (a) and/or step (b) is from about 1° C. to about 100° C., and any range or value therebetween. The duration of step (b) is from about 1 minute to about 10 hours, and any range or value therebetween.

The ratio (weight to weight or weight to volume or volume to volume) of the high salinity brine to pozzolan and/or a latently hydraulic material varies from 1:100 to 100:1, and any range or value therebetween. The ratio (weight to weight or weight to volume or volume to volume) of the high salinity brine to CO₂ varies from 1:100 to 100:1, and any range or value therebetween. The ratio (weight to weight or weight to volume or volume to volume) of the pozzolan and/or a latently hydraulic material to CO₂ varies from 1:100 to 100:1, and any range or value therebetween.

In some cases, an aggregate is added to the combination of step (a). The aggregate may comprise sand, gravel, lightweight aggregate, or crushed stone, and a combination thereof.

In various cases, the latently hydraulic material is a slag. The slag may be added in step (a) in addition to the added pozzolan or the slag is added in step (a) instead of pozzolan.

At least one filler material or other additive, may be added to the cementitious aggregate composition. Examples of a filler or another additive: pumice or other volcanic rock or material, sand, gravel, crushed stone, aggregate (e.g., fine aggregate, coarse aggregate, intermediate aggregate, other types of aggregate, etc.), lightweight aggregate, talc, other clay material, fibers (e.g., steel and/or other metallic fibers, polypropylene and/or other polymeric fibers, glass fibers, asbestos fibers, carbon fibers, organic fibers, etc.), glass fiber reinforced plastic (GFRP), other reinforced polymers, admixtures or other additives that facilitate with fire protection, water protection, corrosion resistance/inhibition, workability, and/or one more other properties of the final cured product (e.g., MasterPel, RheoCell, MasterCell, etc.), sodium naphthalene sulfonate formaldehyde (SNF) and/or other surfactants, plasticizers, pigments, dyes and other color additives, titanium dioxide, other minerals, other natural or synthetic materials, other filler materials and/or the like.

The method may further comprise isolating the pourable cementitious mixture from the reduced salinity water component or other liquid components. The isolating may comprise straining to capture the pourable cementitious mixture.

When forming pourable cementitious mixture, the CO₂ is chemically reacted to form a crystalline form of carbon and this crystalline form is absorbed into the pourable cementitious mixture.

The pourable cementitious mixture formed by the above-described method will have features as disclosed elsewhere herein, e.g., particle size, pore size, pore number, and so forth.

### Example 7

In this example, yet another method for manufacturing a pourable cementitious mixture and a reduced salinity water component is described, here, using a tank precipitation method.

The method includes steps of: (a) combining (i) a high salinity brine, (ii) CO₂, and (iii) a natural pozzolan, a man-made pozzolan, and/or a latently hydraulic material; and, optionally, an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO) and (b) permitting the combination obtained in step (a) to persist under conditions sufficient to transform the combination into a pourable cementitious mixture and a reduced salinity water component, wherein the conditions in step (b) does not comprise applied pressure and wherein steps (a) and/or (b) occur in a tank or basin.

The conditions sufficient to transform the combination into a pourable cementitious mixture and a reduced salinity water component in step (b) comprise time and heat.

The high salinity brine, CO₂, and pozzolan and/or a latently hydraulic material are combined simultaneously or are combined sequentially and in any order.

The high salinity brine may be obtained from a desalination facility, is natural seawater, or an industrial brine.

A benefit of the present method is that the reduced salinity water component can be added to a natural or artificial body of water. The reduced salinity water component does less harm to flora and/or fauna present in the natural or artificial body of water relative to the harm that would be caused when the high salinity brine is added to a natural or artificial body of water. Without wising to be bound by theory, the reduced salinity water comprises less sulphates and chlorides than high salinity brine, which also are harmful to flora and/or fauna present in the natural or artificial body of water.

In some cases, the reduced salinity water component is returned to the desalination plant for a further round of desalination into fresh water.

In some embodiments, the reduced salinity water component is further processed to extract sodium to produce additional fresh water. In addition to or in combination with or after the above-described processes, a chloralkali process can more efficiently be performed, since, at least in part, because the sulphates and chlorides have already been removed. The extracted sodium may be isolated into a pure sodium product.

The salt concentration of the high salinity brine is greater than or about equal to the salt concentration of seawater, whereas the salt concentration of the reduced salinity water component is less than or about equal to the salt concentration of seawater. Notably, the salt concentration of the reduced salinity water component is less than the high salinity brine. In various cases, the high salinity brine comprises water with a salt concentration (e.g., chloride, sulphate, and sodium) higher than 50 parts per thousand.

Steps (a) and/or (b) occurs in a location within the desalination facility, adjacent to the desalination facility, or downstream from the desalination facility.

The pozzolan combined in step (a) comprises silica (SiO₂), alumina (Al₂O₃), and/or iron oxide (Fe₂O₃). The pozzolan may be a natural pozzolan or a man-made pozzolan. The pozzolan comprises or is obtained from one or more of volcanic rock (e.g., rhyolite, obsidian, pitchstone, pumice, basalt or trap, or andesite); volcanic ash; sedimentary clays or shales' calcined clays; rice husk ash; diatomaceous earth; metakaolin; and olivine.

The CO₂ of step (a) is from industrial waste, from environmental sources, or from molecular capture. In some cases, the industrial waste relates to alcoholic fermentation or the burning of fossil fuels. The CO₂ of step (a) is provided in gaseous, solid, and/or as a supercritical fluid form or as a dissolved gas.

In some cases, step (a) further comprises an activator; the activator may be any sodium, lithium or potassium salt or hydroxide and any alkali or alkali earth metal ions and including one or more of Mg(OH)₂, MgO, Ca(OH)₂, CaCO₃, Al₂(SO₄)₃, and CaO.

Step (b) produces exothermic heat and this exothermic heat is transformable from thermal energy into electrical energy.

The temperature of step (a) and/or step (b) is from about 1° C. to about 100° C., and any range or value therebetween. The duration of step (b) is from about 1 minute to about 10 hours, and any range or value therebetween.

The ratio (weight to weight or weight to volume or volume to volume) of the high salinity brine to pozzolan and/or a latently hydraulic material varies from 1:100 to 100:1, and any range or value therebetween. The ratio (weight to weight or weight to volume or volume to volume) of the high salinity brine to CO₂ varies from 1:100 to 100:1, and any range or value therebetween. The ratio (weight to weight or weight to volume or volume to volume) of the pozzolan and/or a latently hydraulic material to CO₂ varies from 1:100 to 100:1, and any range or value therebetween.

In some cases, an aggregate is added to the combination of step (a). The aggregate may comprise sand, gravel, lightweight aggregate, or crushed stone, and a combination thereof.

In various cases, the latently hydraulic material is a slag. The slag may be added in step (a) in addition to the added pozzolan or the slag is added in step (a) instead of pozzolan. The slag may be added in step (a) instead of an activator.

At least one filler material or other additive, may be added to the pourable cementitious mixture. Examples of a filler or another additive: pumice or other volcanic rock or material, sand, gravel, crushed stone, aggregate (e.g., fine aggregate, coarse aggregate, intermediate aggregate, other types of aggregate, etc.), lightweight aggregate, talc, other clay material, fibers (e.g., steel and/or other metallic fibers, polypropylene and/or other polymeric fibers, glass fibers, asbestos fibers, carbon fibers, organic fibers, etc.), glass fiber reinforced plastic (GFRP), other reinforced polymers, admixtures or other additives that facilitate with fire protection, water protection, corrosion resistance/inhibition, workability, and/or one more other properties of the final cured product (e.g., MasterPel, RheoCell, MasterCell, etc.), sodium naphthalene sulfonate formaldehyde (SNF) and/or other surfactants, plasticizers, pigments, dyes and other color additives, titanium dioxide, other minerals, other natural or synthetic materials, other filler materials and/or the like. The method may further comprise isolating the pourable cementitious mixture from the reduced salinity water component or other liquid components. The isolating may comprise straining to capture the pourable cementitious mixture.

When forming pourable cementitious mixture, the CO₂ is chemically reacted to form a crystalline form of carbon and this crystalline form is absorbed into the pourable cementitious mixture.

The pourable cementitious mixture formed by the above-described method will have features as disclosed elsewhere herein, e.g., particle size, pore size, pore number, and so forth.

### Example 8

In this example, a pourable cementitious mixture is molded into a shaped cementitious composition.

The method comprises obtaining a pourable cementitious mixture formed by a herein-disclosed method, e.g., from Example 1 to Example 7.

The pourable cementitious mixture is molded into a shaped cementitious composition. Particles of the pourable cementitious mixture can stick to each other, thereby permitting the molding of the composition into shapes. In some case, molding may not require an additional binder to keep the molded shape and in other cases, molding may require an additional binder to keep the molded shape. In some cases, the shaped cementitious composition, when deposited into a natural or artificial body of water, permits attachment by flora, e.g., algae, and/or fauna, e.g., coral, relative to a standard cement. In various cases, the shaped cementitious composition permits stronger attachment by flora and/or fauna relative to a standard cement and/or the shaped cementitious composition permits more plentiful attachment by flora and/or fauna relative to a standard cement. When molded, the shaped cementitious composition comprises gaps between particles of the aggregate such that the of the shaped cementitious composition is has a more porous surface, is more porous throughout its volume, and is less dense than a standard cement. The gaps of a shaped cementitious composition may be up to 500 nm in diameter. Additionally, a shaped cementitious composition may have up to 85% of the volume being void (e.g., the sum of all gaps) whereas a standard cement may have about 40% of the volume being void.

The shape of the shaped cementitious composition may be any shape capable of providing a substrate for aquatic flora and/or fauna attachment.

The shaped cementitious composition is planar, circular, rounded, elongated, flat, rectangular, tubular, hollow, solid, or any combination thereof.

The shaped cementitious composition is a cube, cuboid, cone, cylinder, dodecahedron, polyhedron, prism, pyramid, sphere, tetrahedron, anthropomorphic, zoomorphic, symbolic, or any combination thereof.

The shaped cementitious composition is pyramidal with open surfaces such that the shape comprises four bars or cylinders that form a square base and four bars or cylinders each originating at a corner of the square and converging to form the pyramid's apex.

The surface of the shaped cementitious composition is flat or the surface comprises contouring, e.g., regular contours or irregular contours, which provide increased surface area and/or locations for attachment by the aquatic flora and/or fauna.

The shaped cementitious composition is like a hydrofoil. In some cases, the hydrofoil shape efficiently redirects the flow of water, which reduces pressure on the structure by minimizing drag and turbulence caused by currents.

Although the foregoing embodiments have been described in some detail by way of illustration and Example for purposes of clarity of understanding, one of skill in the art will appreciate that certain changes and modifications may be practiced within the scope of the appended claims. In addition, each reference provided herein is incorporated by reference in its entirety to the same extent as if each reference was individually incorporated by reference. In particular, the entire contents PCT/US2020/036848; PCT/US2023/032043; PCT/US2023/085531; and PCT/US2024/013143 are incorporated by reference. Where a conflict exists between the instant application and a reference provided herein, the instant application shall dominate.

1.-180. (canceled)

181. A method for promoting coral attachment and/or coral growth, the method comprising the steps of:
(1) mixing a cementitious mixture comprising:
(a) a pozzolan comprising a natural pozzolan and/or a manmade pozzolan;
(b) MgO and/or Mg(OH)₂;
(c) an aqueous solution comprising one or more accelerants; and
(d) at least one aggregate;
optionally, wherein the MgO and/or Mg(OH)₂ of (b) is included in the aqueous solution of (c);
optionally, wherein the manmade pozzolan comprises a slag;
(2) pouring the cementitious mixture into a mold or extruding the cementitious mixture via a 3-D printer to form a shaped cementitious composition; and
(3) depositing the shaped cementitious composition into a natural or artificial body of water;
wherein the attachment to the shaped cementitious composition and/or growth of coral is promoted.

182. The method of claim 181, further comprising a step of transplanting the coral onto the shaped cementitious composition;
wherein the coral is coral colonies removed from their original habitat.

183. The method of claim 181, further comprising step of placing corals on the shaped cementitious composition;
wherein the coral is nursery-grown coral.

184. (canceled)

185. The method of claim 181, wherein the artificial body of water is in a laboratory, a hatchery, a nursery, or the like.

186. The method of claim 181, further comprising the step of applying a curing technique to the cementitious mixture.

187. The method of claim 181, wherein the shaped cementitious composition releases alkaline compounds that buffer the acidity of seawater and raise its pH.

188. The method of claim 181, wherein the shaped cementitious composition:
(i) has a surface that 1) is more hydrostatic, and 2) has a lower pH than a standard cement;
(ii) has a more porous surface, is more porous throughout its volume, and/or is less dense than a standard cement;
(iii) has a surface that is rougher and/or more textured than a surface of a standard cement;
(iv) comprises more magnesium oxychloride crystals than a standard cement; and/or
(v) has a higher thermal mass which effectively absorbs and stores heat than a standard cement;
wherein the standard cement is:
(a) Portland cement comprising clinker rather than pozzolan,
(b) pozzolan-modified Portland cement, or
(c) other carbonate-based and/or sodium-based binder.

189. The method of claim 181, wherein the one or more accelerants is one or more of nitrate, sulfate, sodium, chloride, phosphate, triethanolamine, calcium formate, silica fume, finely divided silica gel, and calcium chloride.

190. The method of claim 181, wherein the one or more accelerants are selected from magnesium chloride, magnesium sulfate, magnesium nitrate, and a phosphate-based accelerant.

191. The method of claim 181, wherein the pozzolan comprises one or both of slag cement and Class C fly ash.

192. The method of claim 181, wherein the proportion by weight of magnesium chloride in the shaped cementitious composition is about 0.1% to about 30% the proportion by weight of MgO and/or Mg(OH)₂ of the shaped cementitious composition.

193. The method of claim 181, wherein the proportion by weight of magnesium nitrate in the shaped cementitious composition is about 0.1% to about 30% the proportion by weight of MgO and/or Mg(OH)₂ of the shaped cementitious composition.

194. The method of claim 181, wherein the sum of the proportions of MgO, Mg(OH)₂, and pozzolan is about 5% to about 90% by weight of the shaped cementitious composition.

195. The method of claim 181, wherein the proportion by weight of magnesium sulfate is about 5% to about 145% of the proportion by weight of MgO and/or Mg(OH)₂ of the shaped cementitious composition.

196. The method of claim 181, wherein the aqueous solution comprises high salinity brine.

197. The method of claim 196, wherein the high salinity brine:
(i) has a salt concentration greater than or about equal to the salt concentration of seawater;
(ii) comprises water with a salt concentration higher than 50 parts per thousand, wherein the salt is chloride, sulfate, and/or sodium;
(iii) has been treated prior to manufacturing the pourable cementitious mixture to reduce the amount of sodium, sulfates, and/or chloride;
(iv) comprises reduced amounts of sodium, potassium, chloride, sulphate, magnesium, and/or calcium ions via chemical precipitation, electrochemical methods, ion selective membranes, reverse osmosis, and/or selective precipitation by pH;
(v) comprises reduced amounts of sodium, potassium, chloride, sulphate, magnesium, and/or calcium ions via chemical precipitation, wherein the chemical precipitation comprises contacting the sodium, potassium, chloride, sulphate, magnesium, and/or calcium ions with lime or alum which forms insoluble precipitates with the sodium, potassium, chloride, sulphate, magnesium, and/or calcium ions;
(vi) has been treated with a chloralkali process prior to manufacturing the pourable cementitious mixture to reduce sodium; and/or
(vii) is obtained from a desalination facility, is natural seawater, or is an industrial brine.

198. The method of claim 181, wherein the cementitious mixture comprises CO₂.

199. The method of claim 198, wherein:
(i) the CO₂ is chemically reacted to form a crystalline form of carbon;
(ii) the CO₂ is absorbed into the cementitious mixture as a crystalline form of carbon;
(iii) the CO₂ is provided in gaseous, solid, and/or as a supercritical fluid form or as a dissolved gas;
(iv) the CO₂ is incorporated into the cementitious mixture as a carbonate;
(v) the shaped cementitious composition retains carbon dioxide of at least 5% by weight of the shaped cementitious composition over a 15-year period;
(vi) the shaped cementitious composition retains carbon dioxide of about 5% by weight to about 16% by weight of the shaped cementitious composition over a 15-year period;
(vii) the cementitious mixture absorbs more CO₂ during its manufacture than is emitted;
(viii) the cementitious mixture comprises more CO₂ per gram than a standard cement; and/or
(ix) the cementitious mixture comprises up to 50% more CO₂ per gram than a standard cement;
wherein the standard cement is:
(a) Portland cement comprising clinker rather than pozzolan,
(b) pozzolan-modified Portland cement, or
(c) other carbonate and/or sodium-based binder.

200. The method of claim 181, wherein the cementitious mixture is cured below water.

201. The method of claim 181, wherein the shaped cementitious composition mitigates undesirable algal growth when compared to a standard cement, wherein the standard cement is:
(a) Portland cement comprising clinker rather than pozzolan,
(b) pozzolan-modified Portland cement, or
(c) other carbonate-based and/or sodium-based binder.
